(19) United States
(12) Patent Application Publication
(10) Pub. No.: US 2016/0029468 A1
(43) Pub. Date: Jan. 28, 2016

(54) ROTATION ANODE X-RAY TUBE UNIT AND ROTATION ANODE X-RAY TUBE ASSEMBLY

(71) Applicants: KABUSHIKI KAISHA TOSHIBA, Minato-ku (JP); Toshiba Electron Tubes & Devices Co., Ltd., Otawara-shi (JP)

(72) Inventors: Hidero ANNO, Otawara (JP); Masaji KANAGAMI, Utsunomiya (JP); Yoshifumi IMAI, Otawara (JP); Yoshiaki SHIRATORI, Otawara (JP); Hisayuki TAMURA, Sakura (JP)

(73) Assignees: KABUSHIKI KAISHA TOSHIBA, Minato-ku (JP); Toshiba Electron Tubes & Devices Co., Ltd., Otawara-shi (JP)

(21) Appl. No.: 14/872,895

(22) Filed: Oct. 1, 2015

Related U.S. Application Data
(63) Continuation of application No. PCT/JP2013/079764, filed on Nov. 1, 2013.

(30) Foreign Application Priority Data
Apr. 1, 2013 (JP) 2013-076304

(51) Int. Cl. H05G 1/02

(52) U.S. Cl. CPC H05G 1/02; H05G 1/025

(57) ABSTRACT

A rotation anode X-ray tube unit includes a rotation anode X-ray tube, a flow-passage formation member, and a X-ray shielding section. The X-ray shielding section includes an X-ray shield and a frame-shaped X-ray shielding member.

### CROSS REFERENCE TO RELATED APPLICATIONS

This application is a Continuation Application of PCT Application No. PCT/JP2013/079764, filed Nov. 1, 2013 and based upon and claiming the benefit of priority from Japanese Patent Application No. 2013-076304, filed Apr. 1, 2013, and based upon the prior Japanese Patent Application No. 2012-082771, filed Mar. 30, 2012, the entire contents of all of which are incorporated herein by reference.

### BACKGROUND OF THE INVENTION

1. Field of the Invention

Embodiments described herein relate to a rotation anode X-ray tube unit and a rotation anode X-ray tube assembly.

2. Description of the Related Art

In X-ray photography applied in the medical field, etc., in general, an X-ray apparatus is used which adopts a rotation anode X-ray tube assembly as an X-ray source. As the X-ray photography, Roentgen photography and computerized tomography (CT) are applied. A rotation anode X-ray tube assembly comprises a housing, a rotation anode X-ray tube provided in the housing to radiate X-rays, and insulating oil is filled in space between the housing and the rotation anode X-ray tube.

The housing is formed of brittle material such as cast aluminum. To an inner surface of the housing, a lead plate for intercepting X-rays is bonded. Also, at an outer wall of the housing, an X-ray transmission window for transmitting the X-ray is provided.

The rotation anode X-ray tube comprises an anode target, a cathode and a vacuum envelope which accommodates the anode target and the cathode, and which is depressurized. The anode target can be rotated at a high speed (for example, 10,000 rpm). The anode target includes a target layer (umbrella portion) which can be rotated at a high speed (for example, 10,000 rpm) and is formed of a tungsten alloy. The cathode is located eccentrically with respect to the axis of rotation of the anode target and opposite to the target layer.

Between the cathode and the anode target, a high voltage is applied. Thus, when ejected from the cathode, electrons are accelerated and focused to collide with the target layer. As a result, the target layer emits X-rays, which are output from the X-ray transmission window to the outside of the housing.

### CITATION LIST

### Patent Literatures

Patent Literature 1 JP 2000-48745A

Patent Literature 2 JP 2010-211939A

Patent Literature 3 JP 2010-244940A

Patent Literature 4 JP 2010-244941A

Patent Literature 5 JP 2010-257900A

Patent Literature 6 JP 2010-257902A

### BRIEF SUMMARY OF THE INVENTION

### Object of the Invention

The above rotation anode X-ray tube assembly raises the following problems:

(1) Problem of Transportation Cost

The longer a rotation anode X-ray tube is used, the more often a failure occurs; for example, the more often discharge occurs (discharge trouble). Thus, in general, the life of the rotation anode-X ray tube is shorter than the lives of the components of an X-ray apparatus which are other than the rotation anode X-ray tube. Inevitably, it is necessary to replace the rotation anode X-ray tube assembly with a new one every few years. In order to do so, it is necessary to transport the entire new rotation anode X-ray tube assembly.

To be more specific, it is necessary to replace the rotation anode X-ray tube assembly, not only the rotation anode X-ray tube. This is because in an expensive, large-scale and special equipment, it is necessary to conduct a confirmation test for confirming that X-rays do not leak from an area other than an X-ray transmission window, with the rotation anode X-ray tube provided along with insulating oil in a housing having an X-ray shield function. At a destination, even if a defective rotation anode X-ray tube can be replaced with a new one, it is impossible to conduct the above test.

For the above reason, it is necessary to transport the entire rotation anode X-ray tube assembly. However, even in the case of the smallest possible weight of the rotation anode X-ray tube assembly, the total weight of the rotation anode x-ray tube assembly and packaging material is close to 20 kg, and the energy required for the transportation cannot be ignored in environmental effect. For example, in the case of transporting it abroad by air, the more distant the place to which it is transported, the larger the amount of the energy required to transport it. If it suffices to transport only the rotation anode X-ray tube, it is possible to reduce the weight of objects to be transported; that is, the total weight of the rotation anode X-ray tube and the packaging material is approximately one fifth that of the rotation anode X-ray tube assembly and the packaging material.

(2) Problem of Shortage of Heat Radiation of Anode Target

In general, an outer peripheral surface of an anode target and a surface of the anode target, which is located opposite to a target layer, are coated with blacked films. Since the anode target is heated by collision of electrons therewith during use of the rotation anode X-ray tube, heat generated at the anode target is radiated from the blacked films to an inner surface of a vacuum envelope which is oppositely located, by thermal radiation. Part of the heat generated at the anode target is conducted to a rotor connected to the anode target, and radiated from a blacked film formed on an outer surface of the rotor to the inner surface of the vacuum envelope, which is located oppositely, due to thermal radiation. The radiated heat heats insulating oil which is present in the vicinity thereof.

In such a manner, in the rotation anode X-ray tube assembly from which heat is radiated, forced convection does not occur in the insulating oil in the housing. Thus, heat is transmitted only by natural convection of the insulating oil, and is then transmitted to the housing. To a wide area of an inner wall of the housing, a lead plate serving as an X-ray shielding member is bonded. The inner wall of the housing and the lead plate partially adhere to each other. However, between most parts of them, very small gaps are provided in which insulating oil cannot not easily flow. Thus, the insulating oil remains in place in the gaps. Accordingly, heat transmitted to the lead plate is not easily transmitted to the housing, as a result of which dissipation of heat falls, and the insulating oil present in the vicinity of the anode target and in the vicinity of the rotor is easily overheated.

If the insulating oil becomes overheated, it carbonizes and deposits as a product on a surface of the vacuum envelope. Thus, if the vacuum envelope is formed of glass, a heat radiation is absorbed by a deposited film (product), and the vacuum envelope becomes overheated. If the vacuum envelope becomes overheated, gas adsorbed on the inner wall of the vacuum envelope is released into the vacuum space, thus increasing the rate at which discharge occurs in the rotation anode X-ray tube.

(3) Problem of Manufacturing Cost of a Housing Having a Lead Plate Bonded to the Inside of the Housing

In order to prevent undesired radiation of X-rays to the outside of the housing, a lead plate is bonded to an inner wall of a main body of the housing. The inner surface of the housing comprises a number of curved surfaces. Thus, it requires a great deal of skill to bond the lead plate to the inner surface of the housing body with no gaps. This is a stumbling block against lowering of the manufacturing cost and also of the prices of manufactured goods. Furthermore, although it is necessary to separate the lead plate and the housing from each other, for example, after the life of the rotation anode X-ray tube assembly ends, it is very hard. Thus, this separation is performed by a specialist. They are otherwise handled as a general industrial waste. It is not desirable, since they cannot be usefully utilized as resources.

The embodiments described herein are made in view of the above, and aim to provide a rotation anode X-ray tube unit which can be alone subjected to an X-ray leakage test, and can improve the heat radiation of an anode target, and a rotation anode X-ray tube assembly provided with the rotation anode X-ray tube unit. Furthermore, in the rotation anode X-ray tube assembly, the manufacturing cost of the housing can be reduced.

### Means for Achieving the Object

A rotation anode X-ray tube unit according to one embodiment includes:

a rotation anode X-ray tube including a cathode which emits electrons, an anode target which is rotatably provided to emit X-rays, and a vacuum envelope which accommodates the cathode and the anode target;

a flow-passage formation member including a shell which surrounds the vacuum envelope in a direction perpendicular to the axis of the anode target, the flow-passage formation member forming along with the vacuum envelope a flow passage in which a cooling fluid flows, and which is located between the flow-passage formation member and the vacuum envelope; and

X-ray shielding means for preventing leakage of the X-rays.

Furthermore, a rotation anode X-ray tube assembly according to one embodiment includes:

a rotation anode X-ray tube unit; and

a housing accompanying the rotation anode X-ray tube unit, and providing space in which a cooling fluid flows, and which is located between the housing and the rotation anode X-ray tube unit,

the rotation anode X-ray tube unit includes:

a rotation anode X-ray tube including a cathode which emits electrons, an anode target which is rotatably provided to emit X-rays, and a vacuum envelope which accommodates the cathode and the anode target;

a flow-passage formation member including a shell which surrounds the vacuum envelope in a direction perpendicular to the axis of the anode target, the flow-passage formation member forming along with the vacuum envelope a flow passage in which the cooling fluid flows, and which is located between the flow-passage formation member and the vacuum envelope; and

X-ray shielding means for preventing leakage of the X-rays.

### BRIEF DESCRIPTION OF THE SEVERAL VIEWS OF THE DRAWING

FIG. 1 is a cross-sectional view showing a rotation anode X-ray tube assembly according to a first embodiment;

FIG. 2 is a cross-sectional view showing a rotation anode X-ray tube unit according to the first embodiment;

FIG. 3 is a cross-sectional view showing a rotation anode X-ray tube according to the first embodiment;

FIG. 4 is a cross-sectional view showing a rotation anode X-ray tube assembly according to a second embodiment;

FIG. 5 is a cross-sectional view showing a rotation anode X-ray tube assembly according to a third embodiment;

FIG. 6 is a cross-sectional view showing a modification of the rotation anode X-ray tube unit of the rotation anode X-ray tube assembly according to the first to third embodiments;

FIG. 7 is a cross-sectional view showing another modification of the rotation anode X-ray tube unit of the rotation anode X-ray tube assemblies according to the first to third embodiments;

FIG. 8 is a cross-sectional view showing still another modification of the rotation anode X-ray tube unit of the rotation anode X-ray tube assemblies according to the first to third embodiments;

FIG. 9 is a cross-sectional view showing a rotation anode X-ray tube assembly according to a fourth embodiment;

FIG. 10 is a cross-sectional view showing a rotation anode X-ray tube unit according to the fourth embodiment;

FIG. 11 is a cross-sectional view showing another modification of a rotation anode X-ray tube unit of the rotation anode X-ray tube assembly according to the fourth embodiment;

FIG. 12 is a cross-sectional view showing another modification of the rotation anode X-ray tube unit of the rotation anode X-ray tube assembly according to the fourth embodiment;

FIG. 13 is a cross-sectional view showing still another modification of the rotation anode X-ray tube unit of the rotation anode X-ray tube assembly according to the fourth embodiment;

FIG. 14 is a cross-sectional view showing a further modification of the rotation anode X-ray tube unit of the rotation anode X-ray tube assembly according to the fourth embodiment;

FIG. 15 is a cross-sectional view showing a still further modification of the rotation anode X-ray tube unit of the rotation anode X-ray tube assembly according to the fourth embodiment;

FIG. 16 is a cross-sectional view showing a rotation anode X-ray tube assembly according to a fifth embodiment;

FIG. 17 is a cross-sectional view showing a rotation anode X-ray tube assembly according to a sixth embodiment;

FIG. 18 is a cross-sectional view showing a rotation anode X-ray tube unit according to the sixth embodiment;

FIG. 19 is a schematic view showing a rotation anode X-ray tube assembly according to a seventh embodiment, and also showing the rotation anode X-ray tube assembly as viewed from a receptacle side;

FIG. 20 is a cross-sectional view showing the rotation anode X-ray tube assembly according to the seventh embodiment, which is taken along line XX-XX in FIG. 19;

FIG. 21 is a cross-sectional view showing a rotation anode X-ray tube assembly according to an eighth embodiment;

FIG. 22 is a schematic view showing a rotation anode X-ray tube assembly according to a ninth embodiment, and also showing the rotation anode X-ray tube assembly as viewed from a receptacle side;

FIG. 23 is a cross-sectional view showing the rotation anode X-ray tube assembly according to the ninth embodiment, which is taken along line XXIII-XXIII in FIG. 22;

FIG. 24 is a cross-sectional view showing the rotation anode X-ray tube assembly according to the ninth embodiment, which is taken along line XXIV-XXIV in FIG. 22;

FIG. 25 is a cross-sectional view showing the rotation anode X-ray tube assembly according to the ninth embodiment, which is taken along line XXV-XXV in FIG. 22;

FIG. 26 is a cross-sectional view showing a rotation anode X-ray tube assembly according to a tenth embodiment;

FIG. 27 is a cross-sectional view showing a rotation anode X-ray tube assembly of a comparative example of each of the X-ray tube assemblies according to the first to tenth embodiments;

FIG. 28 is a cross-sectional view showing a rotation anode X-ray tube assembly according to an eleventh embodiment;

FIG. 29 is a cross-sectional view showing another modification of a rotation anode X-ray tube unit of the rotation anode X-ray tube assembly according to the eleventh embodiment;

FIG. 30 is a cross-sectional view showing another modification of the rotation anode X-ray tube unit of the rotation anode X-ray tube assembly according to the eleventh embodiment;

FIG. 31 is a cross-sectional view showing still another modification of the rotation anode X-ray tube unit of the rotation anode X-ray tube assembly according to the eleventh embodiment;

FIG. 32 is a cross-sectional view showing a further modification of the rotation anode X-ray tube unit of the rotation anode X-ray tube assembly according to the eleventh embodiment;

FIG. 33 is a cross-sectional view showing a still further modification of the rotation anode X-ray tube unit of the rotation anode X-ray tube assembly according to the eleventh embodiment;

FIG. 34 is a cross-sectional view showing a rotation anode X-ray tube assembly according to a twelfth embodiment;

FIG. 35 is a cross-sectional view showing a rotation anode X-ray tube unit according to the twelfth embodiment;

FIG. 36 is a cross-sectional view showing a rotation anode X-ray tube assembly according to a thirteenth embodiment;

FIG. 37 is a cross-sectional view showing a rotation anode X-ray tube assembly according to a fourteenth embodiment;

FIG. 38 is a cross-sectional view showing a rotation anode X-ray tube assembly according to a fifteenth embodiment;

FIG. 39 is a schematic view showing a rotation anode X-ray tube assembly according to a sixteenth embodiment, and also showing the rotation anode X-ray tube assembly as viewed from a receptacle side;

FIG. 40 is a cross-sectional view showing the rotation anode X-ray tube assembly according to the sixteenth embodiment, which is taken along line XL-XL in FIG. 39;

FIG. 41 is a cross-sectional view showing the rotation anode X-ray tube assembly according to the sixteenth embodiment, which is taken along line XLI-XLI in FIG. 39;

FIG. 42 is a cross-sectional view showing the rotation anode X-ray tube assembly according to the sixteenth embodiment, which is taken along line XLII-XLII in FIG. 39;

FIG. 43 is a cross-sectional view showing a rotation anode X-ray tube assembly according to a seventeenth embodiment;

FIG. 44 is a cross-sectional view showing a rotation anode X-ray tube assembly according to an eighteenth embodiment;

FIG. 45 is a cross-sectional view showing a rotation anode X-ray tube assembly according to a nineteenth embodiment;

FIG. 46 is a cross-sectional view showing a rotation anode X-ray tube assembly according to a twentieth embodiment;

FIG. 47 is a cross-sectional view showing a rotation anode X-ray tube assembly according to a twenty-first embodiment;

FIG. 48 is a cross-sectional view showing a rotation anode X-ray tube assembly according to a twenty-second embodiment;

FIG. 49 is a cross-sectional view showing a rotation anode X-ray tube unit according to the twenty-second embodiment;

FIG. 50 is a cross-sectional view showing a rotation anode X-ray tube assembly according to a twenty-third embodiment;

FIG. 51 is a cross-sectional view showing a rotation anode X-ray tube unit according to the twenty-third embodiment;

FIG. 52 is a cross-sectional view showing a rotation anode X-ray tube assembly according to a twenty-fourth embodiment;

FIG. 53 is a cross-sectional view showing a rotation anode X-ray tube assembly according to a twenty-fifth embodiment;

FIG. 54 is an exploded cross-sectional view showing a rotation anode X-ray tube unit according to the twenty-fifth embodiment;

FIG. 55 is a cross-sectional view showing a rotation anode X-ray tube assembly according to a twenty-sixth embodiment;

FIG. 56 is a cross-sectional view showing a rotation anode X-ray tube assembly according to a twenty-seventh embodiment;

FIG. 57 is a cross-sectional view showing a rotation anode X-ray tube unit according to the twenty-seventh embodiment; and

FIG. 58 is a cross-sectional view showing a modification of the rotation anode X-ray tube unit of the rotation anode X-ray tube assembly according to the twenty-seventh embodiment.

### DETAILED DESCRIPTION OF THE INVENTION

### First Embodiment

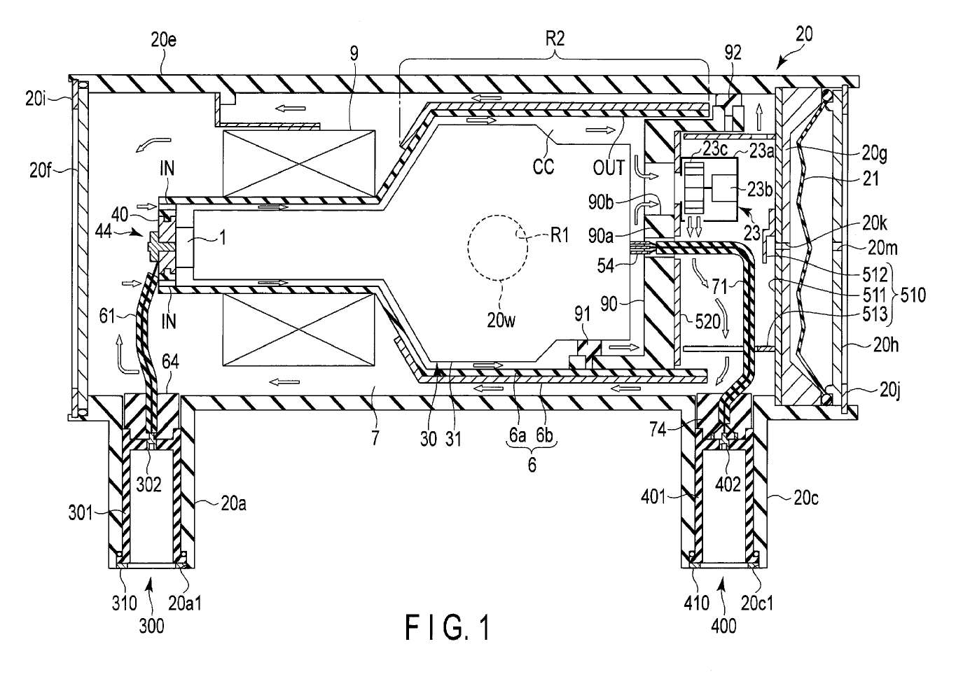

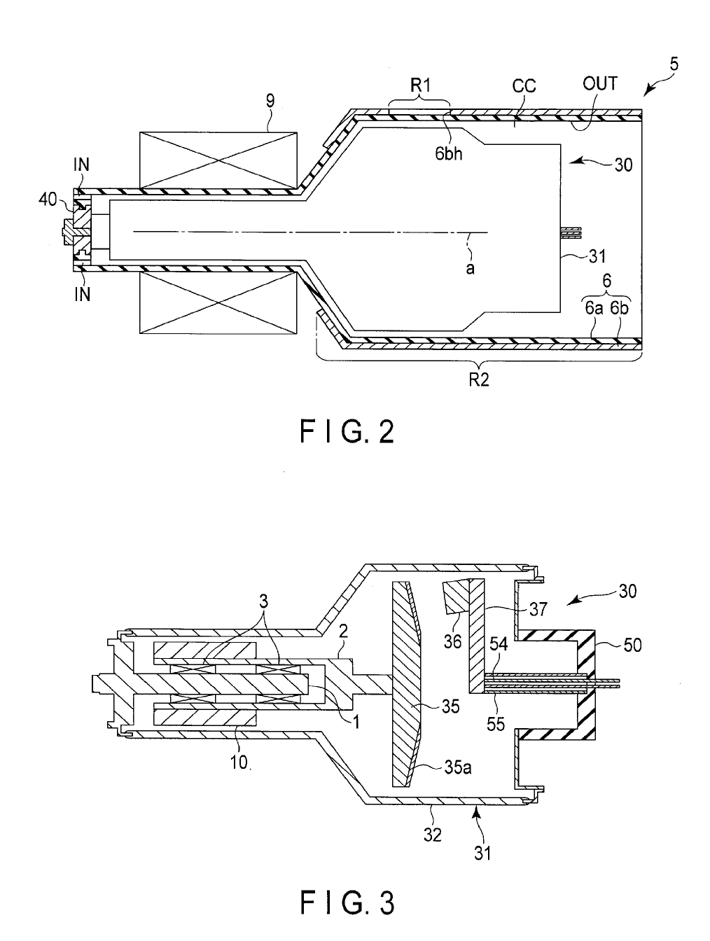

A rotation anode X-ray tube assembly according to the first embodiment will be explained in detail with reference to the drawings. FIG. 1 is a cross-sectional view showing the X-ray tube assembly according to the first embodiment. FIG. 2 is a cross-sectional view of a rotation anode X-ray tube unit according to the first embodiment. FIG. 3 is a cross-sectional view of a rotation anode X-ray tube according to the first embodiment.

As shown in FIG. 1, roughly speaking, the X-ray tube assembly comprises: a housing 20; a rotation anode X-ray tube 30 provided in the housing 20; a coolant 7 serving as a cooling fluid, which is filled in the space between the X-ray tube 30 and the housing 20; a shield structure 6; a stator coil 9 serving as a rotary drive unit; a circulation unit 23; high-voltage cables 61 and 71; and receptacles 300 and 400.

The housing 20 includes a tubularly shaped housing body 20e and lid portions 20f, 20g and 20h. The housing body 20e is formed of resin material. The lid portions 20f, 20g and 20h are formed of metal or resin material. Even if they are formed of resin material, some parts of them may also be formed of metal; for example, the following parts may be formed of metal: part required to have a given strength, e.g., screw part; part which is hard to form in the case of performing injection molding with resin; and a shield layer to be described later, which prevents leakage of electromagnetic noise from the housing 20 to the outside thereof.

The above resin material includes at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

A frame-shaped step portion is formed at an opening portion of the housing body 20e, in which a high-voltage supply terminal 44 to be described later is located. In an inner peripheral surface of the above step portion, a frame-shaped groove portion is formed. In a direction along a tube axis of the X-ray tube assembly, a circumferential edge portion of the lid portion 20f is contact with the step portion of the housing body 20e. In the above groove portion of the housing body 20e, a C-type snap ring 20i is fitted.

The C-type snap ring 20i restricts the position of the lid portion 20f with respect to the housing body 20e in the direction along the tube axis. In the first embodiment, in order to prevent the lid portion 20f from shaking, the lid portion 20f is fixed in position. In a direction perpendicular to the tube axis, a gap between the housing body 20e and the lid portion 20f is liquid-tightly sealed with an O-ring. The O-ring has a function of preventing leakage of the coolant 7 from the housing 20 to the outside thereof. The O-ring is formed of resin or rubber.

Due to the above structure, the opening portion of the housing body 20e, in which the high-voltage supply terminal 44 is located, is liquid-tightly closed by the lid portion 20f, the C-type snap ring 20i and the O-ring.

A frame-shaped step portion is formed at an opening portion of the housing body 20e, in which a high-voltage supply terminal 54 to be described later is located. In an inner peripheral surface of the above step portion, a frame-shaped groove portion is formed. The lid portion 20g is located in the housing body 20e. In the direction along the tube axis, a peripheral edge portion of the lid portion 20g holds along with the step portion of the housing body 20e an X-ray shielding member 510 to be described later. The lid portion 20h is located opposite to the lid portion 20g. In the first embodiment, the lid portion 20h includes an annular portion, which is formed to project toward the lid portion 20g.

Gaps between the inner peripheral surface of the housing body 20e, the lid portion 20g and the lid portion 20h are liquid-tightly sealed by a frame-shaped O-ring. The O-ring is formed at a peripheral edge portion of a rubber bellows 21, and has a function of preventing leakage of the coolant 7 from the housing 20 to the outside thereof.

In the groove portion of the housing body 20e, the C-type snap ring 20j is fitted. The C-type snap ring 20j holds the lid portion 20h applying a stress on the O-ring. Due to the above structure, the opening portion of the part of the main body 20e, in which the high-voltage supply terminal 54 is located, is liquid-tightly closed by the lid portion 20g, the lid portion 20h, the C-type snap ring 20j and the rubber bellows 21.

The housing 20 includes an X-ray output window 20w, which is located opposite to an X-ray transmission region R1. The X-ray output window 20w permits X-rays to pass therethrough, and thus emits the rays to the outside of the housing 20. In the first embodiment, part of the housing body 20e forms the X-ray output window 20w. It should be noted that to the inner surface of the housing 20, a lead plate is not bonded.

The lid portion 20g includes an opening portion 20k for entry or exit of the coolant 7. The lid portion 20h is formed to include an air hole 20m for entry or exit of air which is applied as an atmosphere. In the housing 20, the rubber bellows 21 partitions a region surrounded by the lid portion 20g and the lid portion 20h into a first space communicating with the opening portion 20k and a second space communicating with the air hole 20m. The pressure of the coolant 7 is adjusted by the rubber bellows 21.

As shown in FIGS. 1, 2 and 3, the X-ray tube 30 comprises a vacuum envelope 31. The vacuum envelope 31 includes a vacuum vessel 32. The vacuum vessel 32 is formed of, e.g., glass or metal such as copper, stainless steel or aluminum. In the first embodiment, the vacuum vessel 32 is formed of glass. It should be noted that in the case where the vacuum vessel 32 is formed of metal, it includes an opening located opposite to the X-ray transmission region R1. The opening of the vacuum vessel 32 is vacuum-tightly closed by an X-ray transmission window formed of beryllium which is material permitting X-rays to be transmitted therethough. Part of the vacuum envelope 31 is formed of a high-voltage insulating member 50. In the first embodiment, the high-voltage insulating member 50 is formed of glass.

The X-ray tube 30 includes an anode target 35 and a cathode 36.

The anode target 35 is provided in the vacuum envelope 31. The anode target 35 is formed discoid. Also, the anode target 35 includes a target layer 35a formed in the shape of an umbrella and provided at part of an outer surface of the anode target. The target layer 35a emits X-rays when electrons ejected from the cathode 36 collide with the target layer 35a. The anode target 35 is formed of metal such as molybdenum.

An outer peripheral side surface of the anode target 35 and a surface of the anode target 35, which is located opposite to the target layer 35a, are subjected to blacking processing. The target layer 35a is formed of metal such as molybdenum, a molybdenum alloy or a tungsten alloy. The anode target 35 is rotatable around the tube axis. Thus, the axis a of the anode target 35 is parallel to the tube axis.

The cathode 36 is provided in the vacuum envelope 31. Also, the cathode 36 emits electrons which are incident on the anode target 35. The cathode 36 is given a relatively negative voltage. A KOV member 55, which is a low-expansion alloy, is located to cover the high-voltage supply terminal 54 in the vacuum envelope 31. In this case, the gap between the high-voltage supply terminal 54 and the high-voltage insulating member 50 is sealed with glass, and the KOV member 55 is fixed to the high-voltage insulating member 50 by a friction fit. To the KOV member 55, a cathode supporting member 37 is attached. The cathode 36 is attached to the cathode supporting member 37.

The high-voltage supply terminal 54 is connected to the cathode 36 through the cathode supporting member 37. The high-voltage supply terminal 54 applies a relatively negative voltage to the cathode 36, and supplies a filament current to a filament (electron emission source) of the cathode 36, which is not shown.

The X-ray tube 30 comprises a fixed shaft 1, a rotary unit 2, bearings 3 and a rotor 10. The fixed shaft 1 is columnarly formed. At part of an outer peripheral of the fixed shaft 1, a projection portion is formed, and vacuum-tightly attached to the vacuum envelope 31. Also, to the fixed shaft 1, the high-voltage supply terminal 44 is electrically connected. In addition, the fixed shaft 1 supports the rotary unit 2 in such a manner as to permit the rotary unit 2 to be rotated. The rotary unit 2 is tubularly formed, and provided coaxial with the fixed shaft 1. To an outer surface of the rotary unit 2, a rotor 10 is attached. Also, to the rotary unit 2, the anode target 35 is attached. The bearings 3 are provided between the fixed shaft 1 and the rotary unit 2. The rotating body 2 is provided rotatable along with the anode target 35. The high-voltage supply terminal 44 applies a relatively positive voltage to the anode target 35 through the fixed shaft 1, the bearings 3 and the rotary unit 2. In the first embodiment, the high-voltage supplying terminal 44 and the high-voltage supply terminal 54 are metallic terminals.

A fixing member 90 is provided in the housing 20. The fixing member 90 fixes the X-ray tube 30 in position with respect to the housing 20. The fixing member 90 is formed of electrical insulating member such as resin. To be more specific, the fixing member 90 fixes the X-ray tube 30 (vacuum envelope 31), using a plurality of rubber members (electrical insulating members) 91. For example, the fixing member 90 fixes along with the rubber members 91 the X-ray tube 30 in three or four positions. The rubber members 91 are in contact with the vacuum envelope 31. Thus, the fixing member 90 and the rubber members 91 fix the vacuum envelope 31 due to friction fits.

The fixing member 90 itself is fixed to the housing 20. To be more specific, it is fixed to the housing 20 using a plurality of rubber members (electrical insulating members) 92. For example, in three or four positions, the fixing member 90 is fixed along with the rubber members 92 to the housing 20. The rubber members 92 are in contact with the housing 20. Thus, the fixing member 90 and the rubber members 92 are fixed to the housing 20 by friction fits.

In the fixing member 90, through holes 90a and 90b are formed. The through hole 90a is used as a space for connection between the high-voltage supply terminal 54 and a high-voltage cable 71. The through hole 90b is used as a flow passage for the coolant 7.

Furthermore, the X-ray shielding member 510 is provided on one end portion of the housing 20, which is located opposite to the target layer 35a in the direction along the axis a. The X-ray shielding member 510 serves as a shield against X-rays radiated from the target layer 35a. The X-ray shielding member 510 is formed of material containing a material impermeable to X-rays. The X-ray shielding member 510 includes a first shielding member 511, a second shielding member 512 and a third shielding member 513.

The first shielding member 511 is bonded to part of the lid portion 20g, which is located opposite to the target layer 35a in the direction along the axis a. The first shielding member 511 covers the entire side surface of the lid portion 20g. Also, at part of the first shielding member 511, which is located opposite to the opening portion 20k, an opening is formed to communicate with the opening portion 20k, thus maintaining entry and exist of the coolant 7 through the opening 20k. The second shielding member 512 is provided on the first shielding member 511. Also, the second shielding member 512 serves as a shield against X-rays which may be emitted from the vicinity of the opening portion 20k to the outside of the housing 20. The third shielding member 513 is provided on the first shielding member 511, and tubularly formed. At a plurality of portions of the third shielding member 513, through holes are formed. The through holes are used as a passage though which the high-voltage cable 71 is passed and a flow passage for the coolant 7.

An X-ray shielding member 520 is bonded to part of the fixing member 90, which is located opposite to the X-ray shielding member 510 in the direction along the axis a. Also, openings are formed in parts of the X-ray shielding member 520, which are located opposite to the through holes 90a and 90b. The X-ray shielding members 510 and 520 are grounded.

The shield structure 6 surrounds the entire vacuum space of the vacuum envelope 31 in a direction perpendicular to the axis a. The shield structure 6 includes the X-ray transmission region R1 and the X-ray shield region R2 surrounding the X-ray transmission region R1. The X-ray transmission region R1 permits X-rays to be transmitted therethrough, and the X-ray shield region R2 serves as a shield against X-rays. Between the shield structure 6 and the vacuum envelope 31, the flow passage CC for allowing the flow of the coolant 7 is provided. The X-ray tube 30, the shield structure 6, a connection member 40 and the stator coil 9 form a rotation anode X-ray tube unit 5.

The shield structure 6 includes an insulating member 6a serving as a shell and an X-ray shield 6b. A flow-passage formation member formed of the insulating member 6a forms a flow passage for the coolant 7, which is located between the flow-pass formation member and the vacuum envelope 31.

The insulating member 6a is formed of an electrical insulating material. The insulating member 6a is separated from the vacuum envelope 31 in the direction perpendicular to the axis a. The insulating member 6a surrounds the vacuum envelope 31 (the entire vacuum space of the vacuum envelope 31) in the direction perpendicular to the axis a. The insulating member 6a is formed tubular. The insulating member 6a is shaped in accordance with the shape of the X-ray tube 30. The diameter of the insulating member 6a varies along the axis a. The insulating member 6a is intended to electrically insulate the X-ray tube 30, the housing 20 and the stator coil 9 from each other.

Also, the insulating member 6a is formed of resin material which contains at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer. According to conditions, the insulating member 6a functions as a protection member.

Also, the insulating member 6a (the shield structure 6) is fixed to the X-ray tube 30 by the connection member 40. The insulating member 6a and the connection member 40 are mechanically firmly fixed to each other. The connection member 40 is formed of brass or the like, and can be formed such that the connection member 40 and the insulating member 6a are provided as a single body by an injection molding method. The insulating member 6a includes a plurality of intakes IN for taking in the coolant 7. The insulating member 6a forms an outlet OUT for discharging the coolant 7, which is located between the insulating member 6a and the vacuum envelope 31.

The X-ray shield 6b is fixed to the insulating member 6a. The X-ray shield 6b is provided in the X-ray shield region R2, and serves as a shield against X-rays. The X-ray shield 6b is grounded. Furthermore, the X-ray shield 6b includes a through hole 6bh located in the X-ray transmission region R1. The through hole 6bh is, for example, circular. Also, the through hole 6bh serves as an X-ray transmission window. The X-ray shield 6b is located opposite to the X-ray tube 30 with respect to the insulating member 6a. The X-ray shield 6b is cylindrically formed. In the first embodiment, the X-ray shield 6b is formed to be in tight contact with the insulating member 6a. Also, the X-ray shield 6b is bonded to the insulating member 6a.

One end portion of the X-ray shield 6b is located in close vicinity to the third shielding member 513 and the X-ray shielding member 520. The X-ray shielding member 510, the X-ray shielding member 520 and the X-ray shield 6b can block X-rays radiated to the outside of the X-ray transmission region R1, thus preventing leakage of the X-rays from the housing 20 to the outside thereof.

The X-ray shield 6b extends from the third shielding member 513 to a position where it is located beyond the anode target 35 (on a line extending from a surface of the target layer 35a) along the axis a. In the first embodiment, the X-ray shield 6b extends from the third shielding member 513 to a position just prior to the stator coil 9. The X-ray shield 6b is formed of material containing a material impermeable to X-rays. Also, the X-ray shield 6b has a thickness of approximately 1 to 5 mm. The thickness of the X-ray shield 6b corresponds to the shortest distance between the inner peripheral surface and outer peripheral surface of the X-ray shield 6b, and in the first embodiment, it corresponds to the distance between the inner peripheral surface and outer peripheral surface of the X-ray shield 6b in the direction perpendicular to the axis a.

As the material impermeable to X-rays which is applied to the X-ray shield 6b, the X-ray shielding member 510 and the X-ray shielding member 520, metal and a compound can be used, the metal including at least one of tungsten, tantalum, molybdenum, barium, bismuth, rare-earth metal and lead, the compound being a compound of at least one of tungsten, tantalum, molybdenum, barium, bismuth, rare-earth metal and lead. In the first embodiment, the X-ray shield 6b, the X-ray shielding member 510 and the X-ray shielding member 520 are formed of lead. The surfaces of the X-ray shield 6b, the X-ray shield portion 510 and the X-ray shielding member 520 may be plated with metal such as tin, silver, copper or nickel, or may be coated with resin, in order to protect them against corrosion.

In the case where the shield structure 6 has a certain strength and ductility, it can function as a protection member. If the anode target 35 is broken during a high-speed rotating operation, fragments of the anode target 35, which have a high kinetic energy, break the vacuum vessel 32, which is formed of glass; and further fly apart toward the inner surface of the housing 20. The shield structure 6 protects the housing 20 from the fragments having a high kinetic energy which fly apart from the anode target 35.

Even if the fragments of the anode target 35 collide with the shield structure 6, the shield structure 6 is sufficiently deformed and can thus absorb the kinetic energy of the fragments. In such a manner, even if the shield structure 6 is deformed, the housing 20 itself can be prevented from being deformed, since the shield structure 6 and the housing 20 are separated from each other. It is therefore possible to prevent generation of a crack or cracks in the housing 20, which would be generated if the above feature is absent.

The stator coil 9 is fixed to a plurality of portions of the housing 20. Also, the stator coil 9 is located opposite to the X-ray tube 30 with respect to the shield structure 6. The stator coil 9 is located opposite to an outer surface of the rotor 10 and surrounds an outer side of the vacuum envelope 31. The stator coil 9 restricts the position of the shield structure 6 in the direction perpendicular to the axis a. In the first embodiment, the stator coil 9 is in contact with an outer surface of the insulating member 6a. It should be noted that in order to prevent the X-ray tube 30 from shaking, part of the stator coil 9 is adhered to the outer surface of the insulating member 6a by an adhesive.

The stator coil 9 is intended to rotate the rotor 10, the rotary unit 2 and the anode target 35. When supplied with a predetermined current, the stator coil 9 generates a magnetic field to be applied to the rotor 10, and as a result the anode target 35, etc., are rotated at a predetermined speed.

The X-ray tube assembly comprises the circulation unit 23. The circulation unit 23 is provided in the housing 20, and produces a flow of the coolant 7 in the flow passage CC. Also, the circulation unit 23 comprises a chamber 23a, a motor 23b and fins 23c. The chamber 23a is fixed to the X-ray shielding member 520. The chamber 23a has an intake and an outlet for the coolant 7. The intake is located opposite to the through hole 90b.

The motor 23b is attached to an inner wall of the chamber 23a. The fins 23c are attached to the motor 23b in the chamber 23a. When given power by a power supply portion not shown, the motor 23b rotates the fins 23c. The circulation unit 23 discharges the coolant 7 taken in from the through hole 90b, into the housing 20. Since forced convection can be made to occur in the housing 20, the coolant 7 can be circulated in the housing 20. Furthermore, the flow passage CC can produce a flow of the coolant 7. In the first embodiment, the coolant flows the flow passage CC from a side where the high-voltage supply terminal 44 is located to a side where the high-voltage supply terminal 54 is located.

As the coolant 7, an aquatic coolant or insulating oil serving as an insulating coolant can be applied. In the first embodiment, the coolant 7 is insulating oil.

The X-ray tube assembly includes the receptacles 300 and 400, which are provided as high-voltage receptacles for the anode and for the cathode, respectively. The receptacle 300 is located in a tube portion 20a of the housing 20, and attached to the tube portion 20a. The receptacle 400 is located in a tube portion 20c of the housing 20, and attached to the tube portion 20c. For example, the tube portion 20a and the tube portion 20c are formed of the same material as the housing body 20e and integral with the housing body 20e.

The receptacle 300 includes a housing 301 which is provided as an electrical insulating member, and a terminal 302 which is provided as a high-voltage supply terminal.

The housing 301 is formed in the shape of a cup having an opening which is provided in an outer portion of the tube portion 20a (the housing 20). The housing 301 is formed in the shape of a cup which is substantially axisymmetric. Also, a plug-in of the housing 301 is open in an outer part of the housing 20.

At an end portion of an opening side of the housing 301, an annular projection portion is formed at an outer surface of the housing 301. The housing 301 is formed of an insulating material such as resin. The terminal 302 is liquid-tightly attached to a bottom portion of the housing 301, and penetrates the bottom portion.

The high-voltage cable 61 is immersed in the coolant 7. One of end portions of the high-voltage cable 61 is electrically connected to the high-voltage supply terminal 44, and the other is electrically connected to the terminal 302 through space in the housing 20. The high-voltage cable 61 and the high-voltage supply terminal 44 can be connected to each other by welding or soldering. Alternatively, the high-voltage cable 61 and the high-voltage supply terminal 44 can be detachably connected together by a friction fit.

An electrical insulating member 64 is formed of an electrical insulating resin, filled in an electrical connection portion between the terminal 302 and the high-voltage cable 61, and directly adhered to the housing 301. To be more specific, the electrical insulating member 64 is formed of a mold material. Due to use of the electrical insulating member 64, it is possible to improve an electrical insulation between the housing 20 and an electrical connection portion between the terminal 302 and the high-voltage cable 61.

An O-ring is provided between a step portion of the tube portion 20a and the projection portion of the housing 301. The step portion of the tube portion 20a is subjected to tapping processing. A ring nut 310 includes a side surface subjected to tapping processing. The ring nut 310 is tightened on the step portion of the tube portion 20a, thus pressing the housing 301. Thereby, the O-ring is pressurized by the step portion of the tube portion 20a and the projection portion of the housing 301. The receptacle 300 is liquid-tightly attached to the tube portion 20a, and can thus prevent leakage of the coolant 7 from the housing 20 to the outside thereof.

The receptacle 300 and a plug not shown, which is to be inserted thereinto, are of a non-contact pressure type, and are formed such that the plug can be inserted into and removed from the receptacle 300. A high voltage (for example, +70 to +80 kV) is applied from the plug to the terminal 302, with the plug connected to the receptacle 300.

The receptacle 400 is formed in the same manner as the receptacle 300.

The receptacle 400 includes a housing 401 which is provided as an electrical insulating member, and a terminal 402 which is provided as a high-voltage supply terminal.

The housing 401 is formed in the shape of a cup having an opening provided in an outer part of the tube portion 20c (the housing 20). The housing 401 is formed in the shape of a cup which is substantially axisymmetric. Also, a plug-in of the housing 401 is open in an outer part of the housing 20.

At an end portion of an opening side of the housing 401, an annular projection portion is formed in the outer surface of the housing 401. The housing 401 is formed of an insulating material, for example, resin. The terminal 402 is liquid-tightly attached to a bottom portion of the housing 401, and penetrates the bottom portion.

The high-voltage cable 71 is immersed in the coolant 7. One of end portions of the high-voltage cable 71 is electrically connected to the high-voltage supply terminal 54, and the other is electrically connected to the terminal 402 through the space in the housing 20. The high-voltage cable 71 and the high-voltage supply terminal 54 can be connected to each other by welding or soldering. Alternatively, the high-voltage cable 71 and the high-voltage supply terminal 54 can be detachably connected together by a friction fit.

An electrical insulating member 74 is formed of electrical insulating resin, filled in an electrical connection portion between the terminal 402 and the high-voltage cable 71, and directly adhered to the housing 401. To be more specific, the electrical insulating member 74 is formed of a mold material. Due to use of the electrical insulating member 74, it is possible to improve an electrical insulation between the housing 20 and an electrical connection portion between the terminal 402 and the high-voltage cable 71.

An O-ring is provided between a step portion of the tube portion 20c and the projection portion of the housing 401. The step portion of the tube portion 20c is subjected to tapping processing. A ring nut 410 includes a side surface subjected to tapping processing. The ring nut 410 is tightened to the step portion of the tube portion 20c to press the housing 401. Thereby, the O-ring is pressurized by the step portion of the tube portion 20c and the projection portion of the housing 401. The receptacle 400 is liquid-tightly attached to the tube portion 20c, and can thus prevent leakage of the coolant 7 from the housing 20 to the outside thereof.

The receptacle 400 and a plug not shown, which is to be inserted into the receptacle 400, are of a non-contact pressure type, and are formed such that the plug can be inserted into and removed from the receptacle 400. A high voltage (for example, −70 to −80 kV) is applied from the plug to the terminal 402, with the plug connected to the receptacle 400.

The X-ray tube assembly according to the first embodiment is formed in the above manner.

In the X-ray tube assembly formed in the above manner, when a predetermined current is supplied to the stator coil 9, the rotor 10 is rotated, and the anode target 35 is rotated. Then, a predetermined high voltage is applied to the receptacles 300 and 400.

The high voltage applied to the receptacle 300 is applied to the anode target 35 through the high-voltage cable 61, the high-voltage supply terminal 44, the fixed shaft 1, bearings 3 and the rotary unit 2. The high voltage applied to the receptacle 400 is applied to the cathode 36 through the high-voltage cable 71 and the high-voltage supply terminal 54.

Thereby, electrons ejected from the cathode 36 collide with the target layer 35a of the anode target 35, and X-rays are radiated from the anode target 35.

The X-rays are radiated to the outside of the housing 20 through the through hole 6bh and the X-ray output window 20w.

Next, a method for replacing the X-ray tube 30 of the X-ray tube assembly with a new X-ray tube 30 will be explained.

When a replacement operation for replacing the X-ray tube 30 is started, first, the coolant 7 is taken out from the housing 20. It should be noted that the housing 20 may include an opening portion for taking out the coolant 7. As the opening portion, the X-ray output window 20w can be applied.

Ordinarily, the opening portion is liquid-tightly closed.

Then, the lid portions 20f, 20g and 20h are detached from the housing body 20e. Subsequently, the high-voltage cable 61 and the high-voltage supply terminal 44 are disconnected from each other, and the high-voltage cable 71 and the high-voltage supply terminal 54 are disconnected from each other. Thereafter, after detaching the fixing member 90 from the housing body 20e, a fixing metal fitting of the stator coil 9 is removed from the housing 20 by unscrewing screws which fix it onto the housing 20, and the X-ray tube unit 5 is removed. In this case, it suffices that the receptacles 300 and 400 are removed from the housing 20 as occasion demands.

Next, a new X-ray tube unit 5 is prepared.

Then, in the housing body 20e, after the new X-ray tube unit 5 is attached by screwing fixing metal fittings of the stator coil 9 to the housing 20, the fixing member 90 is pushed, achieving the attachment. In this case, it suffices that the receptacles 300 and 400 are attached to the housing 20 as occasion demands. Next, the high-voltage cable 61 and the high-voltage supply terminal 44 are connected to each other, and the high-voltage cable 71 and the high-voltage supply terminal 54 are connected to each other.

Subsequently, the lid portions 20f, 20g and 20h are attached to the housing body 20e, thus forming an X-ray tube assembly which is in an empty state. Then, the housing 20 is filled with a coolant 7. Thereby, the X-ray tube assembly is completed, and the replacement operation for the X-ray tube 30 ends.

According to the first embodiment, in the X-ray tube unit 5 and the X-ray tube assembly having the above structures, the X-ray tube unit 5 comprises the X-ray tube 30 and the shield structure 6. The shield structure 6 surrounds the entire vacuum space of the vacuum envelope 31 in a direction perpendicular to the axis a. The shield structure 6 includes the X-ray transmission region R1 and the X-ray shield region R2 surrounding the X-ray transmission region R1. The X-ray transmission region R1 permits X-rays to be transmitted therethrough, and the X-ray shield region R2 serves as a shield against X-rays. Between the shield structure 6 and the vacuum envelope 31, the flow passage CC for flowing of the coolant 7 is provided. In this case, local overheating does not easily occur in the X-ray tube 30, as compared with the case where the flow passage CC is not provided; and the heat dissipation of the anode target 35 can thus be improved.

The shield structure 6 can block X-rays which do not travel toward the through hole 6bh. For example, in the case where the X-ray tube assembly is mounted on an apparatus for medical diagnosis, it can prevent unnecessary radiation of X-rays on the body of a person (prevent the person from getting exposed to radiation of X-rays).

With the X-ray tube unit 5 alone, it is possible to conduct a confirmation test to confirm that X-rays do not leak from part of the shield structure 6, which is other than the through hole 6bh. In the first embodiment, the shield structure 6 includes the insulating member 6a, and it is therefore further possible to conduct a confirmation test with the X-ray tube unit alone to check the durability thereof against voltage. Also, a reliability test can be conducted with the X-ray tube unit 5 alone, as described above, without the need to incorporate the X-ray tube unit 5 into the X-ray tube assembly. A transportation cost can be reduced, since it is possible to transport the X-ray tube unit 5 without the need to incorporate it into the X-ray tube assembly.

Since the insulating member 6a surrounds the X-ray tube 30, it is possible to improve the durability thereof against voltage.

Between the shield structure 6 and the vacuum envelope 31, the flow passage CC is provided. The X-ray tube assembly includes the circulation unit 23. It is therefore possible to improve dissipation of heat radiated from the anode target. Furthermore, it is possible to reduce overheating of the vacuum envelope 31, and also reduce occurrence of discharge at the X-ray tube 30.

In general, in order to prevent undesired radiation of X-rays to the outside of the housing, a lead plate is bonded to the inner surface of the housing body. It should be noted that the inner surface of the housing body comprises a number of curved surfaces. Thus, it requires a great deal of skill to bond the lead plate to the inner surface of the housing body with no gaps. This is a stumbling block against lowering of the manufacturing cost and also lowering of the prices of manufactured goods. Furthermore, for example, after the life of the rotation anode X-ray tube assembly ends, the lead plate and the housing are separated from each other; however, it is very hard to do so. Thus, this separation is performed by a specialist. If the lead plate and the housing cannot be separated from each other, they will be disposed of as an ordinary industrial waste. That is, they cannot be usefully utilized as resources. Thus, it is not desirable.

In view of the above, in the first embodiment, the X-ray tube assembly is provided with the shield structure 6. After formed outside the housing 20, the shield structure 6 is incorporated into the housing 20. Thus, in the first embodiment, a lead plate does not need to be bonded to the inner surface of the housing 20, and the shield structure 6, which is tubular, can be easily manufactured, as compared with the case where the lead plate is bonded to the inner surface of the housing. Therefore, the manufacturing cost of the housing 20 can be reduced. Furthermore, lead can be easily separated from the shield structure 6, and it can thus be applied as resources. This can contribute to useful utilization of lead as resources.

Furthermore, since the X-ray shield 6b can be formed to have a smaller size (diameter), usage of material (lead) can be decreased, and it can be made lighter. In addition, the accuracy of shielding against X-rays can be increased. This is because if a lead plate were bonded to the inner surface of the housing 20, X-rays could leak from a gap or gaps between the lead plate and the inner surface.

The insulating member 6a is superior to the coolant 7 in insulating characteristic. Due to provision of the insulating member 6a, an insulation path between the X-ray tube 30 and the housing 20 can be shortened, as compared with the case where the insulating member 6a is not provided. Thus, the X-ray tube assembly can be made smaller. In addition, the X-ray tube assembly can be made to have a smaller size and a higher durability against voltage; that is, the reduction of the size and the improvement of the durability can be achieved at the same time. Furthermore, as described above, it is possible to conduct the confirmation test with the X-ray tube unit 5 alone to confirm the durability against voltage, and omit the confirmation test to confirm the durability against voltage, with the X-ray tube unit 5 incorporated into the housing 20.

In the case where the shield structure 6 has a certain strength and ductility, it can function as a protection member. To be more specific, if the anode target 35 is broken during the high-seed rotating operation, the shield structure 6 protects the housing 20 against fragments of the anode target 35, which fly while having a high kinetic energy. Even if the fragments of the anode target 35 collide with the shield structure 6, the shield structure 6 is sufficiently deformed, and can thus absorb the high kinetic energy of the fragments.

It is therefore possible to prevent generation of a crack or cracks in the housing 20, which would be generated if the above feature is absent. For example, in the case where the X-ray tube assembly is mounted on an apparatus for medical diagnosis, it is possible to eliminate the risk that coolant 7 having a high temperature will fly on an object to be examined (for example, the body of a person).

Furthermore, in the case where the shield structure 6 functions as a protection member, the housing 20 can be formed of resin material as in the first embodiment. Although the resin material has a lower mechanical strength than that of metal, it is inexpensive. Thus, the manufacturing cost and weight of the housing 20 can be decreased if the resin material is applied.

For the above reason, it is possible to obtain an X-ray tube assembly and an X-ray tube unit 5, which can be alone subjected to an X-ray leakage test, and can also improve the heat dissipation of the anode target 35.

Furthermore, in the X-ray tube assembly, the manufacturing cost of the housing 20 can be decreased.

### Second Embodiment

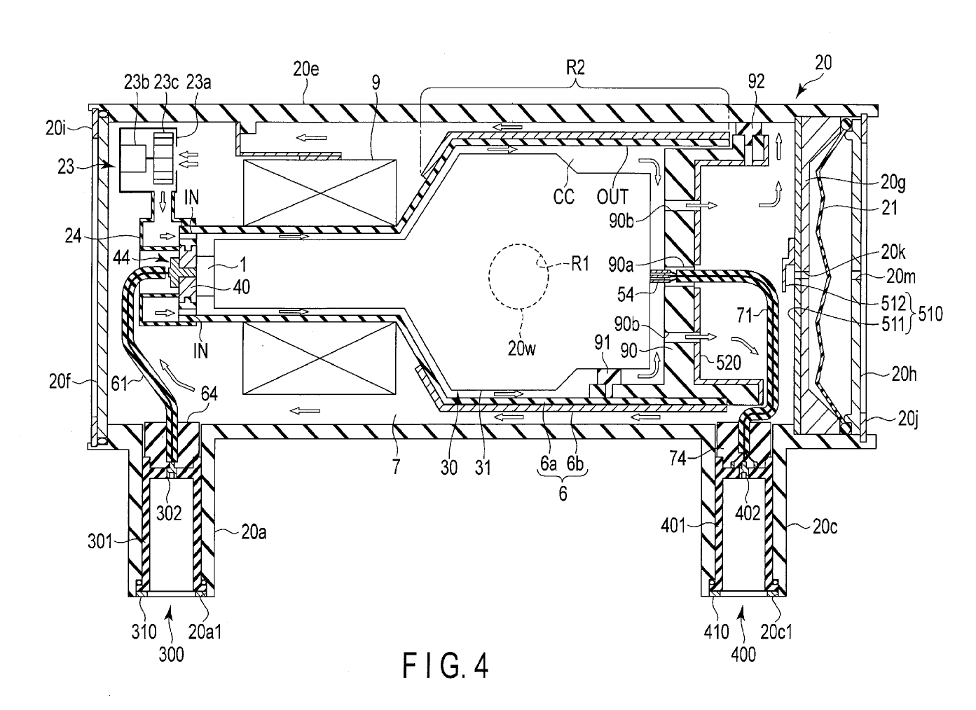

Next, a rotation anode X-ray tube assembly according to the second embodiment will be explained. In the second embodiment, elements having the same functions as those in the first embodiment will be denoted by the same reference numerals as in the first embodiment, and their detailed explanations will be omitted. FIG. 4 is a cross-sectional view showing the X-ray tube assembly according to the second embodiment.

As shown in FIG. 4, roughly speaking, the X-ray tube assembly according to the second embodiment is formed in the same manner as the X-ray tube assembly according to the first embodiment, except for the location of the circulation unit 23. That is, they are different from each other in location of the circulation unit 23. In the second embodiment, the circulation unit 23 is provided on a side where a high-voltage supply terminal 44 is located, not a side where a high-voltage supply terminal 54 is located.

The X-ray tube assembly further comprises a cavity portion 24 formed of an electrically insulating material. The cavity portion 24 includes a tubular inner peripheral wall, a tubular outer peripheral wall and annular end walls. One of the annular end walls liquid-tightly closes an end of each of the inner and outer peripheral walls, and the other liquid-tightly closes the other end of each of the inner and outer peripheral walls. In the second embodiment, the other end wall is made up of the connection member 40 and an insulating member 6a, and includes a plurality of intakes IN. An opening formed in part of the outer peripheral wall liquid-tightly communicates with an outlet of a chamber 23a. The cavity portion 24 serves as a flow passage which connects the outlet of the chamber 23a and the intakes IN. Thus, a coolant flows in a flow passage CC from the side where the high-voltage supply terminal 44 is located to the side where the high-voltage supply terminal 54 is located.

In the second embodiment, the circulation unit 23 and the cavity portion 24 are formed as a single body, and detachably attached to an X-ray tube unit 5.

An X-ray shielding member 510 is formed without having a third shield portion 513.

A fixing member 90 includes a tubular projection portion projecting toward a first shielding member 511. The projection portion is located, with a gap provided between the projection portion and the first shielding member 511. The gap is used as a passage for allowing the high-voltage cable 71 to be passed therethrough and also as a flow passage for the coolant 7. An X-ray shielding member 520 is formed at an entire surface of part of the fixing member 90, which includes the projection portion and is located opposite to the first shielding member 511. The X-ray shielding member 510 and the X-ray shielding member 520 can block X-rays radiated to the outside of an X-ray transmission region R1, and can thus prevent leakage of X-rays from a housing 20 to the outside thereof.

In the above X-ray tube unit 5 and the X-ray tube assembly having the above structure according to the second embodiment, the X-ray tube unit 5 comprises an X-ray tube 30 and a shield structure 6. The circulation unit 23 according to the first embodiment is formed such that the coolant 7 is taken in from the flow passage CC, whereas that according to the second embodiment is formed such that the coolant 7 is discharged into the flow passage CC. In this case also, the coolant 7 can be made to flow in the flow passage CC as in the first embodiment. Therefore, the X-ray tube unit 5 and the X-ray tube assembly according to the second embodiment can obtain the same advantages as in the first embodiment.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

### Third Embodiment

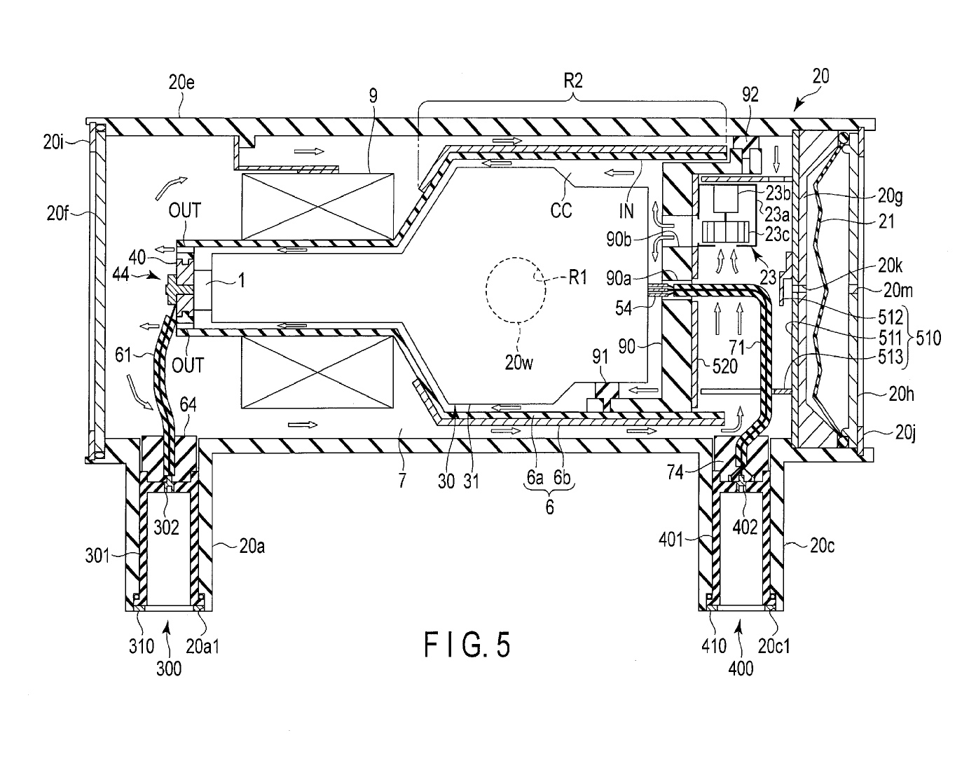

A rotation anode X-ray tube assembly according to the third embodiment will be explained. In the third embodiment, elements having the same functions as those in the first embodiment will be denoted by the same reference numerals as in the first embodiment, and their detailed explanations will be omitted. FIG. 5 is a cross-sectional view showing the X-ray tube assembly according to the third embodiment.

As shown in FIG. 5, roughly speaking, the X-ray tube assembly according to the third embodiment is formed in the same manner as the X-ray tube assembly according to the first embodiment, except for the function of the circulation unit 23. That is, they are different from each other in function of the circulation unit 23. In a chamber 23a, an outlet is located opposite to a through hole 90b; that is, an intake is not opposite thereto. The circulation unit 23 discharges a coolant taken in from the inside of a housing 20, into the through hole 90b. Thus, the coolant flows in a flow passage CC from a side where a high-voltage supply terminal 54 is located to a side where a high-voltage supply terminal 44 is located.

In an X-ray tube unit 5 and the X-ray tube assembly having the above structure according to the third embodiment, the X-ray tube unit 5 comprises an X-ray tube 30 and a shield structure 6. The circulation unit 23 according to the third embodiment also causes the coolant 7 to flow in the flow passage CC. In this regard, it is the same as the circulation units 23 according to the first and second embodiments. Therefore, the X-ray tube unit 5 and the X-ray tube assembly according to the third embodiment can obtain the same advantages as in the first embodiment.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

### Modifications of First to Third Embodiments

Modifications of the X-ray tube units 5 of the X-ray tube assemblies according to the first to third embodiments will be explained.

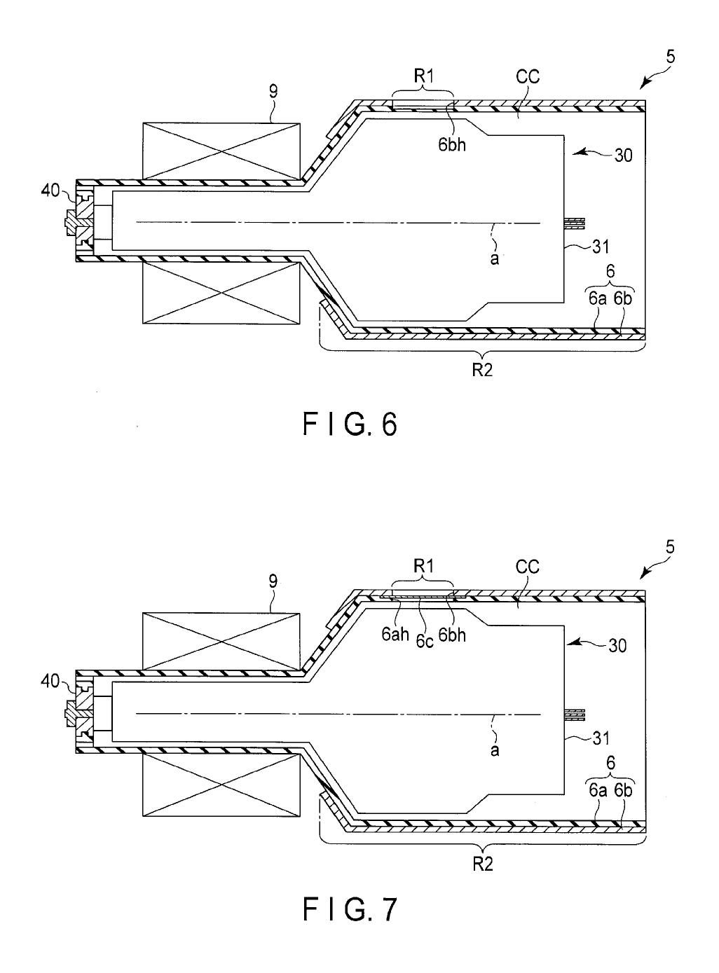

FIG. 6 is a cross-sectional view showing a modification of the X-ray tube units of the X-ray tube assemblies according to the first to third embodiments. The insulating member 6a may be formed such that its thickness varies as shown in FIG. 6. Part of the insulating member 6a which is located in the X-ray transmission region R1 is thinner than part of the insulating member 6a which is located the X-ray shield region R2. Thereby, it is possible to improve an X-ray transmission rate because of the insulating member 6a (the shield structure 6).

FIG. 7 is a cross-sectional view showing another modification of the X-ray tube units of the X-ray tube assemblies according to the first to third embodiments. As shown in FIG. 7, the insulating member 6a includes a through hole 6ah located in the X-ray transmission region R1. The through hole 6ah is, for example, circular. The through holes 6ah and 6bh are stacked together.

The shield structure 6 includes a partition plate 6c which is thinner than the insulating member 6a, and permits X-rays to be easily transmitted through the partition plate 6c. It is preferable that the partition plate 6c be formed of, for example, resin or beryllium, which is material having a good X-ray transmission characteristic. The partition plate 6c is formed, for example, discoid. The partition plate 6c is located opposite the through holes 6ah and 6bh, and held between the insulating member 6a and the X-ray shield 6b. The partition plate 6c liquid-tightly closes the through holes 6ah and 6bh. Thereby, it is possible to improve an X-ray transmission rate due to the shield structure 6, without hindering the flow of the coolant 7 in the flow passage CC.

A modification of the X-ray tube units of the X-ray tube assemblies according to the first to third embodiments will be explained.

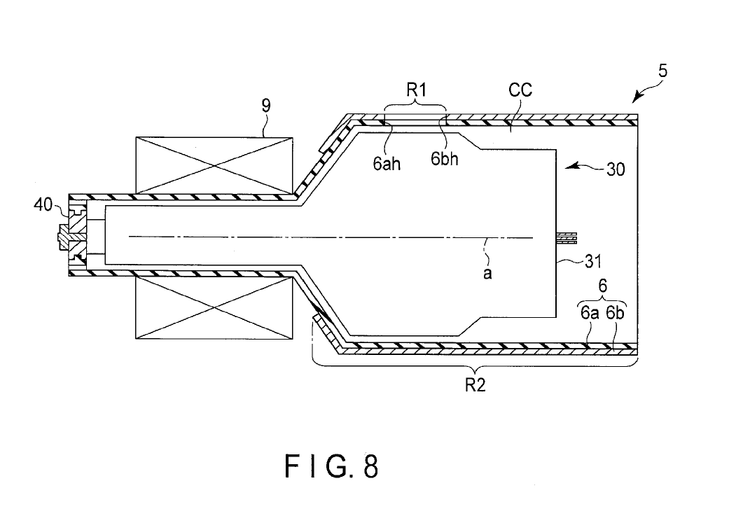

FIG. 8 is a cross-sectional view showing another modification of the X-ray tube units of the X-ray tube assemblies according to the first and second embodiments. As shown in FIG. 8, the insulating member 6a includes the above through hole 6ah. Thereby, the X-ray transmission rate can be improved due to the shield structure 6, and the shield structure 6 can be more easily manufactured than the shield structure 6 as shown in FIGS. 6 and 7.

### Fourth Embodiment

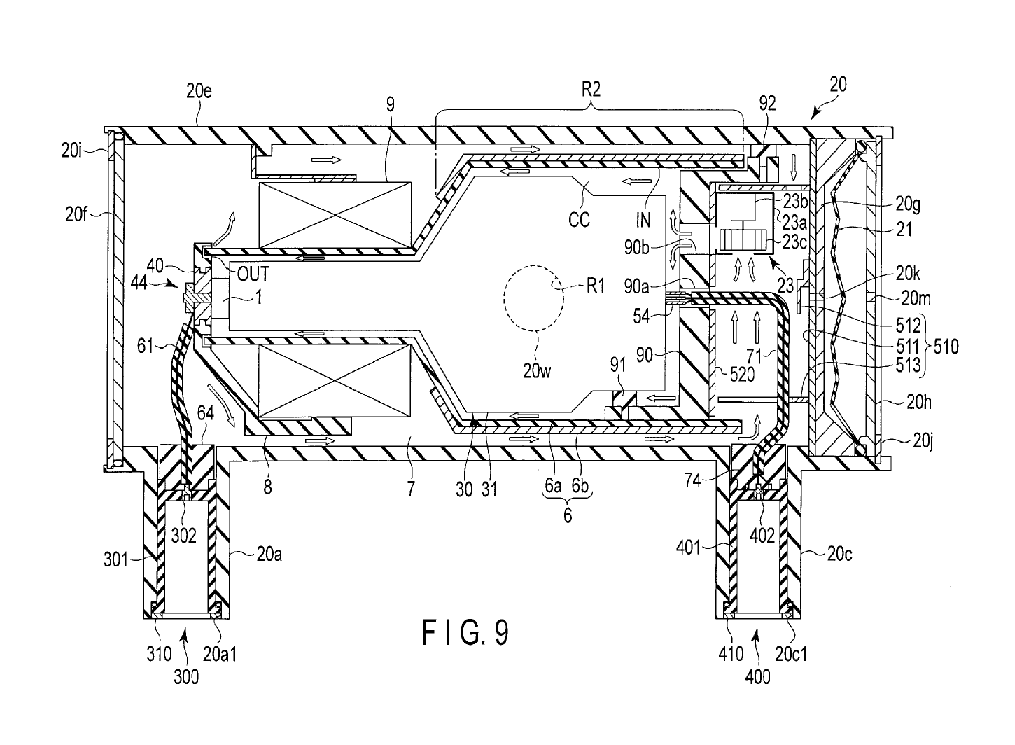

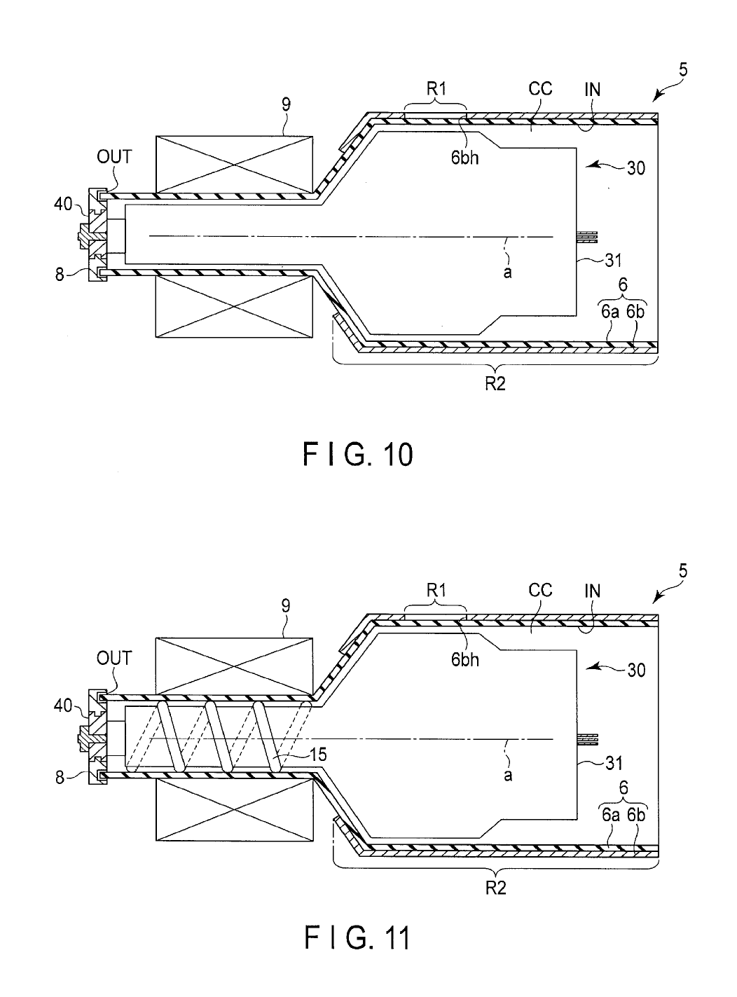

A rotation anode X-ray tube assembly according to the fourth embodiment will be explained. In the fourth embodiment, elements having the same functions as those in the third embodiment will be denoted by the same reference numerals as in the third embodiment, and their detailed explanations will be omitted. FIG. 9 is a cross-sectional view showing the X-ray tube assembly according to the fourth embodiment. FIG. 10 is a cross-sectional view showing a cross section of a rotation anode X-ray tube unit according to the fourth embodiment, which is rotated from the cross section as shown in FIG. 9 by 90°.

As shown in FIGS. 9 and 10, the X-ray tube assembly further comprises a holder 8 as a high-voltage insulating member. The holder 8 is fixed to a connection member 40 and a stator coil 9. The holder 8 holds relative positions of an X-ray tube 30 and the stator coil 9. The holder 8 restricts the position of the shield structure 6 with respect to the X-ray tube 30.

The holder 8 comprises an annular portion and a number of arm portions extending from an outer peripheral portion of the annular portion, the annular portion and the arm portions being provided as a single body. The annular portion includes an inner peripheral portion which is mechanically firmly connected to the connection member 40. The arm portions are located at regular intervals along an outer periphery of the annular portion. The arm portions are connected to the stator coil 9. In the fourth embodiment, the holder 8 includes three arm portions. It should be noted that the number of arm portions may be four or more. The number of arms may be two or less as long as the holder 8 can hold the relative positions of the X-ray tube 30 and the stator coil 9.

The holder 8 and the connection member 40 are not connected to the insulating member 6a (the shield structure 6). The holder 8 (annular portion) includes an annular groove portion. The groove portion is shaped in accordance with the shape of a tubular end portion of the insulating member 6a on the side where a high-voltage supply terminal 44 is located. In the groove portion, the above end portion of the insulating member 6a is inserted, with a gap provided. The gap between the holder 8 and the insulating member 6a form an outlet OUT for taking out a coolant 7 from the flow passage CC.

The X-ray tube 30, the shield structure 6, the connection member 40, the holder 8 and the stator coil 9 form the X-ray tube unit 5.

In the X-ray tube unit 5 and the X-ray tube assembly having the above structures according to the fourth embodiment, the X-ray tube unit 5 comprises the X-ray tube 30 and the shield structure 6. Therefore, the X-ray tube unit 5 and the X-ray tube assembly according to the fourth embodiment can obtain the same advantages as in the third embodiment.

The X-ray tube unit 5 comprises the holder 8. It is possible to restrict the positions of the X-ray tube 30 and the shield structure 6 without connecting the shield structure 6 to the connection member 40 or the holder 8.

Furthermore, as described above, since the shield structure 6 need not to be connected to the connection member 40 or the holder 8, the accuracy with which structural elements of the X-ray tube unit 5 according to the fourth embodiment are combined may be lower than that of the X-ray tube unit 5 according to the third embodiment. Therefore, the X-ray tube unit 5 according to the fourth embodiment can be more easily manufactured than the X-ray tube unit 5 according to the third embodiment.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

### Modifications of Fourth Embodiment

Modifications of the X-ray tube unit of the X-ray tube assembly according to the fourth embodiment will be explained. FIG. 11 is a cross-sectional view showing a modification of the X-ray tube unit of the X-ray tube assembly according to the fourth embodiment. In general, when heat is transmitted to the coolant 7, the temperature of the coolant 7 thereof rises, but varies in the direction of gravitational force. That is, the temperature of the coolant 7 gradually lowers in the direction of gravitational force. Therefore, it is preferable that the temperature distribution of the coolant 7 in the direction of gravitational force be made more uniform.

In view of the above, as shown in FIG. 11, the X-ray tube unit 5 further comprises a separator 15. The separator 15 is located between a vacuum vessel 32 (vacuum envelope 31) and an insulating member 6a (shield structure 6). The separator 15 is helically shaped. It also helically forms part of the flow passage CC. It is formed of an electrical insulating material such as rubber.

The separator 15 is wound around an outer periphery of the vacuum vessel 32, and in contact with an inner periphery of the insulating member 6a. It can therefore fix the X-ray tube 30 and the shield structure 6 by utilizing a friction fit. However, the separator 15 may be spaced from the inner periphery of the insulating member 6a.

It should be noted that the separator 15 may be wound around the inner periphery of the insulating member 6a and in contact with the outer periphery of the vacuum vessel 32, although it becomes hard to form. In this case also, the separator 15 may be spaced from the outer periphery of the vacuum vessel 32.

In the example shown in FIG. 11, the separator 15 is provided opposite to the rotor 10 and a small-diameter portion of the vacuum vessel 32.

This can uniformize the temperature distribution of the coolant 7 in the housing 20.

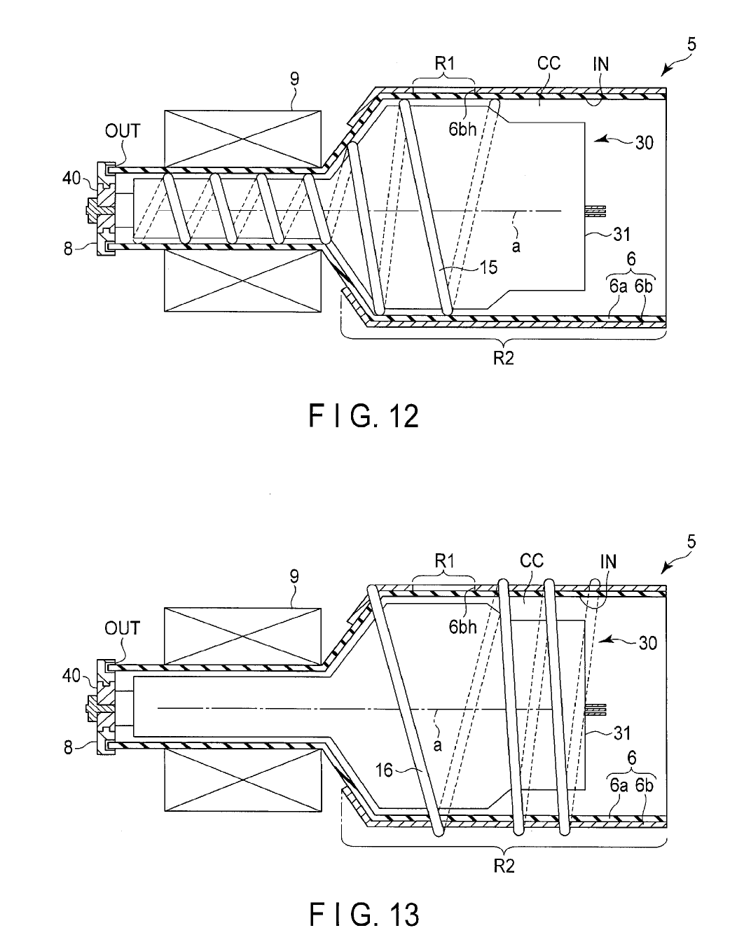

FIG. 12 is a cross-sectional view showing another modification of the X-ray tube unit of the X-ray tube assembly according to the fourth embodiment. As shown in FIG. 12, the separator 15 may be formed to extend to an anode target 35 or a large-diameter portion of the vacuum vessel 32. However, the separator 15 is located apart from an X-ray transmission region R1. Thereby, it is possible to also helically form part of the flow passage CC which is located in the vicinity of the large-diameter portion of the vacuum vessel 32.

FIG. 13 is a cross-sectional view showing still another modification of the X-ray tube unit of the X-ray tube assembly according to the fourth embodiment. As shown in FIG. 13, the X-ray tube unit 5 may further comprise a separator 16. The separator 16 is located between an X-ray shield 6b (shield structure 6) and a housing 20. The separator 16 is helically shaped. It also helically forms part of a flow passage which is located between the X-ray tube unit 5 and the housing 20. It is formed of an electrical insulating material such as rubber.

The separator 16 is wound around an outer periphery of an X-ray shield 6b, and in contact with an inner periphery of the housing 20. The separator 16 can therefore fix the X-ray tube unit 5 to the housing 20 by utilizing a friction fit. However, the separator 16 may be spaced from the inner periphery of the housing 20.

It should be noted that the separator 16 may be wound around the inner periphery of the housing 20 and in contact with the outer periphery of the X-ray shield 6b, although it becomes hard to make. In this case also, the separator 16 may be spaced from the outer periphery of the X-ray shield 6b.

In the above modification, part of the flow passage CC is helically formed using the separator 15; however, the flow passage CC may be helically formed by another method. For example, the flow passage CC may be helically formed without adding a given member such as the separator 15.

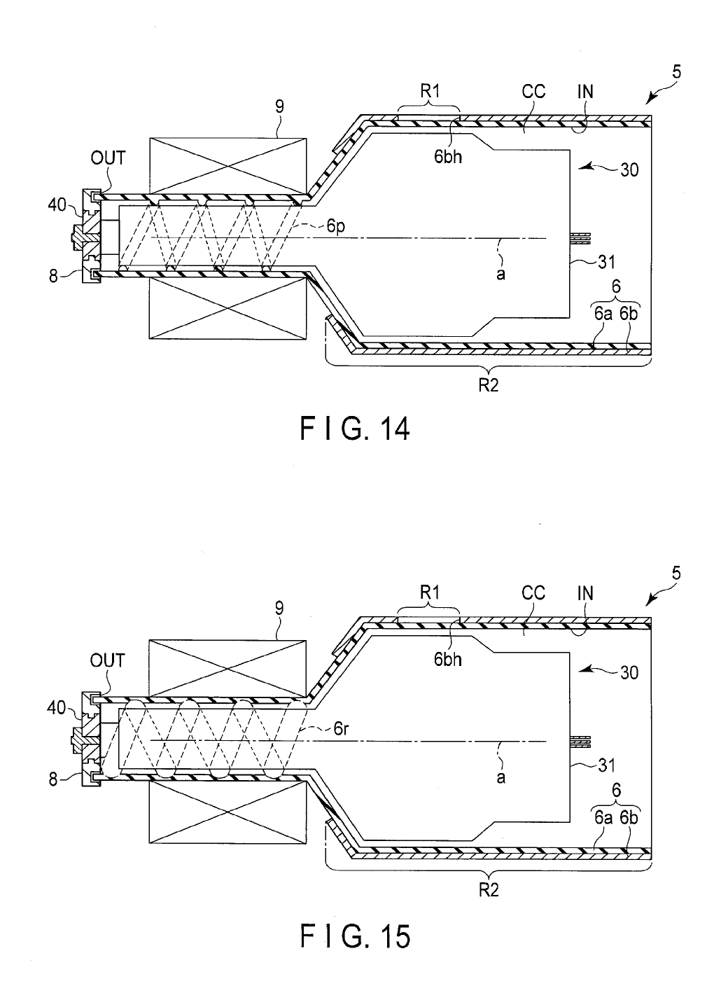

FIG. 14 is a cross-sectional view showing a further modification of the X-ray tube unit of the X-ray tube assembly according to the fourth embodiment. As shown in FIG. 14, the insulating member 6a may have a helical projection 6p formed at the inner peripheral surface of the insulating member 6a. The projection 6p does not have elasticity, and is therefore spaced from the outer periphery of a vacuum vessel 32. In this case also, it is possible to helically form part of the flow passage CC which is located in the vicinity of a small-diameter portion of the vacuum vessel 32.

FIG. 15 is a cross-sectional view showing a still further modification of the X-ray tube unit of the X-ray tube assembly according to the fourth embodiment. As shown in FIG. 15, an insulating member 6a may have a helical groove portion 6r formed in the inner peripheral surface of the insulating member 6a. In this case also, it is possible to helically form part of the flow passage CC which is located in the vicinity of a small-diameter portion of the vacuum vessel 32.

### Fifth Embodiment

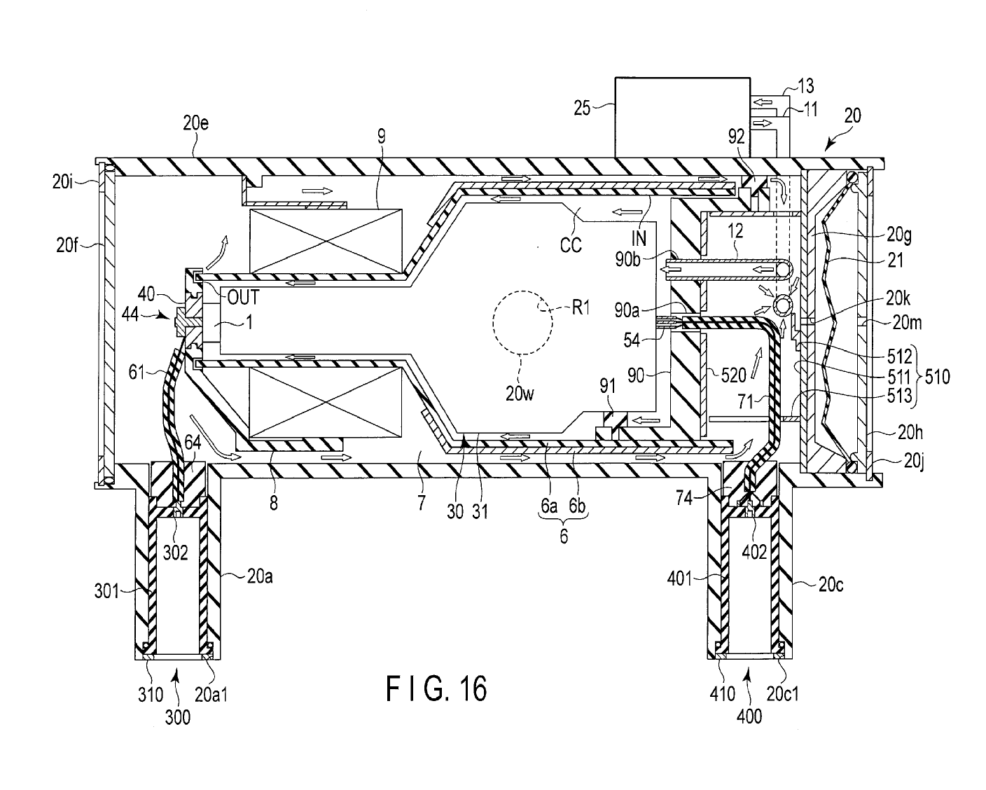

A rotation anode X-ray tube assembly according to the fifth embodiment will be explained. In this embodiment, elements having the same functions as those in the fourth embodiment will be denoted by the same reference numerals as in the fourth embodiment, and their detailed explanations will be omitted. FIG. 16 is a cross-sectional view showing the X-ray tube assembly according to the fifth embodiment. It should be noted that in FIG. 16, the denotation of an X-ray shield region R2 is omitted; however, actually, it is provided in the same manner as in the fourth embodiment.

As shown in FIG. 16, the X-ray tube assembly is formed without having a circulation unit 23. The X-ray tube assembly further comprises a circulation pump 25 serving as a circulation unit and pipes 11, 12 and 13. It suffices that the pipes 11, 12 and 13 can feed a coolant 7. They are formed of, for example, hoses. The circulation pump 25 is fixed to an outer surface of a housing body 20e (housing 20).

One of end portions of the pipe 11 is liquid-tightly connected to an outlet of the circulation pump 25. The pipe 11 extends through an opening not shown which is provided in the housing body 20e and a through hole formed in a third shielding member 513 such that the other end portion of the pipe 11 is located in the housing 20. The opening of the housing body 20e through which the pipe 11 extends is liquid-tightly closed.

The pipe 12 is fixed to a fixing member 90. The pipe 12 is made to extend through the through hole 90b. One of end portions of the pipe 12 communicates with the other end portion of the pipe 11. The other end portion of the pipe 12 is located opposite to an X-ray tube 30 and communicates with an intake IN.

One of end portions of the pipe 13 is located in part of internal space of the housing 20, which is located between the fixing member 90 and the lid portion 20g. The pipe 13 extend through the through hole formed in the third shielding member 513 and the opening not shown provided in the housing body 20e such that the other end portion of the pipe 13 is liquid-tightly connected to an intake of the circulation pump 25. The opening of the housing body 20e, through which the pipe 13 extends, is liquid-tightly closed.

The circulation pump 25 can discharge the coolant 7 taken in from the pipe 13 into the pipe 11, and cause forced convection to occur in the housing 20. Thus, the coolant 7 can be circulated in the housing 20. Furthermore, a flow passage CC can produce a flow of the coolant 7.

In the X-ray tube unit 5 and the X-ray tube assembly having the above structures according to the fifth embodiment, the X-ray tube unit 5 comprises an X-ray tube 30 and a shield structure 6. Therefore, the X-ray tube unit 5 and the X-ray tube assembly according to the fifth embodiment can obtain the same advantages as in the fourth embodiment.

The X-ray tube assembly comprises a circulation pump 25. Since the circulation pump 25 can be located outside the housing 20, and a large pump can be applied as the circulation pump 25, it can feed the coolant 7 at a higher pressure level than the above circulation unit 23. It is possible to further circulate the coolant 7 in the housing 20, and uniformize the temperature distribution of the coolant 7 in the housing 20.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

### Sixth Embodiment

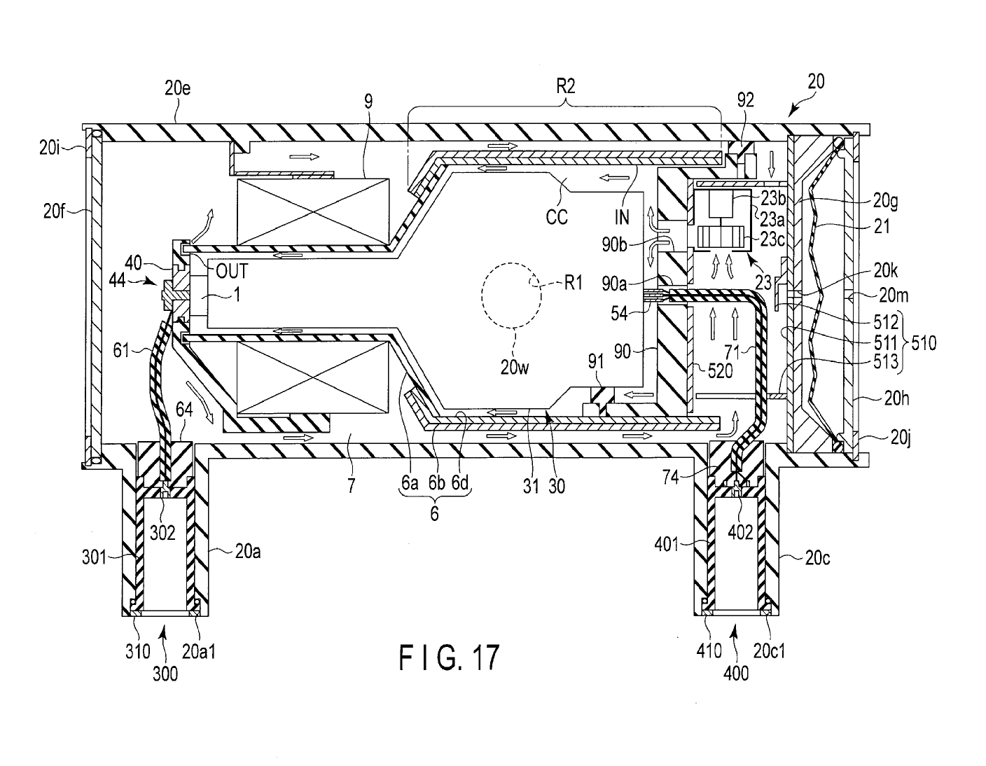

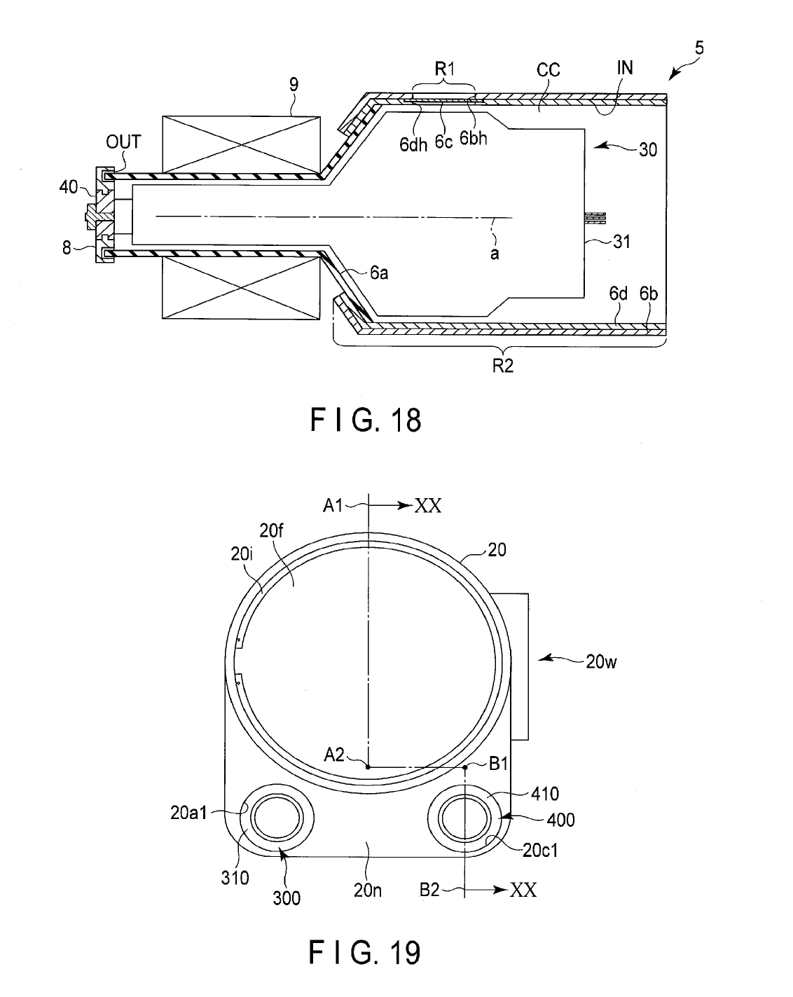

A rotation anode X-ray tube assembly according to the sixth embodiment will be explained. In this embodiment, elements having the same functions as those in the fourth embodiment will be denoted by the same reference numerals as in the fourth embodiment, and their detailed explanations will be omitted. FIG. 17 is a cross-sectional view showing the X-ray tube assembly according to the sixth embodiment. FIG. 18 is a cross-sectional view showing a cross section of a rotation anode X-ray tube unit according to the sixth embodiment, which is rotated from the cross section as shown in FIG. 17 by 90°.

As shown in FIGS. 17 and 18, a shield structure 6 includes an insulating member 6a, a X-ray shield 6b, a partition plate 6c, and a metal member 6d. The X-ray shield 6b is formed in the same manner as the X-ray shield 6b according to the fourth embodiment. The insulating member 6a and the metal member 6d function as shells. A flow-passage formation member formed of the insulating member 6a and the metal member 6d forms a flow passage for a coolant 7, which is located between the flow-pass formation member and a vacuum envelope 31.

The metal member 6d surrounds a large-diameter portion of the vacuum envelope 31 in the direction perpendicular the axis a. The metal member 6d is cylindrically formed. In this embodiment, the metal member 6d is shaped to be in close contact with an X-ray shield 6b. To the metal member 6d, the X-ray shield 6b is bonded. The metal member 6d is provided in the X-ray shield region R2, and stacked on the X-ray shield 6b. The metal member 6d includes a through hole 6dh located in an X-ray transmission region R1. The through hole 6dh is, for example, circular. The through holes 6dh and 6bh are stacked together. The through hole 6dh serves as an X-ray transmission window. The metal member 6d is located between the X-ray shield 6b and an X-ray tube 30.

The metal member 6d is formed of metal material having such ductility and a strength as to absorb the kinetic energy of fragments of an anode target 35. As the above metal material, it is possible to use, for example, a hard lead in which antimony or the like is added to a lead or a stainless steel. In the case where the metal member 6d is formed of a hard lead or the metal member 6d is formed to have a sufficiently greater thickness, the X-ray shield 6b can be omitted. The metal member 6d can function as a protection body. Since the shield structure 6 and the housing 20 are provided, with a gap interposed between them, the housing 20 itself can be prevented from being deformed even if the metal member 6d (the shield structure 6) is deformed. It is therefore possible to prevent generation of a crack or cracks in the housing 20, which would be generated if the above feature is absent.

It is preferable that the partition plate 6c be formed of, for example, resin or beryllium, which is material having a good X-ray transmission characteristic. The partition plate 6c is formed, for example, discoid. The partition plate 6c is located opposite through holes 6bh and 6dh, and held between the metal member 6d and the X-ray shield 6b. The partition plate 6c liquid-tightly closes the through holes 6bh and 6dh. Thereby, it is possible to improve an X-ray transmission rate due to the shield structure 6, without hindering the flow of the coolant 7 in a flow passage CC.

The insulating member 6a is shorter than the insulating member 6a according to the fourth embodiment, and one end portion of the insulating member 6a is formed in the shape of a conical tube. One end portion of the insulating member 6a is in close contact with an end portion of the metal member 6d. The insulating member 6a surrounds a small-diameter portion of the vacuum envelope 31 in the direction perpendicular to the axis a.

In the X-ray tube unit 5 and the X-ray tube assembly having the above structures according to the sixth embodiment, the X-ray tube unit 5 comprises an X-ray tube 30 and a shield structure 6. Therefore, the X-ray tube unit 5 and the X-ray tube assembly according to the sixth embodiment can obtain the same advantages as in the fourth embodiment.

The shield structure 6 comprises the metal member 6d, which is located opposite to the anode target 35. Thus, the shield structure 6 can be made to have an enhanced absorption power for absorbing the kinetic energy of the fragments of the anode target 35, as compared with the shield structure 6 according to the fourth embodiment. It is therefore possible to further reliably prevent generation of a crack or cracks in the housing 20, which would be generated if the above feature is absent.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

### Seventh Embodiment

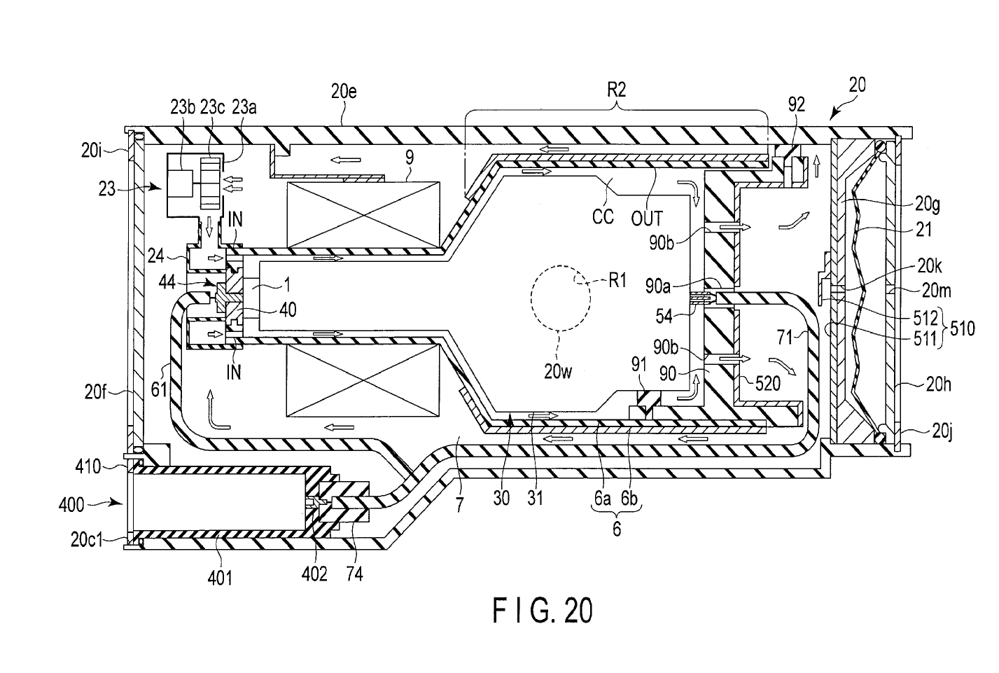

A rotation anode X-ray tube assembly according to the seventh embodiment will be explained. With respect to the seventh embodiment, elements having the same functions as those in the second embodiment will be denoted by the same reference numerals as in the second embodiment, and their detailed explanations will be omitted. FIG. 19 is a schematic view showing the X-ray tube assembly according to the seventh embodiment, and also showing the X-ray tube assembly as viewed from a receptacle side. FIG. 20 is a cross-sectional view taken along line XX-XX in FIG. 19. To be more specific, FIG. 20 is a view obtained by combining a cross-sectional view taken along line A1-A2 in FIG. 19 and a cross-sectional view taken along line B1-B2 in FIG. 19.

As shown in FIGS. 19 and 20, at part of the housing body 20e, a projection portion is formed which projects in the direction perpendicular to the tube axis. It should be noted that the projection portion is relatively easily formed. The projection portion of the housing body 20e and the X-ray shield 6b (the shield structure 6) form a passage (pass) through which the high-voltage cable 71 is passed. It should be noted that needless to say, the passage (the high-voltage cable 71) is located away from a location opposite to the X-ray output window 20w of the housing 20.

The housing 20 includes a side portion 20n. The side portion 20n closes together with the lid portion 20f, an end portion of the housing body 20e. An opening 20a1 and an opening 20c1 are formed in the side portion 20n.

The receptacles 300 and 400 are attached to the side portion 20n. The receptacles 300 and 400 extend along the tube axis. It should be noted that the longitudinal direction of the housing 20 is parallel to the tube axis. The housing 301 extends from the opening 20a1 to space between the X-ray tube 30 and the housing body 20e in the direction perpendicular to the tube axis. The housing 401 extends from the opening 20c1 to space between the X-ray tube 30 and the housing body 20e in the direction perpendicular to the tube axis.

In the X-ray tube unit 5 and the X-ray tube assembly having the above structures according to the seventh embodiment, the X-ray tube unit 5 comprises an X-ray tube 30 and a shield structure 6. Therefore, the X-ray tube unit 5 and the X-ray tube assembly according to the seventh embodiment can obtain the same advantages as in the second embodiment.

The receptacles 300 and 400 are located between the X-ray tube 30 and the housing body 20e in the direction perpendicular to the tube axis of the X-ray tube assembly. A conventional structure is not adopted in which a receptacle is provided between an X-ray tube 30 and a housing 20 (lid portion) in the direction along to the tube axis. Therefore, the seventh embodiment can reduce the size of the X-ray tube assembly, as compared with the conventional structure.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

### Eighth Embodiment

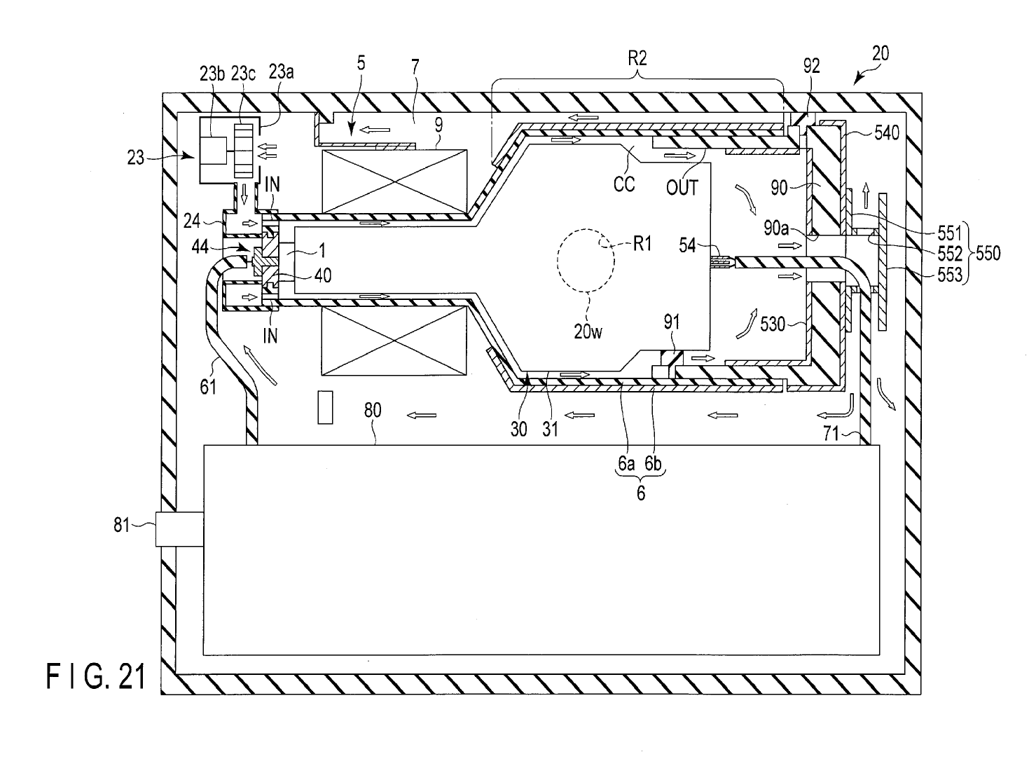

A rotation anode X-ray tube assembly according to the eighth embodiment will be explained. With respect to the eighth embodiment, elements having the same functions as those in the second embodiment will be denoted by the same reference numerals as in the second embodiment, and their detailed explanations will be omitted. FIG. 21 is a cross-sectional view showing the X-ray tube assembly according to the eighth embodiment.

As shown in FIG. 21, a housing 20 is formed closed without having any of lid portions 20f, 20g and 20h and tube portions 20a and 20c. The housing 20 includes a lid portion not shown. In the X-ray tube assembly, neither a receptacle 300 nor a receptacle 400 is formed.

The inner peripheral surface of an insulating member 6a is in contact with a fixing member 90. Alternatively, the inner peripheral surface of the insulating member 6a is located opposite to the fixing member 90, with a slight gap provided between them. Thus, an outlet OUT is provided between the vacuum envelope 31 and the fixing member 90. The fixing member 90 includes no through hole 90b. Thus, the through hole 90a also serves as a passage for a coolant 7.

An X-ray shielding member 530 is bonded to a surface of the fixing member 90, which is located opposite to an X-ray tube 30. An end portion of the X-ray shielding member 530 is located opposite to the X-ray shield 6b in the direction perpendicular to the tube axis. Also, an opening is formed in part of the X-ray shielding member 530, which is located opposite to the through hole 90a.

An X-ray shielding member 540 is bonded to a surface of the fixing member 90, which is located opposite to the fixing member 90. An end portion of the X-ray shielding member 540 is located close to the X-ray shield 6b in the direction perpendicular to the tube axis. Also, an opening is formed in part of the X-ray shielding member 540, which is located opposite to the through hole 90a.

An X-ray shielding member 550 includes an annular portion 551, a tubular portion 552 and a plate portion 553. The annular portion 551 is formed on the X-ray shielding member 540, and an opening of the annular portion 551 is located opposite to the through hole 90a. The plate portion 553 is, for example, a disk, and located apart from and opposite to the annular portion 551. The tubular portion 552 is located between the annular portion 551 and the plate portion 553, and joins the annular portion 551 and the plate portion 553 to each other. In the tubular portion 552, a number of through holes are formed. The through holes are used as a passage through which the high-voltage cable 71 is passed, and a passage for the flow of the coolant 7. The X-ray shielding member 550 prevents leakage of X-rays from the through hole 90a.

The X-ray tube assembly further comprises a high-voltage generator 80 as a high-voltage unit. The high-voltage generator 80 is accommodated along with an X-ray tube unit 5, etc., in the housing 20, and immersed in the coolant 7. Such an X-ray tube assembly is called a manoblock or a mono-tank or the like. The high-voltage generator 80 applies a high voltage to the X-ray tube 30. A primary voltage supplying terminal 81 of the high-voltage generator 80 is extended to the outside of the housing 20 through an opening 20p of the housing 20. It should be noted that the opening 20p is liquid-tightly closed. The high-voltage cable 61 is connected to an output terminal for anode which is provided in the high-voltage generator 80, and the high-voltage cable 71 is connected to an output terminal for cathode which is provided in the high-voltage generator 80.

In the X-ray tube unit 5 and the X-ray tube assembly having the above structures according to the eighth embodiment, the X-ray tube unit 5 comprises an X-ray tube 30 and a shield structure 6. The X-ray tube unit 5 and the X-ray tube assembly according to the eighth embodiment can obtain the same advantages as in the second embodiment.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

### Ninth Embodiment

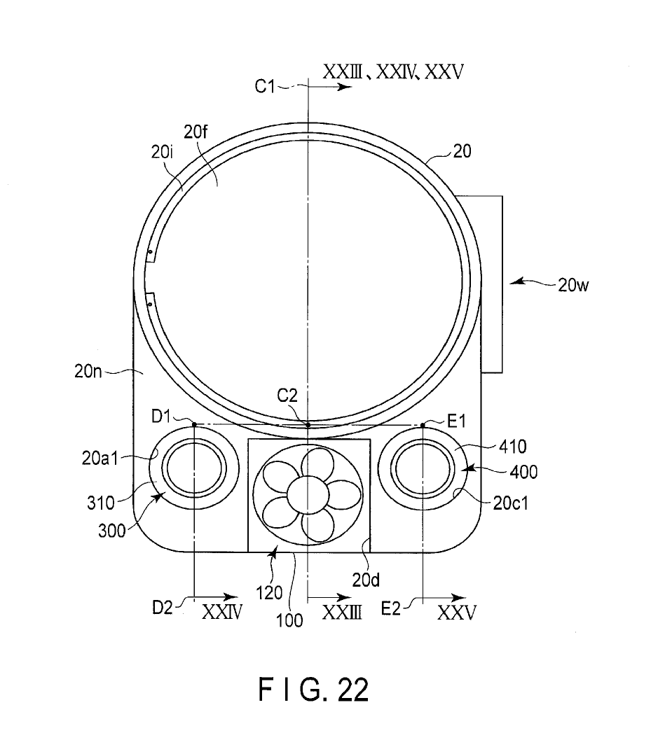

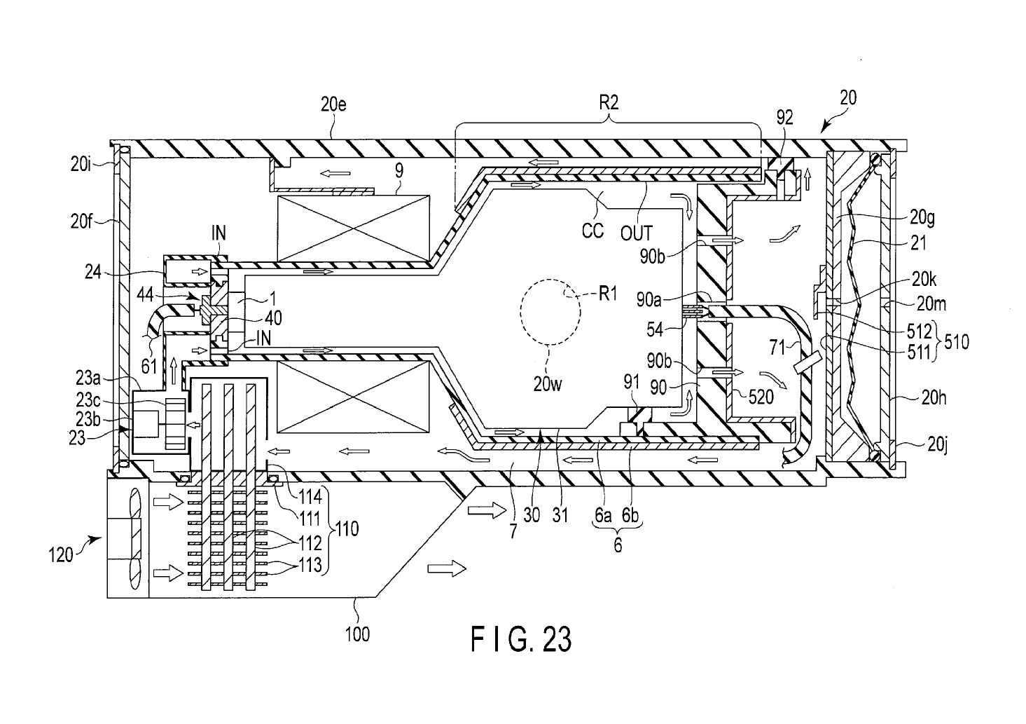

A rotation anode X-ray tube assembly according to the ninth embodiment will be explained. In the ninth embodiment, elements having the same functions as those in the seventh embodiment will be denoted by the same reference numerals as in the seventh embodiment, and their detailed explanations will be omitted. FIG. 22 is a schematic view showing the X-ray tube assembly according to the ninth embodiment, and also showing the X-ray tube assembly as viewed from a receptacle side. FIG. 23 is a cross-sectional view taken along line XXIII-XXIII in FIG. 22.

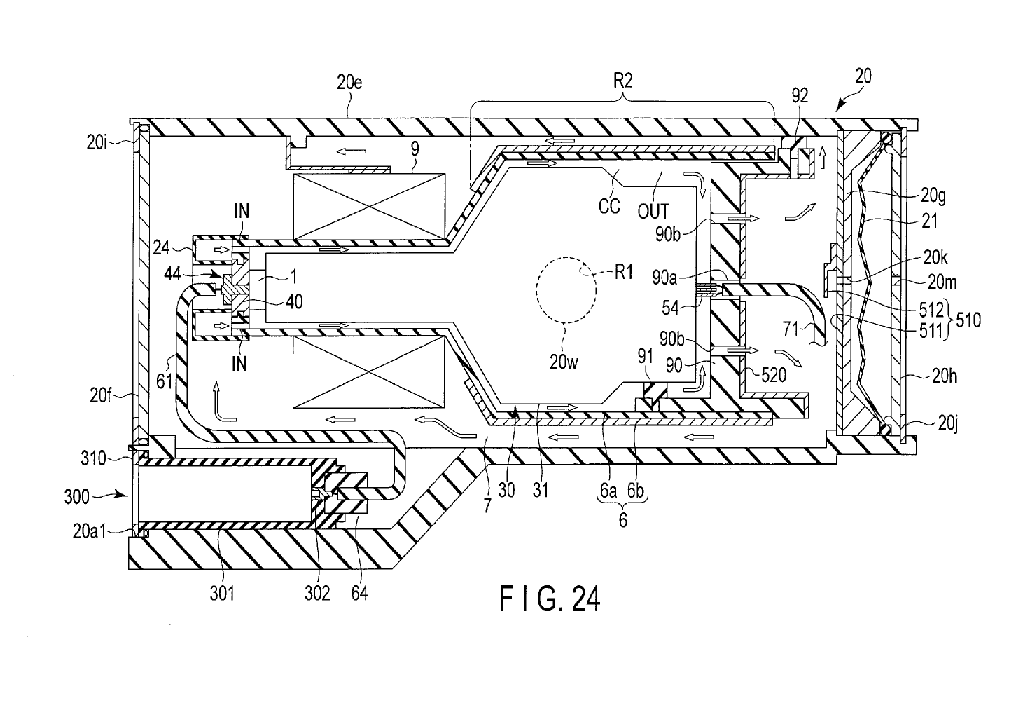

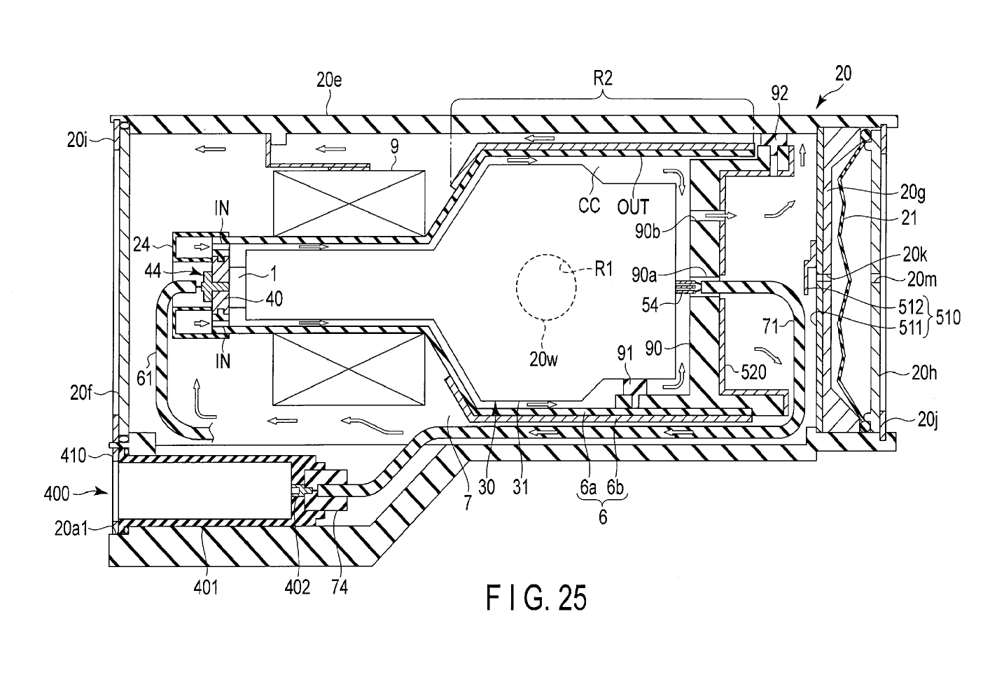

FIG. 24 is a cross-sectional view taken along line XXIV-XXIV in FIG. 22. To be more specific, FIG. 24 is a view obtained by combining a cross-sectional view taken along line C1-C2 in FIG. 22 and a cross-sectional view taken along line D1-D2 in FIG. 22. FIG. 25 is a cross-sectional view taken along line XXV-XXV in FIG. 22. To be more specific, FIG. 25 is a view obtained by combining a cross-sectional view taken along line C1-C2 in FIG. 22 and a cross-sectional view taken along line E1-E2 in FIG. 22.

As shown in FIGS. 22, 23, 24 and 25, the housing 20 includes a concave portion 20d. The concave portion 20d is located between the receptacle 300 and the receptacle 400, and extends along the tube axis. In the direction perpendicular to the tube axis, an opening side of the concave portion 20d is covered by a closing member 100. The concave portion 20d and the closing member 100 form a duct.

The X-ray tube assembly comprises an air-cooling radiator 110. The air-cooling radiator 110 comprises a lid portion 111, a number of heat pipes 112, a number of fins 113 and a chamber 114. The air-cooling radiator 110 is located in the housing 20 and outside the housing 20 (in the above duct). The air-cooling radiator 110 is liquid-tightly attached to the housing 20, and radiates heat of a coolant 7 to the outside of the housing 20.

The lid portion 111 is provided at an opening of the housing 20, and fastened to the housing 20 by a fastener not shown. In the housing 20, a groove portion is formed in the shape of a frame and opposite to the lid portion 111. The gap between the housing 20 and the lid portion 111 is liquid-tightly sealed by an O-ring provided in the groove portion. The O-ring has a function of preventing leakage of the coolant 7 from the housing 20 to the outside thereof.

The heat pipes 112 are liquid-tightly attached to the lid portion 111, and extend to the inside and outside of the housing 20. The fins 113 are located outside the housing 20, and connected to the heat pipes 112.

The chamber 114 is located in the housing 20, and attached to the lid portion 111. The chamber 114 covers the heat pipes 112. The chamber 114 includes an intake and an outlet for the coolant 7. It should be noted that an intake of a chamber 23a is close to the outlet of the chamber 114. In the ninth embodiment, the intake of the chamber 23a communicates with the outlet of the chamber 114.

The X-ray tube assembly comprises a fan 120 as an air blower. The fan 120 and the air-cooling radiator 110 form a heat exchanger. The fan 120 sends air to the air-cooling radiator 110, which is located outside the housing 20 (in the duct). Since the air-cooling radiator 110 is provided in the duct, it is possible to efficiently blow air onto the air-cooling radiator 110. The air-cooling radiator 110 can radiate heat in a heat pipe manner and in an air-cooling manner. Thus, a cooled coolant 7 can be made to flow into a flow passage CC.

In the X-ray tube unit 5 and the X-ray tube assembly having the above structures according to the ninth embodiment, the X-ray tube unit 5 comprises an X-ray tube 30 and a shield structure 6. Therefore, the X-ray tube unit 5 and the X-ray tube assembly according to the ninth embodiment can obtain the same advantages as in the second embodiment.

The X-ray tube assembly comprises the air-cooling radiator 110 and the fan 120. It is therefore possible to improve dissipation of heat radiated from the anode target 35.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

### Tenth Embodiment

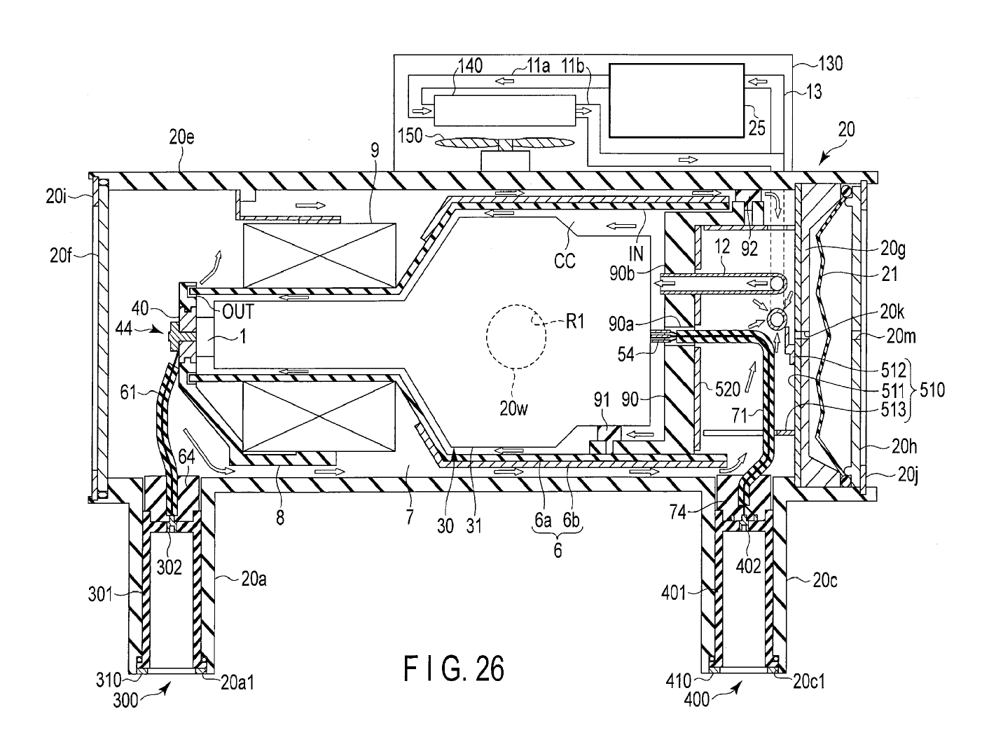

A rotation anode X-ray tube assembly according to the tenth embodiment will be explained. In the tenth embodiment, elements having the same functions as those in the fifth embodiment will be denoted by the same reference numerals as in the fifth embodiment, and their detailed explanations will be omitted. FIG. 26 is a cross-sectional view showing the X-ray tube assembly according to the tenth embodiment. It should be noted that in FIG. 26, the denotation of an X-ray shield region R2 is omitted; however, there is provided the same X-ray shield region R2 as in the fifth embodiment (fourth embodiment).

As shown in FIG. 26, the X-ray tube assembly further comprises a housing 130, an air-cooling radiator 140 and a fan 150 serving as an air blower. The air-cooling radiator 140 and the fan 150 form a heat exchanger. Also, the X-ray tube assembly comprises pipes 11a and 11b in place of the pipe 11. It suffices that the pipes 11a and 11b can feed a coolant 7. They are formed of, for example, hoses.

The housing 130 is attached to an outer surface of a housing body 20e (housing 20). The circulation pump 25, the air-cooling radiator 140 and the fan 150 are provided in the housing 130.

One of end portions of the pipe 11a is liquid-tightly connected to an outlet of a circulation pump 25. The other end portion of the pipe 11a is liquid-tightly connected to the air-cooling radiator 140. One of end portions of the pipe 11b is liquid-tightly connected to the air-cooling radiator 140. The other end portion of the pipe 11b extends through an opening not shown formed in the housing body 20e and a through hole formed in the third shielding member 513 such that the other end portion of the pipe 11b is located in the housing 20. The opening of the housing body 20e through which the pipe 11b extends is liquid-tightly closed.

A circulation pump 25 can discharge the coolant 7 taken in from a pipe 13 into the pipe 11a, and cause forced convection to occur in the housing 20. Due to air blown onto the air-cooling radiator 140 by the fan 150, the air-cooling radiator 140 can discharge heat of the coolant 7 to the outside. Thereby, the coolant 7 is cooled. By virtue of the above, the cooled coolant 7 can be made to flow in a flow passage CC.

According to the tenth embodiment, in the X-ray tube unit 5 and the X-ray tube assembly having the above structures, the X-ray tube unit 5 comprises the X-ray tube 30 and the shield structure 6. Therefore, the X-ray tube unit 5 and the X-ray tube assembly according to the tenth embodiment can obtain the same advantages as in the fifth embodiment.

The X-ray tube assembly comprises the air-cooling radiator 140 and the fan 150. It is therefore possible to further promote dissipation of heat radiated from an anode target 35 to the outside.

For the above reason, it is possible to obtain an X-ray tube assembly and an X-ray tube unit 5, which can be alone subjected to an X-ray leakage test, and can also improve the heat dissipation of an anode target 35. Furthermore, in the X-ray tube assembly, the manufacturing cost of the housing 20 can be decreased.

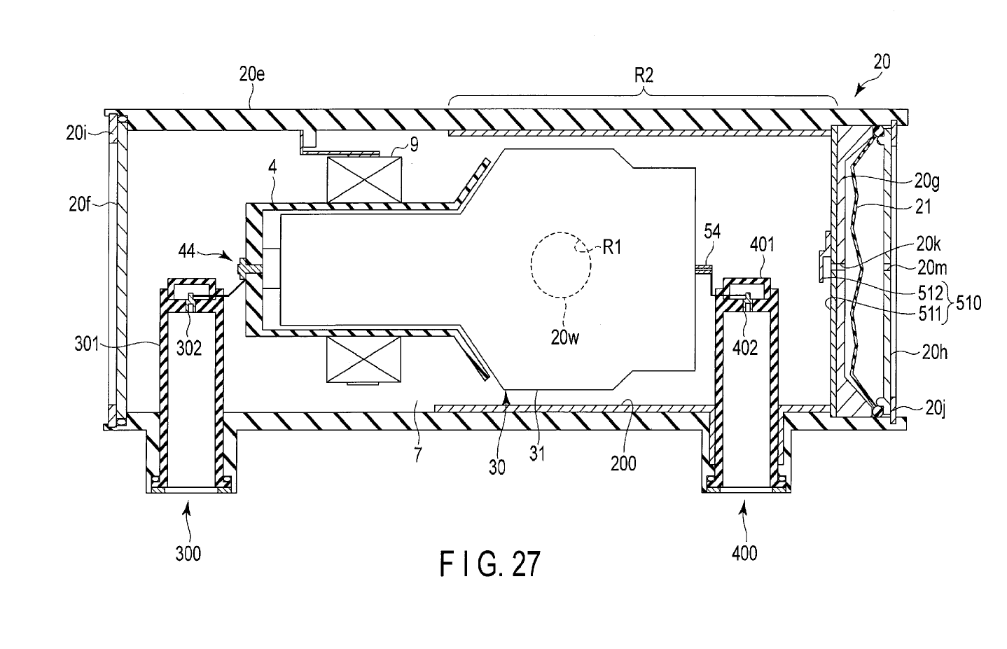

Then, an X-ray tube assembly of a comparative example to be compared with the X-ray tube assemblies according to the first to tenth embodiments will be explained. It should be noted that the X-ray tube assembly of the comparative example can be also applied as a comparative example to be compared with the X-ray tube assemblies according to subsequent embodiments to be described below. FIG. 27 is a cross-sectional view showing the X-ray tube assembly of the comparative example.

As shown in FIG. 27, the X-ray tube assembly of the comparative example does not include a shield structure 6. The X-ray tube assembly includes a high-voltage insulating member 4 fixed to a fixed shaft 1. One of ends of the high-voltage insulating member 4 is conically formed and the other is tubularly formed. The high-voltage insulating member 4 electrically insulates the fixed shaft 1, a housing 20 and a stator coil 9 from each other.

In order to prevent undesired X-rays from being radiated to the outside of the housing 20, a lead plate 200 is bonded to an inner surface of a housing body 20e. This, however, is a stumbling block against lowering of the manufacturing cost and also of the prices of manufactured goods. Also, it is not good in useful utilization of resources, since it is very hard to separate the housing body 20e and the lead plate 200 from each other.

Furthermore, using an expensive, large-scale and special equipment, it is necessary to conduct a confirmation test for confirming that X-rays do not leak from an area other than the X-ray output window 20w, with an X-ray tube 30 provided along with a coolant 7 in the housing 20 with the lead plate 200. Thus, it is necessary to transport the X-ray tube assembly as it is.

In the housing 20, forced convection does not occur in the coolant 7. Heat radiated from the anode target 35 or the rotor 10 is dissipated by natural convection of the coolant 7, and then transmitted to the housing. To a wide area of an inner wall of the housing, a lead plate is bonded. The inner wall of the housing and the lead plate partially adhere to each other. However, between most parts of them, very small gaps are provided in which insulating oil will not easily flow. Thus, the insulating oil remains in place in the gaps. Thus, heat transmitted to the lead plate is not easily transmitted to the housing. As a result, dissipation of heat transmitted from the anode target 35 and the rotor 10 lowers, and coolant 7 present in the vicinity of the anode target 35 and the vicinity of the rotor 10 is easily overheated. Consequently, a discharge more frequently occurs at the X-ray tube 30.

Next, matters related to the first to tenth embodiments and the modifications thereof will be referred to in the following (S1) to (S17).

(S1) A rotation anode X-ray tube unit including:

a rotation anode X-ray tube including a cathode which emits electrons, an anode target which is rotatably provided to emit X-rays, and a vacuum envelope which accommodates the cathode and the anode target; and

a shield structure surrounding an entire vacuum space of the vacuum envelope in a direction perpendicular to an axis of the anode target, and including an X-ray transmission region which permits X-rays to be transmitted through the X-ray transmission region, and an X-ray shield region which serves as a shield against X-rays and surrounds the X-ray transmission region, the shield structure forming along with the vacuum envelope, a flow passage for a flow of a coolant.

(S2) The rotation anode X-ray tube unit according to (S1), wherein the shield structure includes:

an electrical insulating member which surrounds the entire vacuum space of the vacuum envelope; and

an X-ray shield fixed to the electrical insulating member, provided in the X-ray shield region, shields X-rays, and including a through hole located in the X-ray transmission region.

(S3) The rotation anode X-ray tube unit according to (S2), wherein the X-ray shield is located opposite to the rotation anode X-ray tube with respect to the electrical insulating member, and is shaped to be in close contact with the electrical insulating member.

(S4) The rotation anode X-ray tube unit according to (S3), wherein the electrical insulating member is formed of resin material including at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(S5) The rotation anode X-ray tube unit according to (S1), wherein the shield structure includes:

a metal member surrounding at least part of the vacuum envelope; and

an X-ray shield fixed to the metal member, provided in the X-ray shield region, shields X-rays, and including a through hole located in a position corresponding to the position of the X-ray transmission region.

(S6) The rotation anode X-ray tube unit according to (S5), wherein the metal member includes a through hole located in the X-ray transmission region.

(S7) The rotation anode X-ray tube unit according to (S1), wherein the shield structure is formed of an electrical insulating material which contains as an admixture ingredient, metal fine particles of at least one of tungsten, tantalum, molybdenum, barium, bismuth, rare-earth metal and lead, and/or compound fine particles of at least one of tungsten, tantalum, molybdenum, barium, bismuth, rare-earth metal and lead, the shield structure including a through hole located in a position corresponding to the position of the X-ray transmission region.

(S8) The rotation anode X-ray tube unit according to (S6) or (S7), wherein the shield structure includes a partition plate which closes the through hole, and is formed of a good X-ray transmission characteristic.

(S9) The rotation anode X-ray tube unit according to (S1), further including a rotary drive unit which is located opposite to the anode X-ray tube with respect to the shield structure, restricts the position of the shield structure in a direction perpendicular to the axis, and rotates the anode target.

(S10) A rotation anode X-ray tube assembly including:

a rotation anode X-ray tube unit;

a housing accommodating the rotation anode X-ray tube unit;

a coolant filled in space between the rotation anode X-ray tube unit and the housing; and

a circulation unit,

wherein the rotation anode X-ray tube unit includes:

a rotation anode X-ray tube which includes a cathode which emits electrons, an anode target which is rotatably provided to emit X-rays, and a vacuum envelope which accommodates the cathode and the anode target; and

a shield structure including an X-ray transmission region which surrounds an entire vacuum space of the vacuum envelope in a direction perpendicular to an axis of the anode target, and which permits X-rays to be transmitted through the X-ray transmission region, and an X-ray shield region which blocks X-rays and surrounds the X-ray transmission region, the shield structure forming along with the vacuum envelope, a passage in which the coolant is made to flow, and which is located between the shield structure and the vacuum envelope, and

the circulation unit produces a flow of the coolant in the flow passage.

(S11) The rotation anode X-ray tube assembly according to (S10), wherein the housing is formed of resin material.

(S12) The rotation anode X-ray tube assembly according to (S11), wherein the resin material of which the housing is formed includes at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(S13) The rotation anode X-ray tube assembly according to (S11), wherein the housing includes a shield layer which forms at least part of an inner surface and an outer surface of the housing, and prevents an electromagnetic noise from the housing to the outside thereof.

(S14) The rotation anode X-ray tube assembly according to (S13), wherein the shield layer is formed of metal.

(S15) The rotation anode X-ray tube assembly according to one of (S10) to (S14), wherein the coolant is insulating oil.

(S16) The rotation anode X-ray tube assembly according to (S15), further including a high-voltage unit which is provided in the housing, immersed in the coolant, and applies a high voltage to the rotation anode X-ray tube.

(S17) The rotation anode X-ray tube assembly according to one of (S10) to (S16), further including a heat exchanger which includes: an air-cooling radiator which is located in the housing and outside the housing, and liquid-tightly attached to the housing, and radiates heat of the coolant to the outside of the housing; and an air blower which is provided outside the housing and sends air to the air-cooling radiator.

### Eleventh Embodiment

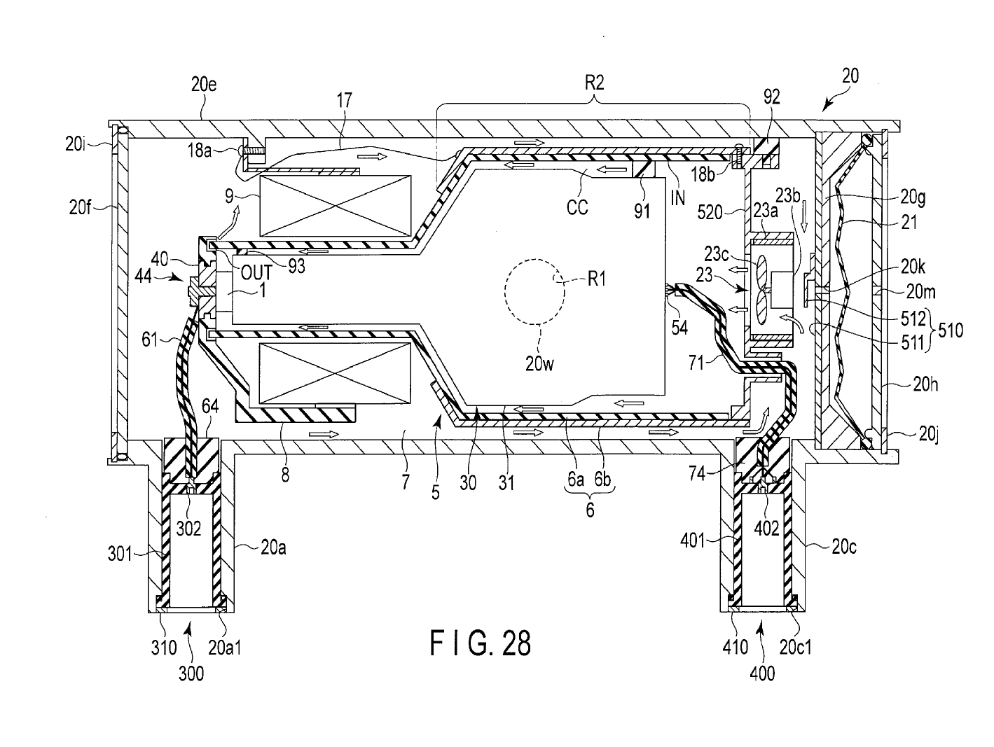

A rotation anode X-ray tube assembly according to the eleventh embodiment will be explained. In this embodiment, elements having the same functions as those in the fourth embodiment will be denoted by the same reference numerals as in the fourth embodiment, and their detailed explanations will be omitted. FIG. 28 is a cross-sectional view showing the X-ray tube assembly according to the eleventh embodiment.

As shown in FIG. 28, a housing body 20e is formed of metal material such as aluminum. In the housing body 20e formed of the metal material, heat of a coolant 7 is easily transmitted, and heat is easily radiated to the outside, as compared with a housing body formed of resin material.

A number of rubber members (electrical insulating members) 91 are in contact with a large-diameter portion of an X-ray tube 30 (vacuum envelope 31) and an insulating member 6a. A number of rubber members (electrical insulating members) 93 are in contact with a small-diameter portion of the X-ray tube 30 (vacuum envelope 31) and the insulating member 6a. The number of rubber members 91 and that of rubber members 93 are each three or four. The insulating member 6a and the rubber members 91 and 93 fix the vacuum envelope 31 due to friction fits. Thus, the X-ray tube 30 and a shield structure 6 are formed as a single body.

An X-ray shielding member 510 includes a first shielding member 511 and a second shielding member 512.

An X-ray shielding member 520 is formed of a hard lead. It should be noted that the hard lead is a lead alloy containing 3 wt % of antimony (Sb) defined by JIS H5601. The hard lead is material having rigidity. Thus, the X-ray tube assembly can be formed without including a fixing member 90. Furthermore, components made by a casting process can be subjected to screwing processing, and can be screw-engaged with each other.

The X-ray shielding member 520 includes a plate portion (disk) including first and second through holes, a first tubular portion attached in such a manner as to surround an outer edge of the plate portion, a second tubular portion attached to the plate portion, surrounding the first through hole, and projecting toward a side where the X-ray shielding member 510 is located, and a third tubular portion attached to the plate portion, surrounding the second through hole and projecting toward the side where the X-ray shielding member 510 is located.

Screw holes are formed in the first tubular portion of the X-ray shielding member 520, and the X-ray shielding member 520 and X-ray shield 6b are screw-engaged with each other by screws 18b. Thus, the X-ray shielding member 520 functions as an X-ray shield lid which closes an opening of the X-ray shield 6b.

Furthermore, the X-ray shielding member 520 itself is fixed to a housing 20. The first tubular portion of the X-ray shielding member 520 is fixed to the housing 20 by using the rubber members (electrical insulating members) 92. For example, the first tubular portion of the X-ray shielding member 520 is fixed along with the rubber members 92 to the housing 20 in three or four positions. The rubber members 92 are in contact with the housing 20. Thus, the X-ray shielding member 520 and the rubber members 92 are fixed to the housing 20 by friction fits.

A circulation unit 23 is provided in space surrounded by the X-ray shielding member 510 and the X-ray shielding member 520. A chamber 23a is fixed to the X-ray shielding member 520. The chamber 23a has an intake and an outlet for the coolant 7. The outlet is located opposite to the first through hole of the plate portion of the X-ray shielding member 520. The circulation unit 23 discharges the coolant 7 taken in from the intake, through the outlet. In the eleventh embodiment, the coolant flows in a flow passage CC, from a side where a high-voltage supply terminal 54 is located to a side where a high-voltage supply terminal 44 is located. It should be noted that the third tubular portion and the second through hole of the plate portion of the X-ray shielding member 520 are applied to a passage through which a high-voltage cable 71 is passed.

The X-ray tube 30 and the shield structure 6 form a rotation anode X-ray tube unit 5. The shield structure 6 includes an insulating member 6a serving as a shell and an X-ray shield 6b. The X-ray shield 6b is formed of a hard lead.

A stator coil 9 is fixed to the housing 20 at a number of portions thereof. Thus, in this case, a number of metal fittings which support the stator coil 9 are screw-engaged with the housing 20 by using screws 18a. The stator coil 9 is located opposite to an outer surface of a rotor 10 provided as shown in FIG. 3 and surrounds an outer side of the small-diameter portion of the vacuum envelope 31. The stator coil 9 is spaced from the insulating member 6a in the direction perpendicular to the axis a. Since the stator coil 9 need not to be adhered to the insulating member 6a, the X-ray tube unit 5 can be formed without incorporating the stator coil 9.

The X-ray shield 6b is electrically connected to the housing 20. In the eleventh embodiment, the X-ray shield 6b is electrically connected to the housing 20 by a conductive line (grounding conductor) 17 and the metal fittings of the stator coil 9.

It is therefore possible to stabilize the potential of the X-ray shield 6b. It is possible to restrict induction of discharge of the X-ray tube 30 in the case where the X-ray shield 6b is electrically in a floating state. In the case where electrical conduction cannot be easily effected between the X-ray shield 6b and the housing 20 as in the eleventh embodiment, it is preferable that the X-ray shield 6b be electrically connected to the housing 20, and it is advisable to apply the conductive line 17 or the like.

Then, a method for replacing the X-ray tube 30 of the X-ray tube assembly with a new X-ray tube 30 will be explained.

When a replacement operation for replacing the X-ray tube 30 is started, first, the coolant 7 is taken out from the housing 20. It should be noted that the housing 20 may include an opening portion for taking out the coolant 7. Ordinarily, the opening portion is liquid-tightly closed.

Next, the lid portions 20f, 20g and 20h are detached from the housing body 20e. Then, the high-voltage cable 61 and the high-voltage supply terminal 44 are disconnected from each other, and the high-voltage cable 71 and the high-voltage supply terminal 54 are disconnected from each other. Thereafter, the metal fittings of the stator coil 9 and the conductive line 17 are disconnected from each other, and the X-ray tube 30 and the connection member 40 are disconnected from each other.

Next, the X-ray tube unit 5, etc. (the X-ray tube 30, the shield structure 6 and the X-ray shielding member 520) are removed from the housing body 20e. In this case, it suffices that the receptacles 300 and 400 are removed from the housing 20 as occasion demands. Then, the screws 18b are detached, and the X-ray tube 30 is taken out from the shield structure 6.

Next, a new X-ray tube unit 5 is prepared.

Then, the new X-ray tube unit 5, etc. (X-ray tube 30, shield structure 6 and X-ray shielding member 520) are pushed into the housing body 20e, and set therein. In this case, it suffices that the receptacles 300 and 400 are attached to the housing 20 as occasion demands. Next, the conductive line 17 and the metal fittings of the stator coil 9 are restored to their connected states; the X-ray tube 30 and the connection member 40 are restored to their connected state; the high-voltage cable 61 and the high-voltage supply terminal 44 are connected to each other; and the high-voltage cable 71 and the high-voltage supply terminal 54 are connected to each other.

Subsequently, the lid portions 20f, 20g and 20h are attached to the housing body 20e, thus forming an X-ray tube assembly which is in an empty state. Then, the housing 20 is filled with a coolant 7. Thereby, the X-ray tube assembly is completed, and the replacement operation for the X-ray tube 30 ends.

According to the eleventh embodiment, in the X-ray tube unit 5 and the X-ray tube assembly having the above structures, the X-ray tube unit 5 comprises the X-ray tube 30 and the shield structure 6. Therefore, the X-ray tube unit 5 and the X-ray tube assembly according to the eleventh embodiment can obtain the same advantages as in the fourth embodiment.

Since the stator coil 9 need not to be adhered to the insulating member 6a, the X-ray tube unit 5 can be formed without incorporating the stator coil 9.

The X-ray shield 6b is electrically connected to the housing 20. In the eleventh embodiment, the X-ray shield 6b is electrically connected to the housing 20 by a conductive line (grounding conductor) 17 and the metal fittings of the stator coil 9. It is therefore possible to stabilize the potential of the X-ray shield 6b.

For the above reason, it is possible to obtain an X-ray tube assembly and an X-ray tube unit 5, which can improve the heat dissipation of the anode target 35. Furthermore, the X-ray tube unit 5 can be alone subjected to an X-ray leakage test.

### Modifications of Eleventh Embodiment

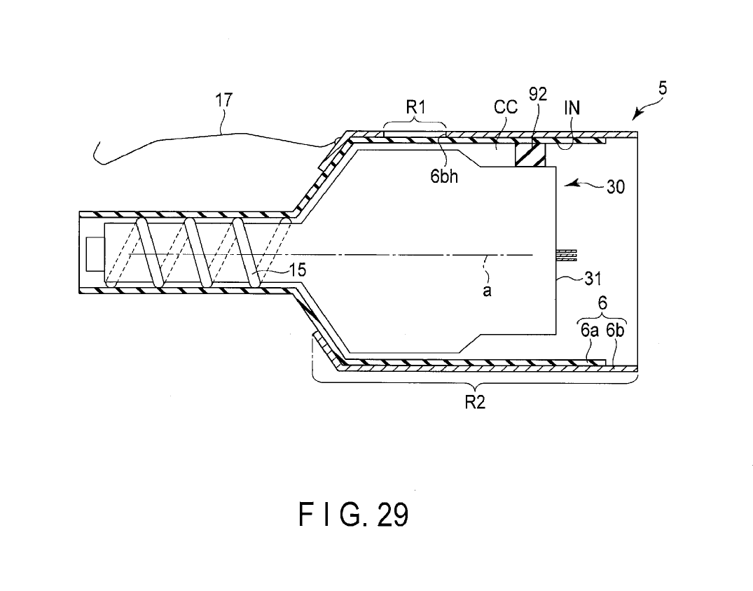

Modifications of the X-ray tube unit of the X-ray tube assembly according to the eleventh embodiment will be explained. FIG. 29 is a cross-sectional view showing a modification of the X-ray tube unit of the X-ray tube assembly according to the eleventh embodiment.

As shown in FIG. 29, the X-ray tube unit 5 further comprises a separator 15. The separator 15 is located between a small-diameter portion of a vacuum vessel 32 (vacuum envelope 31) and an insulating member 6a (shield structure 6). Since an X-ray tube 30 and a shield structure 6 can be fixed due to a friction fit, the X-ray tube unit 5 can be formed without rubber members 93. However, the separator 15 may be spaced from the inner periphery of an insulating member 6a. In this case, the X-ray tube unit 5 can utilize rubber members 93.

It should be noted that the separator 15 may be wound around the inner periphery of the insulating member 6a and in contact with the outer periphery of the vacuum vessel 32, although it becomes hard to form. In this case also, the separator 15 may be spaced from the outer periphery of the vacuum vessel 32.

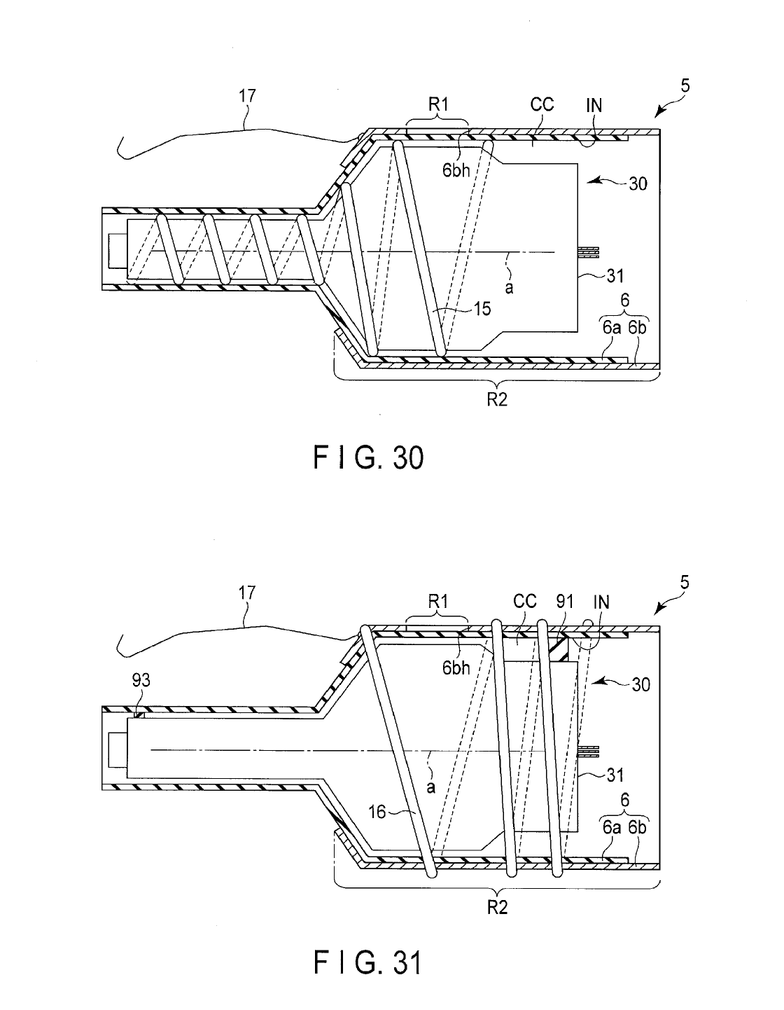

FIG. 30 is a cross-sectional view showing another modification of the X-ray tube unit of the X-ray tube assembly according to the eleventh embodiment. As shown in FIG. 30, the separator 15 may be formed to extend to an anode target 35 or a large-diameter portion of the vacuum vessel 32. However, the separator 15 is located apart from an X-ray transmission region R1. In this case, an X-ray tube unit 5 can be formed without rubber members 93.

FIG. 31 is a cross-sectional view showing still another modification of the X-ray tube unit of the X-ray tube assembly according to the eleventh embodiment. As shown in FIG. 31, the X-ray tube unit 5 may further comprise a separator 16. The separator 16 is located between an X-ray shield 6b (shield structure 6) and a housing 20. The separator 16 can therefore fix the X-ray tube unit 5 to the housing 20 due to a friction fit. However, the separator 16 may be spaced from the inner periphery of the housing 20.

It should be noted that the separator 16 may be wound around the inner periphery of the housing 20 and in contact with the outer periphery of the X-ray shield 6b, although it become hard to form. In this case also, the separator 16 may be spaced from the outer periphery of the X-ray shield 6b.

In the above modification, part of the flow passage CC is helically formed using the separator 15; however, the flow passage CC may be helically formed by another method. For example, the flow passage CC may be helically formed without adding a given member such as the separator 15.

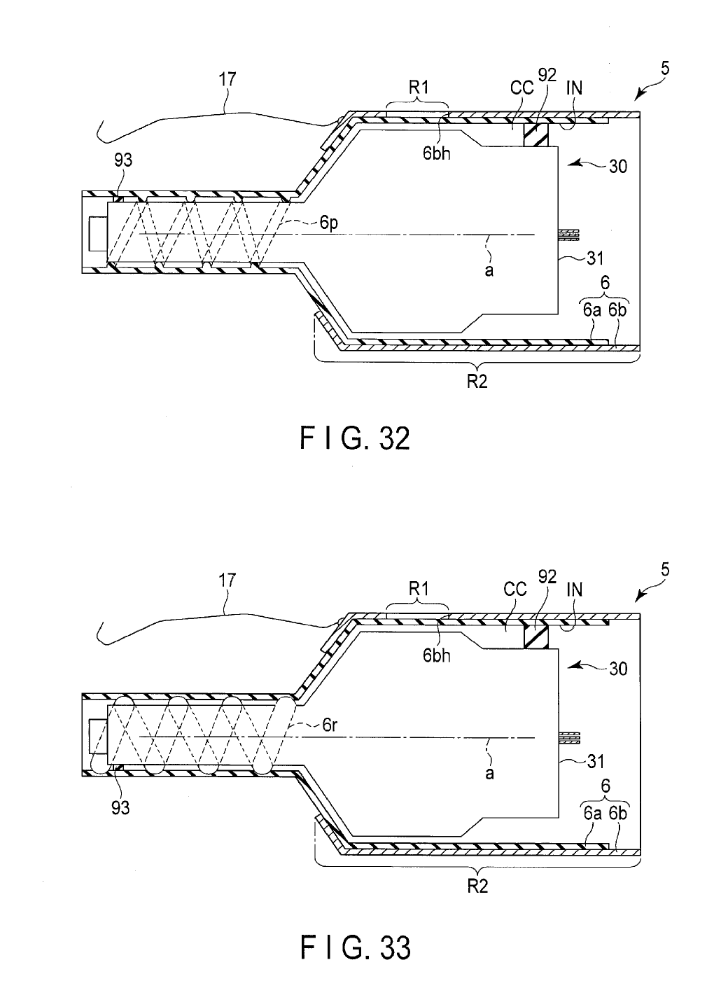

FIG. 32 is a cross-sectional view showing a further modification of the X-ray tube unit of the X-ray tube assembly according to the eleventh embodiment. As shown in FIG. 32, the insulating member 6a may have a helical projection 6p formed at the inner peripheral surface of the insulating member 6a. The projection 6p does not have elasticity, and is therefore spaced from the outer periphery of a vacuum vessel 32. In this case also, it is possible to helically form part of a flow passage CC which is located in the vicinity of a small-diameter portion of the vacuum vessel 32.

FIG. 33 is a cross-sectional view showing a still further modification of the X-ray tube unit of the X-ray tube assembly according to the eleventh embodiment. As shown in FIG. 33, the insulating member 6a may have a helical groove portion 6r formed in the inner peripheral surface of the insulating member 6a. In this case also, it is possible to helically form part of a flow passage CC which is located in the vicinity of a small-diameter portion of the vacuum vessel 32.

### Twelfth embodiment

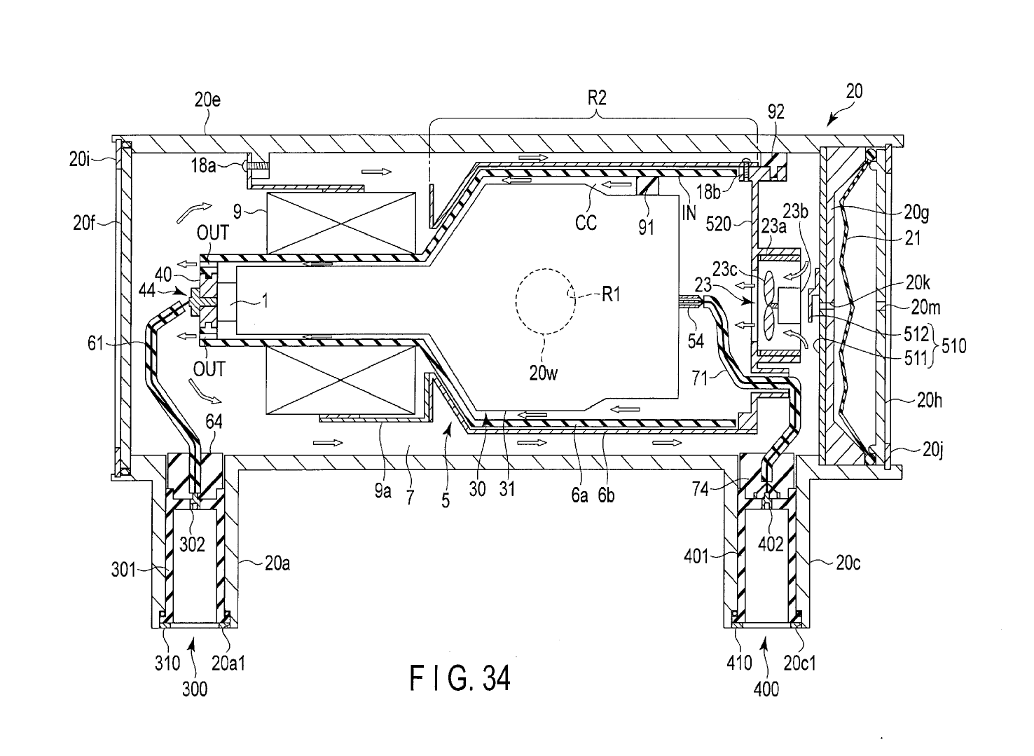

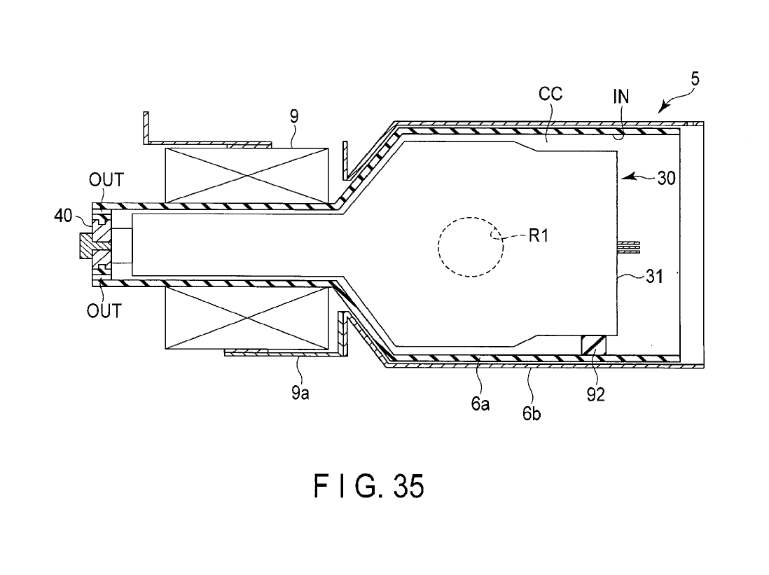

A rotation anode X-ray tube assembly according to the twelfth embodiment will be explained. In the twelfth embodiment, elements having the same functions as those in the eleventh embodiment will be denoted by the same reference numerals as in the eleventh embodiment, and their detailed explanations will be omitted. FIG. 34 is a cross-sectional view showing the X-ray tube assembly according to the twelfth embodiment. FIG. 35 is a cross-sectional view of a rotation anode X-ray tube unit according to the twelfth embodiment.

As shown in FIGS. 34 and 35, an X-ray tube 30, an insulating member 6a (a shell and a flow-passage formation member), an X-ray shield 6b, a connection member 40 and a stator coil 9 form the rotation anode X-ray tube unit 5. It is possible to remove the X-ray tube unit 5 from a housing 20, and guided the X-ray tube unit 5 into the housing 20, by turning the X-ray tube unit 5. This is because engagement portions (housing body 20e and metal fittings of a stator coil 9) for screws 18a will be located not to face each other.

An insulating member 6a is fixed to the X-ray tube 30 by a connection member 40. Thus, the rotation anode X-ray tube unit 5 is formed without rubber members 93.

The stator coil 9 restricts the position of the insulating member 6a in the direction perpendicular to the axis a. In the twelfth embodiment, the stator coil 9 is in contact with an outer surface of the insulating member 6a. It should be noted that in order to prevent the X-ray tube 30 from shaking, part of the stator coil 9 is adhered to the outer surface of the insulating member 6a by an adhesive.

To the stator coil 9, a number of supporting members 9a formed of metal are attached. The supporting members 9a are each connected to the X-ray shield 6b. Thus, the supporting members 9a support the X-ray shield 6b. Also, the supporting members 9a can electrically connect the X-ray shield 6b to the housing 20, and stabilize the potential of the X-ray shield 6b. In the twelfth embodiment, it is possible to easily effect electrical conduction between the X-ray shield 6b and the housing 20 without using the above conductive line 17, etc.

The X-ray shield 6b is not bonded to the insulating member 6a. The X-ray shield 6b has such a shape as to be in close vicinity to the insulating member 6a. The X-ray shield 6b can be formed, with a gap interposed between the X-ray shield 6b and the insulating member 6a. Therefore, in the twelfth embodiment, the X-ray shield 6b can be applied without being bonded to the insulating member 6a.

According to the twelfth embodiment, in the X-ray tube unit 5 and the X-ray tube assembly having the above structures, the X-ray tube unit 5 comprises the X-ray tube 30, the insulating member 6a and the X-ray shield 6b. Therefore, the X-ray tube unit 5 and the X-ray tube assembly according to the twelfth embodiment can obtain the same advantages as in the eleventh embodiment.

However, since the stator coil 9 is adhered to the insulating member 6a, it also forms the X-ray tube unit 5. Furthermore, since the X-ray shield 6b is electrically connected to the housing 20 by the supporting members 9a, etc., the potential of the X-ray shield 6b can be stabilized.

For the above reason, it is possible to obtain an X-ray tube assembly and an X-ray tube unit 5, which can improve the heat dissipation of the anode target 35. Furthermore, the X-ray tube unit 5 can be alone subjected to an X-ray leakage test.

### Thirteenth Embodiment

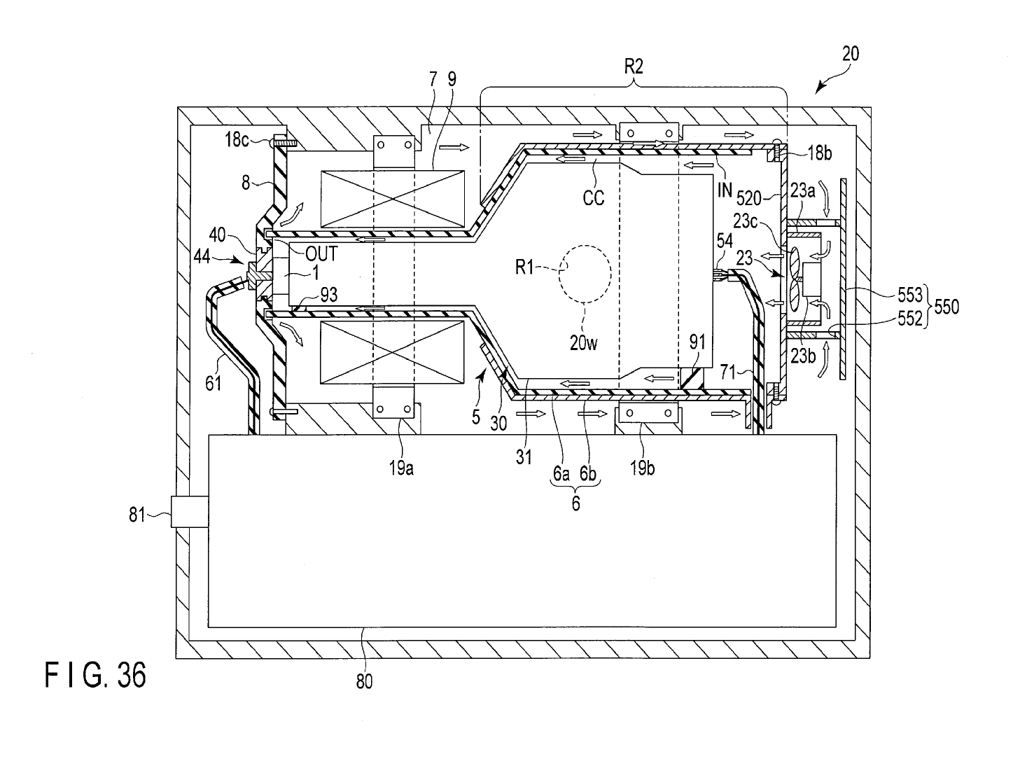

A rotation anode X-ray tube assembly according to the thirteenth embodiment will be explained. In the thirteenth embodiment, elements having the same functions as those in the eighth embodiment will be denoted by the same reference numerals as in the eighth embodiment, and their detailed explanations will be omitted. FIG. 36 is a cross-sectional view showing the X-ray tube assembly according to the thirteenth embodiment.

As shown in FIG. 36, a housing 20 is formed of metal material such as aluminum.

A holder 8 is fixed to a connection member 40 and the housing 20. The holder 8 and the housing 20 are screw-engaged with each other by screws 18c. In the thirteenth embodiment, the holder 8 is an X-ray tube holder, not a stator coil holder. The holder 8 holds relative positions of an X-ray tube 30 and the housing 20.

Neither the holder 8 nor the connection member 40 is connected to an insulating member 6a (shield structure 6). The holder 8 (annular portion) includes an annular groove portion. The groove portion is shaped in accordance with the shape of a tubular end portion of the insulating member 6a on the side where a high-voltage supply terminal 44 is located. In the groove portion, the above end portion of the insulating member 6a is inserted, with a gap provided. The gap between the holder 8 and the insulating member 6a form an outlet OUT for taking out a coolant 7 from a flow passage CC.

A number of rubber members (electrical insulating members) 91 are in contact with a large-diameter portion of an X-ray tube 30 (vacuum envelope 31) and an insulating member 6a. A number of rubber members (electrical insulating members) 93 are in contact with a small-diameter portion of the X-ray tube 30 (vacuum envelope 31) and the insulating member 6a. The number of rubber members 91 and that of rubber members 93 are each three or four. The insulating member 6a and the rubber members 91 and 93 fix the vacuum envelope 31 due to friction fits. Thus, the X-ray tube 30 and the shield structure 6 are formed as a single body.

The X-ray shielding member 520 is formed of a hard lead. Thus, the X-ray tube assembly can be formed without a fixing member 90. The X-ray shielding member 520 includes a plate portion (disk) having a through hole and a tubular portion attached to surround an outer edge of the plate portion. In the tubular portion of the X-ray shielding member 520, screw holes are formed, and the X-ray shielding member 520 and an X-ray shield 6b are screw-engaged with each other by screws 18b. Thus, the X-ray shielding member 520 functions as an X-ray shield lid which closes an opening of the X-ray shield 6b.

An X-ray shielding member 550 comprises a tubular portion 552 and a plate portion 553. The plate portion 553 is located apart from and opposite to the X-ray shielding member 520. The tubular portion 552 is located between the X-ray shielding member 520 and the plate portion 553, and joins the X-ray shielding member 520 and the plate portion 553 to each other. In the tubular portion 552, a number of through holes are formed. The through holes are used as a flow passage for the coolant 7. The X-ray shielding member 550 prevents leakage of X-rays from the through hole of the X-ray shielding member 520.

A circulation unit 23 is provided in space surrounded by the X-ray shielding member 520 and the X-ray shielding member 550. A chamber 23a is fixed to the X-ray shielding member 520. The chamber 23a has an intake and an outlet for the coolant 7. The outlet is located opposite to the through hole of the plate portion of the X-ray shielding member 520. The circulation unit 23 discharges the coolant 7 taken in from the intake, from the outlet. In the thirteenth embodiment, the coolant flows in the flow passage CC, from a side where a high-voltage supply terminal 54 is located to a side where the high-voltage supply terminal 44 is located.

The X-ray tube 30 and the shield structure 6 form a rotation anode X-ray tube unit 5. The shield structure 6 includes the insulating member 6a, which serves as a shell, and the X-ray shield 6b. The X-ray shield 6b is formed of a hard lead. Also, in the X-ray shield 6b, a through hole is formed and used as a passage through which a high-voltage cable 71 is passed.

A stator coil 9 is located opposite to an outer surface of a rotor 10 provided as shown in FIG. 3 and surrounds an outer side of a small-diameter portion of the vacuum envelope 31. The stator coil 9 is spaced from the insulating member 6a in the direction perpendicular to the axis a. Since the stator coil 9 need not to be adhered to the insulating member 6a, the X-ray tube unit 5 can be formed without incorporating the stator coil 9.

First holddown fittings 19a are fixed to the housing 20, while holding down the stator coil 9. The first holddown fittings 19a and flange portions of the housing 20 are screw-engaged with each other. It is therefore possible to fix the position of the stator coil 9 with respect to the housing 20. Also, it is possible that the outer surface of the stator coil 9 and the housing 20 are set to have the same potential.

On the other hand, second holddown fittings 19b are fixed to the housing 20, while holding down the X-ray shield 6b (the shield structure 6). The second holddown fittings 19b and flange portions of the housing 20 are screw-engaged with each other. Thereby, it is possible to fix the position of the X-ray shield 6b (the X-ray tube unit 5) with respect to the housing 20.

The X-ray shield 6b is electrically connected to the housing 20. To be more specific, in the thirteenth embodiment, the X-ray shield 6b is electrically connected to the housing 20 through the second holddown fittings 19b. It is therefore possible to stabilize the potential of the X-ray shield 6b. It is possible to restrict induction of discharge of the X-ray tube 30 in the case where the X-ray shield 6b is electrically in a floating state.

Then, a method for replacing the X-ray tube 30 of the X-ray tube assembly with a new X-ray tube 30 will be explained.

When a replacement operation for replacing the X-ray tube 30 is started, first, the coolant 7 is taken out from the housing 20. It should be noted that the housing 20 may include an opening portion for taking out the coolant 7. Ordinarily, the opening portion is liquid-tightly closed.

Next, lid portions of the housing 20 are removed therefrom. Then, screws 18b are detached, and from the shield structure 6, the X-ray shielding member 520 and the X-ray shielding member 550 are detached. Next, a high-voltage cable 61 and the high-voltage supply terminal 44 are disconnected from each other, and the high-voltage cable 71 and the high-voltage supply terminal 54 are disconnected from each other. Thereafter, the X-ray tube 30 and the connection member 40 are disconnected from each other, and the second holddown fittings 19b are detached from the housing 20. Further, the X-ray tube unit 5 (the X-ray tube 30 and the shield structure 6) is removed.

Next, a new X-ray tube unit 5 is prepared.

Then, the new X-ray tube unit 5 (X-ray tube 30 and shield structure 6) is inserted into a housing 20, and the second holddown fittings 19b are fixed to the housing 20. Next, the X-ray tube 30 and the connection member 40 are restored to their connected state; the high-voltage cable 61 and the high-voltage supply terminal 44 are connected to each other; and the high-voltage cable 71 and the high-voltage supply terminal 54 are connected to each other. To the shield structure 6, the X-ray shielding member 520 and the X-ray shielding member 550 are attached.

Subsequently, the lid portions of the housing 20 are attached, thus forming an X-ray tube assembly which is in an empty state. Then, the housing 20 is filled with a coolant 7. Thereby, the X-ray tube assembly is completed, and the replacement operation for the X-ray tube 30 ends.

According to the thirteenth embodiment, in the X-ray tube unit 5 and the X-ray tube assembly having the above structures, the X-ray tube unit 5 comprises the X-ray tube 30 and the shield structure 6. Therefore, the X-ray tube unit 5 and the X-ray tube assembly according to the thirteenth embodiment can obtain the same advantages as in the eighth embodiment.

Since the stator coil 9 need not to be adhered to the insulating member 6a, the X-ray tube unit 5 can be formed without incorporating the stator coil 9.

The X-ray shield 6b is electrically connected to the housing 20. To be more specific, in the thirteenth embodiment, the X-ray shield 6b is electrically connected to the housing 20 through the second holddown fittings 19b. It is therefore possible to stabilize the potential of the X-ray shield 6b.

For the above reason, it is possible to obtain an X-ray tube assembly and an X-ray tube unit 5, which can improve the heat dissipation of an anode target 35. Furthermore, the X-ray tube unit 5 can be alone subjected to an X-ray leakage test.

### Fourteenth Embodiment

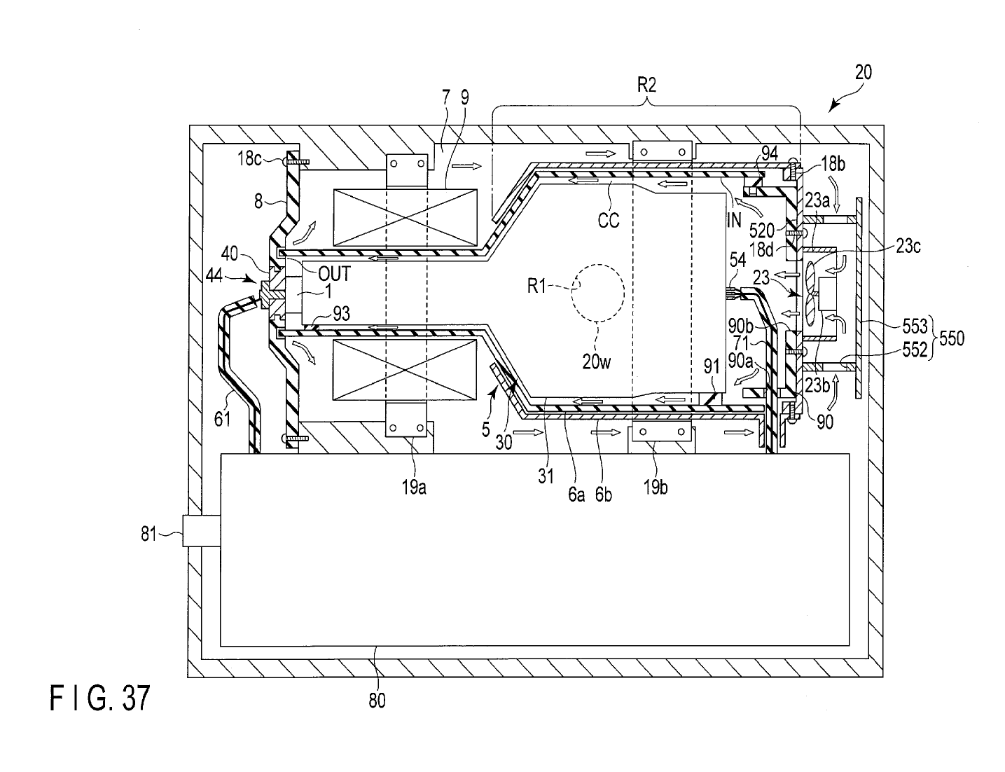

A rotation anode X-ray tube assembly according to the fourteenth embodiment will be explained. In the fourteenth embodiment, elements having the same functions as those in the thirteenth embodiment will be denoted by the same reference numerals as in the thirteenth embodiment, and their detailed explanations will be omitted. FIG. 37 is a cross-sectional view showing the X-ray tube assembly according to the fourteenth embodiment.

As shown in FIG. 37, at least an X-ray tube 30 and an insulating member 6a (a shell and a flow-passage formation member) form a rotation anode X-ray tube unit 5.

An X-ray shield 6b is not bonded to the insulating member 6a. The X-ray shield 6b has such a shape as to be in close vicinity to the insulating member 6a. The X-ray shield 6b can be formed, with a gap interposed between the X-ray shield 6b and the insulating member 6a. Therefore, in the fourteenth embodiment, the X-ray shield 6b can be applied without being bonded to the insulating member 6a.

A fixing member 90 is provided in a housing 20. The fixing member 90 fixes the position of the insulating member 6a (the X-ray tube unit 5) with respect to the housing 20. The fixing member 90 is formed of electrical insulating member such as resin. The fixing member 90 uses a number of rubber members (electrical insulating members) 94 to fix the insulating member 6a. For example, the fixing member 90 fixes along with the rubber members 94 the insulating member 6a in three or four positions. The rubber members 94 are in contact with the insulating member 6a. Thus, the fixing member 90 and the rubber members 94 fix the insulating member 6a due to friction fits.

The fixing member 90 itself is screw-engaged with an X-ray shielding member 520 by screws 18d. In the fixing member 90, through holes 90a and 90b are formed. The through hole 90a is used as a passage for a high-voltage cable 71. The through hole 90b is used as a flow passage for a coolant 7.

According to the fourteenth embodiment, in the X-ray tube unit 5 and the X-ray tube assembly having the above structures, the X-ray tube unit 5 comprises the X-ray tube 30, the insulating member 6a and the X-ray shield 6b. Therefore, the X-ray tube unit 5 and the X-ray tube assembly according to the fourteenth embodiment can obtain the same advantages as in the thirteenth embodiment.

Since the X-ray tube assembly includes the fixing member 90 formed of an electrical insulating material, it can improve insulation between the X-ray tube 30 and the X-ray shielding member 520.

Furthermore, the X-ray shield 6b is not bonded to the insulating member 6a, as a result of which the vibration of the X-ray tube 30 will not be easily transmitted to the housing 20.

For the above reason, it is possible to obtain an X-ray tube assembly and an X-ray tube unit 5, which can improve the heat dissipation of the anode target 35.

### Fifteenth Embodiment

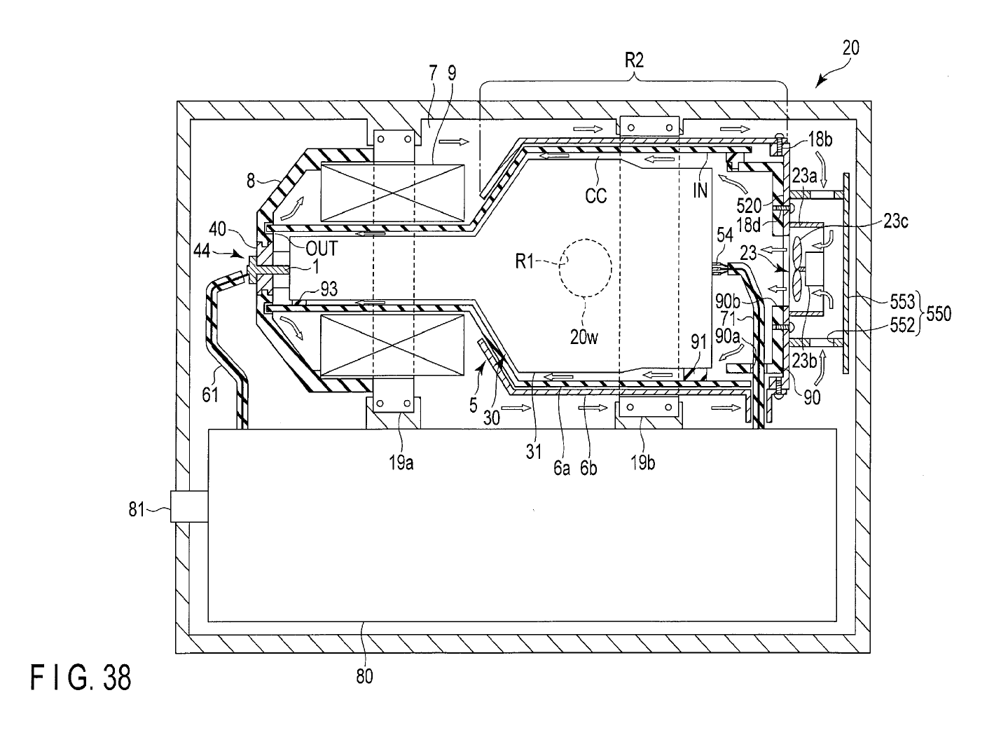

A rotation anode X-ray tube assembly according to the fifteenth embodiment will be explained. In the fifteenth embodiment, elements having the same functions as those in the fourteenth embodiment will be denoted by the same reference numerals as in the fourteenth embodiment, and their detailed explanations will be omitted. FIG. 38 is a cross-sectional view showing the X-ray tube assembly according to the fifteenth embodiment.

As shown in FIG. 38, a holder 8 may be formed such that it is not directly fixed to a housing 20. The holder 8 is fixed to a connection member 40 and a stator coil 9. In the fifteenth embodiment, the holder 8 is a stator-coil holder. The stator coil 9 is pressed by first holddown fittings 19a, whereby the stator coil 9 is fixed, and the holder 8, etc. are also fixed.

According to the fifteenth embodiment, in an X-ray tube unit 5 and the X-ray tube assembly having the above structures, the X-ray tube unit 5 comprises an X-ray tube 30, an insulating member 6a and an X-ray shield 6b. Therefore, the X-ray tube unit 5 and the X-ray tube assembly according to the fifteenth embodiment can obtain the same advantages as in the fourteenth embodiment.

It is not necessary that the holder 8 is solely fixed to the housing 20, and it is therefore possible that fixing of the holder 8, etc. and assembling of the X-ray tube assembly are further easily achieved.

For the above reason, it is possible to obtain an X-ray tube assembly and an X-ray tube unit 5, which can improve the heat dissipation of an anode target 35. Furthermore, the X-ray tube unit 5, which includes an X-ray shield 6b, can be alone subjected to an X-ray leakage test.

### Sixteenth Embodiment

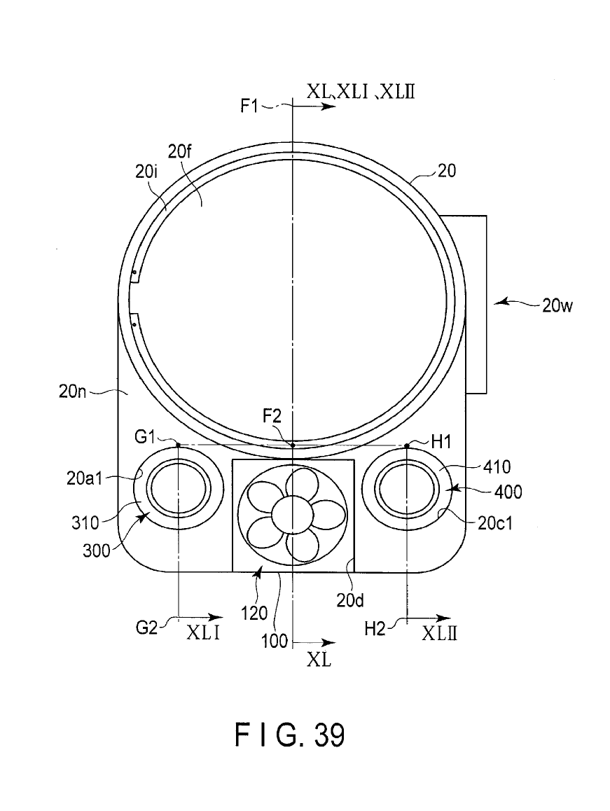

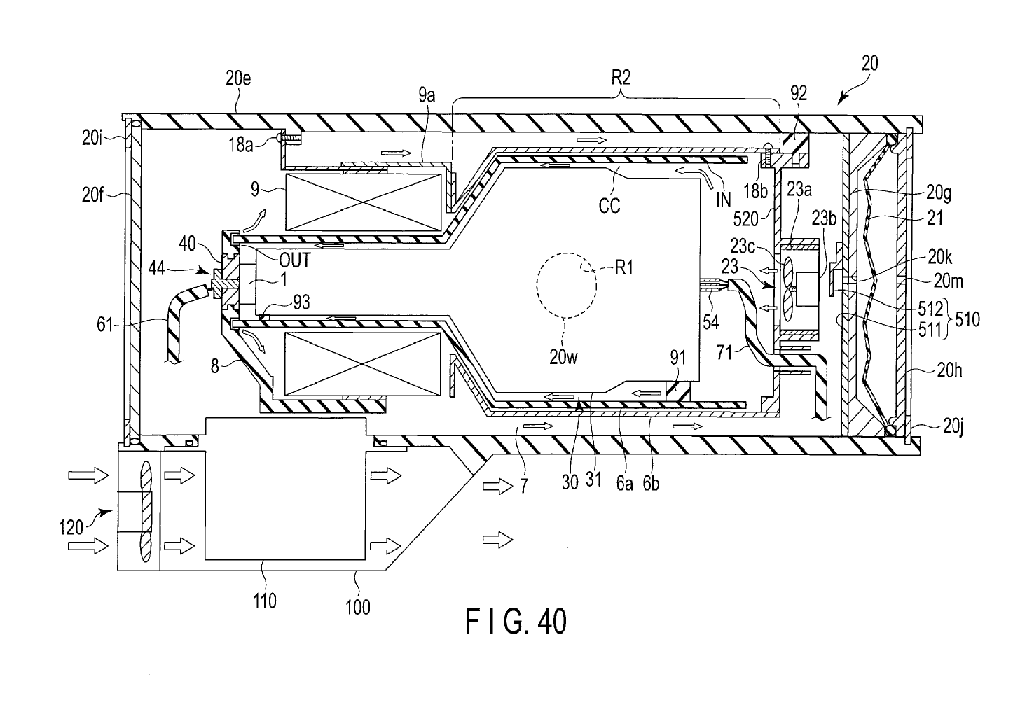

A rotation anode X-ray tube assembly according to the sixteenth embodiment will be explained. In the sixteenth embodiment, elements having the same functions as those in the ninth embodiment will be denoted by the same reference numerals as in the ninth embodiment, and their detailed explanations will be omitted. FIG. 39 is a schematic view showing the X-ray tube assembly according to the sixteenth embodiment, and also showing the X-ray tube assembly as viewed from a receptacle side. FIG. 40 is a cross-sectional view taken along line XL-XL in FIG. 39.

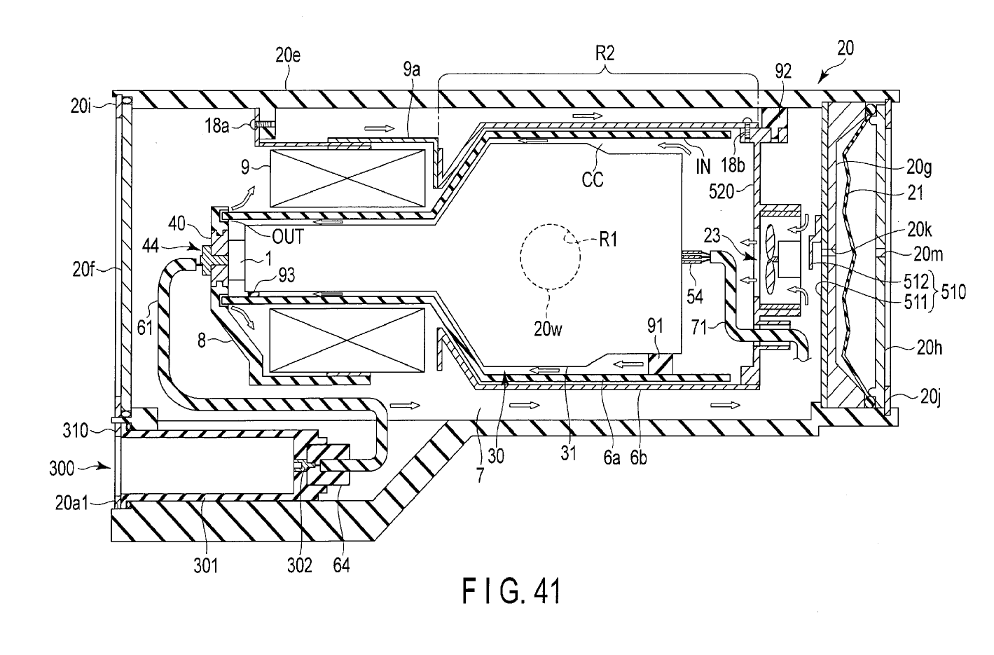

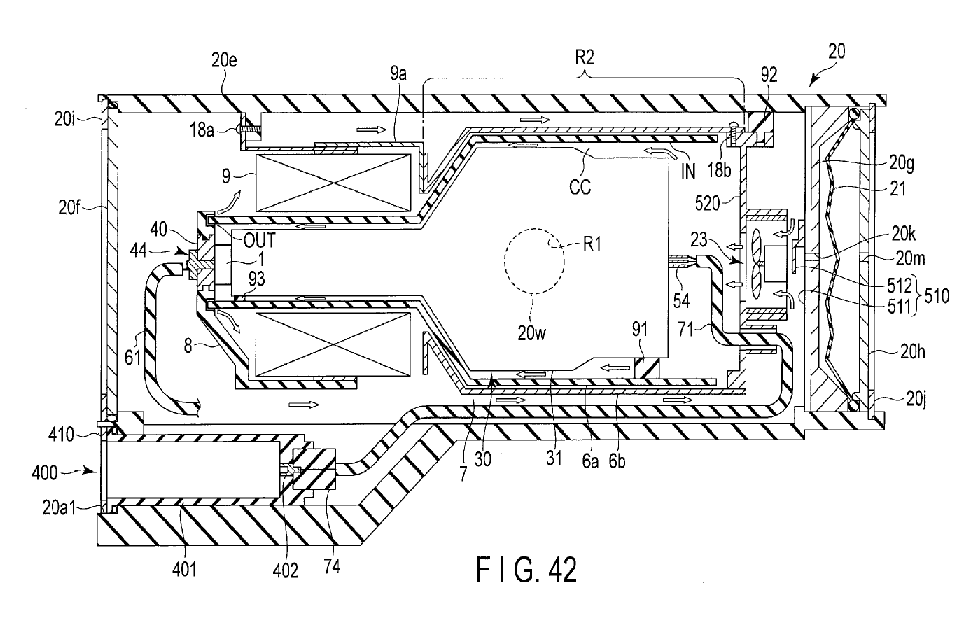

FIG. 41 is a cross-sectional view taken along line XLI-XLI in FIG. 39. To be more specific, FIG. 41 is a view obtained by combining a cross-sectional view taken along line F1-F2 in FIG. 39 and a cross-sectional view taken along line G1-G2 in FIG. 39. FIG. 42 is a cross-sectional view taken along line XLII-XLII in FIG. 39. To be more specific, FIG. 42 is a view obtained by combining a cross-sectional view taken along line F1-F2 in FIG. 39 and a cross-sectional view taken along line H1-H2 in FIG. 39.

As shown in FIGS. 39, 40, 41 and 42, a housing body 20e is formed of resin material. Heat of a coolant 7 is not easily transmitted to the housing body 20e formed of resin material, and is not easily radiated from the housing body 20e from the outside thereof, as compared with a housing body formed of metal.

In view of the above, in the sixteenth embodiment, the X-ray tube assembly comprises an air-cooling radiator 110. By the operation of the air-cooling radiator 110, the heat of the coolant 7 can be radiated to the outside of the housing 20. The air-cooling radiator 110 comprises a metal block which is immersed in the coolant 7, a number of heat pipes and a number of fins which receive air sent from a fan 120, etc.

A number of rubber members (electrical insulating members) 91 are in contact with a large-diameter portion of an X-ray tube 30 (vacuum envelope 31) and an insulating member 6a. A number of rubber members (electrical insulating members) 93 are in contact with a small-diameter portion of the X-ray tube 30 (vacuum envelope 31) and the insulating member 6a. The number of rubber members 91 and that of rubber members 93 are each three or four. The insulating member 6a and the rubber members 91 and 93 fix the vacuum envelope 31 due to friction fits. Thus, the X-ray tube 30 and the insulating member 6a are formed as a single body.

An X-ray shielding member 520 is formed of a hard lead. The X-ray shielding member 520 includes a plate portion (disk) having first and second through holes, a first tubular portion attached to surround an outer edge of the plate portion, a second tubular portion attached to the plate portion, surrounding the first through hole, and projecting toward a side where an X-ray shielding member 510 is located, and a third tubular portion attached to the plate portion, surrounding the second through hole and projecting toward the side where the X-ray shielding member 510 is located.

A screw hole is formed in the first tubular portion of the X-ray shielding member 520, and the X-ray shielding member 520 and an X-ray shield 6b are screw-engaged with each other with screws 18b. Thus, the X-ray shielding member 520 functions as an X-ray shield lid which closes an opening of the X-ray shield 6b.

Furthermore, the X-ray shielding member 520 itself is fixed to a housing 20. The first tubular portion of the X-ray shielding member 520 is fixed to the housing 20, using rubber members (electrical insulating members) 92. For example, the first tubular portion of the X-ray shielding member 520 is fixed along with the rubber members 92 to the housing 20 in three or four positions. The rubber members 92 are in contact with the housing 20. Thus, the X-ray shielding member 520 and the rubber members 92 are fixed to the housing 20 by friction fits.

A circulation unit 23 is provided in space surrounded by the X-ray shielding member 510 and the X-ray shielding member 520. A chamber 23a is fixed to the X-ray shielding member 520. The chamber 23a has an intake and an outlet for the coolant 7. The outlet is located opposite to the first through hole of the plate portion of the X-ray shielding member 520. The circulation unit 23 discharges the coolant 7 taken in from the intake, from the outlet. In the sixteenth embodiment, the coolant flows in a flow passage CC, from a side where a high-voltage supply terminal 54 is located to a side where a high-voltage supply terminal 44 is located. It should be noted that the third tubular portion and the second through hole of the plate portion of the X-ray shielding member 520 are applied to a passage through which a high-voltage cable 71 is passed.

A stator coil 9 is fixed to the housing 20 at a number of portions thereof. Thus, in this case, a number of metal fittings which support the stator coil 9 are screw-engaged with the housing 20 with screws 18a. The stator coil 9 is located opposite to an outer surface of a rotor 10 provided as shown in FIG. 3 and surrounds an outer side of the small-diameter portion of the vacuum envelope 31. The stator coil 9 is spaced from the insulating member 6a in the direction perpendicular to the axis a. Since the stator coil 9 need not to be adhered to the insulating member 6a, an X-ray tube unit 5 can be formed without incorporating the stator coil 9.

At least the X-ray tube 30 and the insulating member 6a (a shell and a flow-passage formation member) form the rotation anode X-ray tube unit 5.

The X-ray shield 6b is formed of a hard lead. The X-ray shield 6b is not bonded to the insulating member 6a. The X-ray shield 6b has such a shape as to be in close vicinity to the insulating member 6a. The X-ray shield 6b can be formed, with a gap interposed between the X-ray shield 6b and the insulating member 6a. Therefore, in the sixteenth embodiment, the X-ray shield 6b can be applied without being bonded to the insulating member 6a.

To the stator coil 9, a number of supporting members 9a formed of metal are attached. The supporting members 9a are each connected to the X-ray shield 6b. Thus, the supporting members 9a support the X-ray shield 6b. Also, the supporting members 9a can electrically connect the X-ray shield 6b to the housing 20, and stabilize the potential of the X-ray shield 6b.

According to the sixteenth embodiment, in the X-ray tube unit 5 and the X-ray tube assembly having the above structures, the X-ray tube unit 5 comprises the X-ray tube 30 and the insulating member 6a. Therefore, the X-ray tube unit 5 and the X-ray tube assembly according to the sixteenth embodiment can obtain the same advantages as in the ninth embodiment.

Since the stator coil 9 need not to be adhered to the insulating member 6a, the X-ray tube unit 5 can be formed without incorporating the stator coil 9. Furthermore, since the X-ray shield 6b need not to be bonded to the insulating member 6a, the X-ray tube unit 5 can be formed without incorporating the X-ray shield 6b.

The X-ray shield 6b is electrically connected to the housing 20. In the sixteenth embodiment, the X-ray shield 6b is electrically connected to the housing 20 through the supporting members 9a, etc. It is therefore possible to stabilize the potential of the X-ray shield 6b.

For the above reason, it is possible to obtain an X-ray tube assembly and an X-ray tube unit 5 which can improve the heat dissipation of an anode target 35. Furthermore, the X-ray tube unit 5, which includes the X-ray shield 6b, can be alone subjected to an X-ray leakage test.

### Seventeenth Embodiment

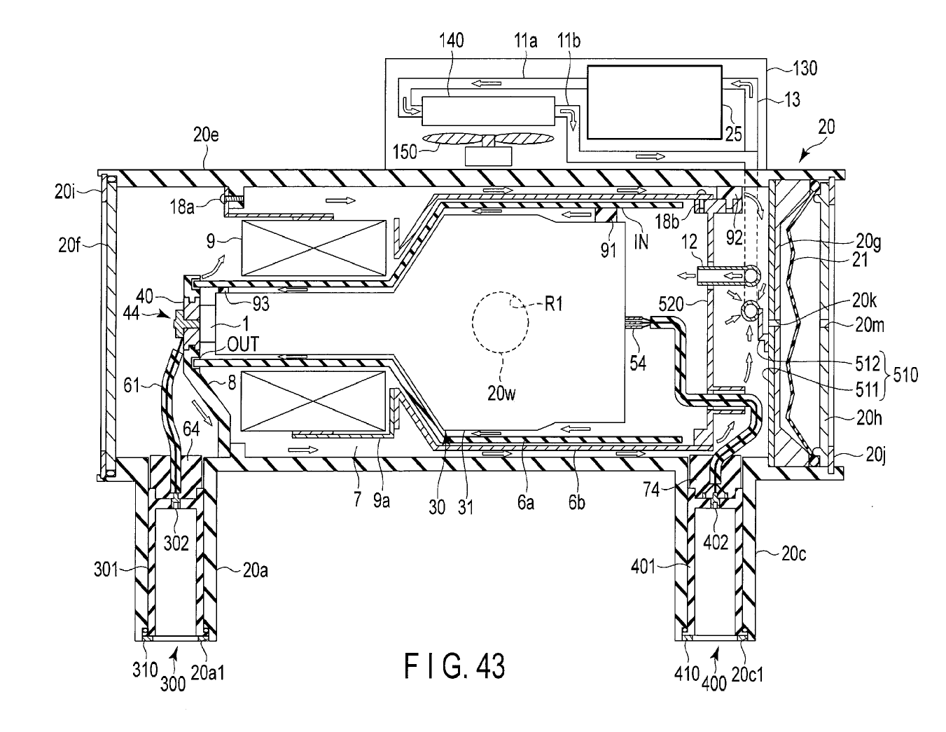

A rotation anode X-ray tube assembly according to the seventeenth embodiment will be explained. In the seventeenth embodiment, elements having the same functions as those in the tenth embodiment will be denoted by the same reference numerals as in the tenth embodiment, and their detailed explanations will be omitted. FIG. 43 is a cross-sectional view showing the X-ray tube assembly according to the seventeenth embodiment.

As shown in FIG. 43, a housing body 20e is formed of resin material. Heat of a coolant 7 is not easily transmitted to the housing body 20e formed of resin material, and is not easily radiated from the housing body 20e from the outside thereof, as compared with a housing body formed of metal.

In view of the above, in the seventeenth embodiment, the X-ray tube assembly further comprises a housing 130, an air-cooling radiator 140 and a fan 150. Thereby, heat of the coolant 7 can be radiated to the outside of the housing 20.

A number of rubber members (electrical insulating members) 91 are in contact with a large-diameter portion of an X-ray tube 30 (vacuum envelope 31) and an insulating member 6a. A number of rubber members (electrical insulating members) 93 are in contact with a small-diameter portion of the X-ray tube 30 (vacuum envelope 31) and the insulating member 6a. The number of rubber members 91 and that of rubber members 93 are each three or four. The insulating member 6a and the rubber members 91 and 93 fix the vacuum envelope 31 due to friction fits. Thus, the X-ray tube 30 and the insulating member 6a are formed as a single body.

An X-ray shielding member 520 is formed of a hard lead. The X-ray shielding member 520 includes a plate portion (disk) having first and second through holes, a first tubular portion attached to surround an outer edge of the plate portion, and a second tubular portion attached to the plate portion, and surrounding the second through hole, and projecting toward a side where an X-ray shielding member 510 is located.

A screw hole is formed in the first tubular portion of the X-ray shielding member 520, and the X-ray shielding member 520 and an X-ray shield 6b are screw-engaged with each other with screws 18b. Thus, the X-ray shielding member 520 functions as an X-ray shield lid which closes an opening of the X-ray shield 6b.

Furthermore, the X-ray shielding member 520 itself is fixed to a housing 20. The first tubular portion of the X-ray shielding member 520 is fixed to the housing 20, using the rubber members (electrical insulating members) 92. For example, the first tubular portion of the X-ray shielding member 520 is fixed along with the rubber members 92 to the housing 20 in three or four positions. The rubber members 92 are in contact with the housing 20. Thus, the X-ray shielding member 520 and the rubber members 92 are fixed to the housing 20 by friction fits.

A pipe 12 is passed through the first through hole of the X-ray shielding member 520 such that the other end portion of the pipe 12 is located opposite to the X-ray tube 30. In the seventeenth embodiment, the coolant 7 flows in a flow passage CC, from a side where a high-voltage supply terminal 54 is located to a side where a high-voltage supply terminal 44 is located. It should be noted that the second tubular portion and the second through hole of the plate portion of the X-ray shielding member 520 are applied to a passage through which a high-voltage cable 71 is passed.

A stator coil 9 is fixed to the housing 20 at a number of portions thereof. Thus, in this case, a number of metal fittings which support the stator coil 9 are screw-engaged with the housing 20 with screws 18a. The stator coil 9 is located opposite to an outer surface of a rotor 10 provided as shown in FIG. 3 and surrounds an outer side of the small-diameter portion of the vacuum envelope 31. The stator coil 9 is spaced from the insulating member 6a in the direction perpendicular to the axis a. Since the stator coil 9 need not to be adhered to the insulating member 6a, an X-ray tube unit 5 can be formed without incorporating the stator coil 9.

At least the X-ray tube 30 and the insulating member 6a (a shell and a flow-passage formation member) form the rotation anode X-ray tube unit 5.

The X-ray shield 6b is formed of a hard lead. The X-ray shield 6b is not bonded to the insulating member 6a. The X-ray shield 6b has such a shape as to be in close vicinity to the insulating member 6a. The X-ray shield 6b can be formed, with a gap interposed between the X-ray shield 6b and the insulating member 6a. Therefore, in the seventeenth embodiment, the X-ray shield 6b can be applied without being bonded to the insulating member 6a.

To the stator coil 9, a number of supporting members 9a formed of metal are attached. The supporting members 9a are each connected to the X-ray shield 6b. Thus, the supporting members 9a support the X-ray shield 6b. Also, the supporting members 9a can electrically connect the X-ray shield 6b to the housing 20, and stabilize the potential of the X-ray shield 6b.

A holder 8 is fixed to a connection member 40 and the housing 20. The holder 8 and the housing 20 are, for example, screw-engaged with each other. In the seventeenth embodiment, the holder 8 is an X-ray tube holder, not a stator coil holder. The holder 8 holds relative positions of the X-ray tube 30 and the housing 20.

According to the seventeenth embodiment, in the X-ray tube unit 5 and the X-ray tube assembly having the above structures, the X-ray tube unit 5 comprises the X-ray tube 30 and the insulating member 6a. Therefore, the X-ray tube unit 5 and the X-ray tube assembly according to the seventeenth embodiment can obtain the same advantages as in the tenth embodiment.

Since the stator coil 9 need not to be adhered to the insulating member 6a, the X-ray tube unit 5 can be formed without incorporating the stator coil 9. Furthermore, since the X-ray shield 6b need not to be bonded to the insulating member 6a, the X-ray tube unit 5 can be formed without incorporating the X-ray shield 6b.

The X-ray shield 6b is electrically connected to the housing 20. In the seventeenth embodiment, the X-ray shield 6b is electrically connected to the housing 20 through the supporting members 9a, etc. It is therefore possible to stabilize the potential of the X-ray shield 6b.

For the above reason, it is possible to obtain an X-ray tube assembly and an X-ray tube unit 5 which can improve the heat of an anode target 35. Furthermore, the X-ray tube unit 5, which includes the X-ray shield 6b, can be alone subjected to an X-ray leakage test.

Techniques related to the above eleventh to seventeenth embodiments and modifications thereof can be applied as appropriate to the X-ray tube assemblies according to the first to tenth embodiments.

Next, matters related to the eleventh to seventeenth embodiments and the modifications thereof will be referred to in the following (T1) to (T24).

(T1) A rotation anode X-ray tube unit including:

a rotation anode X-ray tube including a cathode which emits electrons, an anode target which is rotatably provided to emit X-rays, and a vacuum envelope which accommodates the cathode and the anode target; and

a flow-passage formation member including a shell which surrounds the vacuum envelope in a direction perpendicular to an axis of the anode target, and forms a flow passage for flow of a cooling fluid.

(T2) The rotation anode X-ray tube unit according to (T1), wherein the cooling fluid is a coolant.

(T3) The rotation anode X-ray tube unit according to (T1), wherein the shell is an electrical insulating member.

(T4) The rotation anode X-ray tube unit according to (T3), wherein the electrical insulating member is formed of resin material containing at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(T5) The rotation anode X-ray tube unit according to (T3) or (T4), wherein the shell is formed of an electrical insulating material which contains as an admixture ingredient, metal fine particles of at least one of tungsten, tantalum, molybdenum, barium, bismuth, rare-earth metal and lead, and/or compound fine particles of at least one of tungsten, tantalum, molybdenum, barium, bismuth, rare-earth metal and lead, the shell including a through hole which permits X-rays to be transmitted therethrough.

(T6) The rotation anode X-ray tube unit according to (T1), wherein the shell surrounds at least part of the envelope, and includes a metal material including a through hole which permits X-rays to be transmitted therethrough.

(T7) The rotation anode X-ray tube unit according to (T5) or (T6), further including a partition plate which closes the through hole of the shell, and is formed of material having a good X-ray transmission characteristic.

(T8) The rotation anode X-ray tube unit according to one of (T1) to (T7), further including an X-ray shield which is located opposite to the rotation anode X-ray tube with respect to the shell, and includes a through hole which permits X-rays to be transmitted through.

(T9) The rotation anode X-ray tube unit according to (T8), wherein the X-ray shield is shaped to be in tight contact or close contact with the shell.

(T10) The rotation anode X-ray tube unit according to (T9), wherein the X-ray shield is fixed to the shell, and forms along with the shell a shield structure.

(T11) The rotation anode X-ray tube unit according to one of (T1) to (T10), further including a rotary drive unit which is located opposite to the rotation anode X-ray tube with respect to the flow-passage formation member, and rotates the anode target.

(T12) The rotation anode X-ray tube unit according to (T11), wherein the rotary drive unit is fixed to an outer surface of the shell.

(T13) A rotation anode X-ray tube assembly including:

a rotation anode X-ray tube unit; and

a housing accompanying the rotation anode X-ray tube unit, the housing providing space in which a cooling fluid flows, and which is located between the housing and the rotation anode X-ray tube unit,

wherein the rotation anode X-ray tube unit includes:

a rotation anode X-ray tube including a cathode which emits electrons, an anode target which is rotatably provided to emit X-rays, and a vacuum envelope which accommodates the cathode and the anode target; and

a flow-passage formation member including a shell surrounding the vacuum envelope in a direction perpendicular to an axis of the anode target, the flow-passage formation member forming along with the vacuum envelope a flow passage in which the cooling fluid flows, and which is located between the flow-passage formation member and the vacuum envelope.

(T14) The rotation anode X-ray tube assembly according to (T13), wherein the cooling fluid is a coolant.

(T15) The rotation anode X-ray tube assembly according to (T14), further including a circulation unit which produces a flow of the coolant in the flow passage and the space.

(T16) The rotation anode X-ray tube assembly according to (T14), wherein the cooling fluid is insulating oil.

(T17) The rotation anode X-ray tube assembly according to (T14), further including a high-voltage unit which is provided in the housing, immersed in the cooling fluid, and applies a high voltage to the rotation anode X-ray tube.

(T18) The rotation anode X-ray tube assembly according to one of (T14) to (T17), further including a heat exchanger which includes: an air-cooling radiator which is located in the housing and outside the housing, liquid-tightly attached to the housing, and radiates heat of the coolant to the outside of the housing; and an air blower which is provided outside the housing and sends air to the air-cooling radiator.

(T19) The rotation anode X-ray tube assembly according to one of (T13) to (T18), further including an X-ray shield which is located opposite to the rotation anode X-ray tube with respect to the shell, and includes a through hole which permits X-rays to be transmitted through.

(T20) The rotation anode X-ray tube assembly according to (T19), wherein the X-ray shield is electrically connected to the housing.

(T21) The rotation anode X-ray tube assembly according to one of (T13) to (T20), wherein the housing is formed of resin material.

(T22) The rotation anode X-ray tube assembly according to (T21), wherein the resin material of which the housing is formed includes at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(T23) The rotation anode X-ray tube assembly according to (T21) or (T22), wherein the housing includes a shield layer which forms at least part of an inner surface and an outer surface of the housing, and prevents an electromagnetic noise from leaking from the housing to the outside thereof.

(T24) The rotation anode X-ray tube assembly according to (T23), wherein the shield layer is formed of metal.

### Eighteenth Embodiment

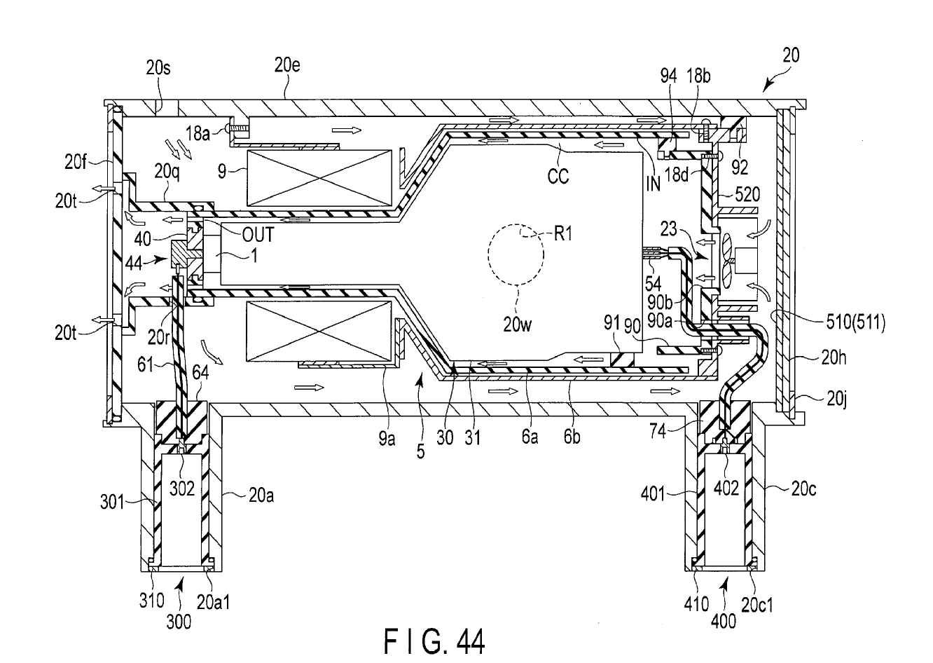

A rotation anode X-ray tube assembly according to the eighteenth embodiment will be explained. In the eighteenth embodiment, elements having the same functions as those in the twelfth embodiment will be denoted by the same reference numerals as in the twelfth embodiment, and their detailed explanations will be omitted. FIG. 44 is a cross-sectional view showing the X-ray tube assembly according to the eighteenth embodiment.

As shown in FIG. 44, a coolant 7 is not filled into a housing 20. There is a case where a load to the X-ray tube 30 is not high, and the X-ray tube assembly need not to use a coolant 7. In this case, the X-ray tube assembly can use air as a cooling fluid.

Furthermore, the X-ray tube assembly can be formed without a lid portion 20g or a rubber bellows 21. An X-ray shielding member 510 includes a first shielding member 511. The first shielding member 511 is bonded to the lid portion 20h. In a lid portion 20h, an air hole 20m is not formed.

A housing 20 includes an intake 20s for taking in air (open air) and an outlet 20t for letting out air. The intake 20s is a through hole formed in a housing body 20e. The intake 20s is located relatively close to a lid portion 20f. The outlet 20t is a through hole formed in the lid portion 20f.

To the lid portion 20f, a guide 20q for regulating the flow of air is closely contacted. The guide 20q is formed of resin material. In the eighteenth embodiment, a lid portion 20f is also formed of resin material. The guide 20q is tubularly formed, and surrounds the outlet 20t. The guide 20q is located opposite to an insulating member 6a. In the guide 20q, a through hole 20r is formed. The through hole 20r is a passage through which a high-voltage cable 71 is passed.

An annular groove portion is formed on an inner peripheral surface side of the guide 20q which is located opposite to the insulating member 6a. The gap between the guide 20q and the insulating member 6a is sealed by an annular O-ring provided in the groove portion. The O-ring has a function of preventing the leakage of air in the gap between the guide 20q and the insulating member 6a, and also a function of fixing the guide 20q to the insulating member 6a by utilizing a friction fit.

A fixing member 90 is provided in the housing 20. The fixing member 90 fixes the position of the insulating member 6a (X-ray tube unit 5) with respect to the housing 20. The fixing member 90 is formed of electrical insulating member such as resin. The fixing member 90 uses a number of rubber portions (electrical insulating members) 94 to fix the insulating member 6a. For example, the fixing member 90 fixes along with the rubber members 94 the insulating member 6a in three or four positions. The rubber members 94 are in contact with the insulating member 6a. Thus, the fixing member 90 and the rubber members 94 fix the insulating member 6a due to friction fits.

The fixing member 90 itself is screw-engaged with an X-ray shielding member 520 by screws 18d. In the fixing member 90, through holes 90a and 90b are formed. The through hole 90a is used as a passage for the high-voltage cable 71. The through hole 90b is used as a flow passage for air.

A circulation unit 23 lets out air taken in, to a side where the through hole 90b is located. Since forced convection can be made to occur in the housing 20, air can be circulated in the housing 20. Furthermore, a flow passage CC can produce a flow of air. In the eighteenth embodiment, air flows in the flow passage CC from a side where a high-voltage supply terminal 54 is located to a side where a high-voltage supply terminal 44 is located.

According to the eighteenth embodiment, in an X-ray tube unit 5 and the X-ray tube assembly having the above structures, the X-ray tube unit 5 comprises an X-ray tube 30 and the insulating member 6a. Therefore, the X-ray tube unit 5 and the X-ray tube assembly according to the eighteenth embodiment can obtain the same advantages as in the twelfth embodiment.

Since the X-ray tube assembly can be formed without a coolant 7, its weight can be reduced. Furthermore, the X-ray tube 30 is surrounded by the insulating member 6a, the fixing member 90, the guide 20q and the lid portion 20f, each of which has an electrical insulation. Thus, even in the case where a coolant 7 (insulating oil) is not provided in the housing 20, the durability of the X-ray tube 30 against voltage can be enhanced.

For the above reason, it is possible to obtain an X-ray tube assembly and an X-ray tube unit 5 which can improve the heat dissipation of an anode target 35. Furthermore, the X-ray tube unit 5, which includes an X-ray shield 6b, can be alone subjected to an X-ray leakage test.

### Nineteenth Embodiment

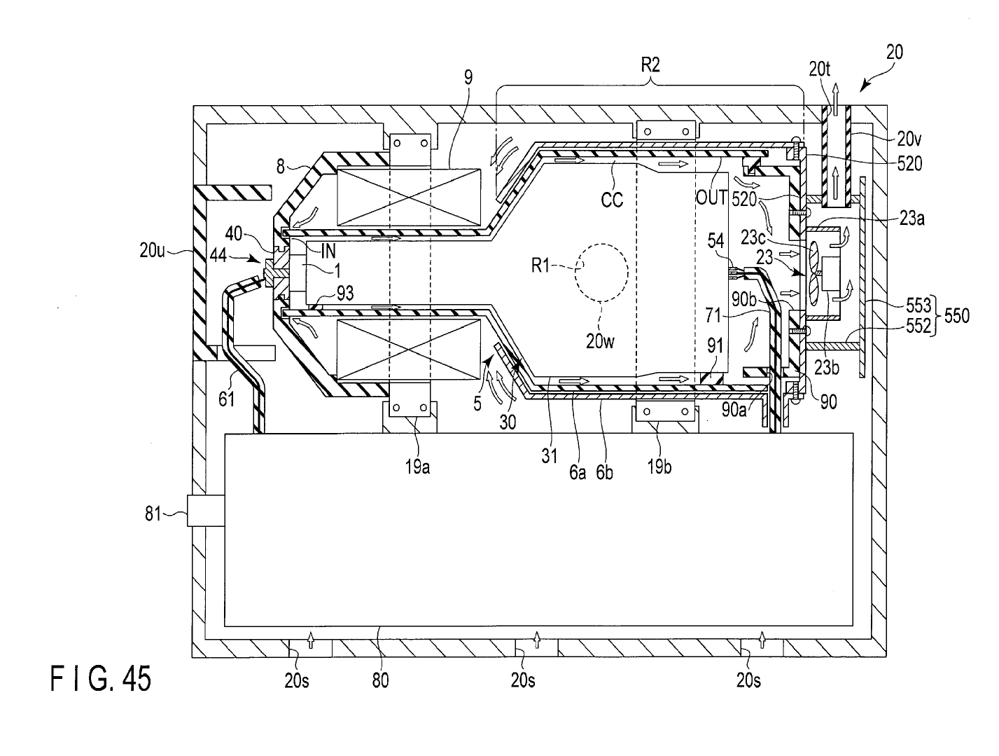

A rotation anode X-ray tube assembly according to the nineteenth embodiment will be explained. In the nineteenth embodiment, elements having the same functions as those in the fifteenth embodiment will be denoted by the same reference numerals as in the fifteenth embodiment, and their detailed explanations will be omitted. FIG. 45 is a cross-sectional view showing the X-ray tube assembly according to the nineteenth embodiment.

As shown in FIG. 45, a coolant 7 is not filled into a housing 20. The X-ray tube assembly can use air as a cooling fluid. The housing 20 includes an insulating member 20u and a duct 20v.

The insulating member 20u covers an electrical connection portion between a high-voltage supply terminal 44 and a high-voltage cable 61. The insulating member 20u is formed in the shape of a tub, and separated from the electrical connection portion. In the insulating member 20u, a through hole is formed as a passage through which the high-voltage cable 61 is passed.

The duct 20v has an electrical insulation. The duct 20v communicates with a through hole formed in a tubular portion 552. In the nineteenth embodiment, only the above through hole is formed in the tubular portion 552; that is, the number of through holes formed in the tubular portion 552 is only one. The duct 20v regulates the flow of air.

The housing 20 includes an intake 20s for taking in air (open air) and an outlet 20t for letting out air. The intake 20s is a through hole formed in the housing 20. The intake 20s is formed in the duct 20v. The outlet 20t is formed in a lid portion 20f.

A circulation unit 23 lets out air taken in from a side where a through hole 90b is located, to a side in which the duct 20v is located. Since forced convection can be made to occur in the housing 20, air can be circulated in the housing 20. Furthermore, a flow passage CC can produce a flow of air. In the nineteenth embodiment, air flows in a flow passage CC from a side where the high-voltage supply terminal 44 is located to a side in which the high-voltage supply terminal 54.

According to the nineteenth embodiment, in an X-ray tube unit 5 and the X-ray tube assembly having the above structures, the X-ray tube unit 5 comprises an X-ray tube 30 and an insulating member 6a. Therefore, the X-ray tube unit 5 and the X-ray tube assembly according to the nineteenth embodiment can obtain same advantages as in the fifteenth embodiment.

Since the X-ray tube assembly can be formed without a coolant 7, its weight can be reduced. Furthermore, the X-ray tube 30 is surrounded by the insulating member 6a, a fixing member 90 and a holder 8, each of which has an electrical insulation. The insulating member 20u covers an electrical connection portion between the high-voltage supply terminal 44 and the high-voltage cable 61. Thus, even in the case where a cooling fluid 7 (insulating oil) is not provided in the housing 20, the durability of an X-ray tube 30 against voltage can be enhanced.

For the above reason, it is possible to obtain an X-ray tube assembly and an X-ray tube unit 5 which can improve the heat dissipation of an anode target 35. Furthermore, the X-ray tube unit 5, which includes an X-ray shield 6b, can be alone subjected to an X-ray leakage test.

### Twentieth Embodiment

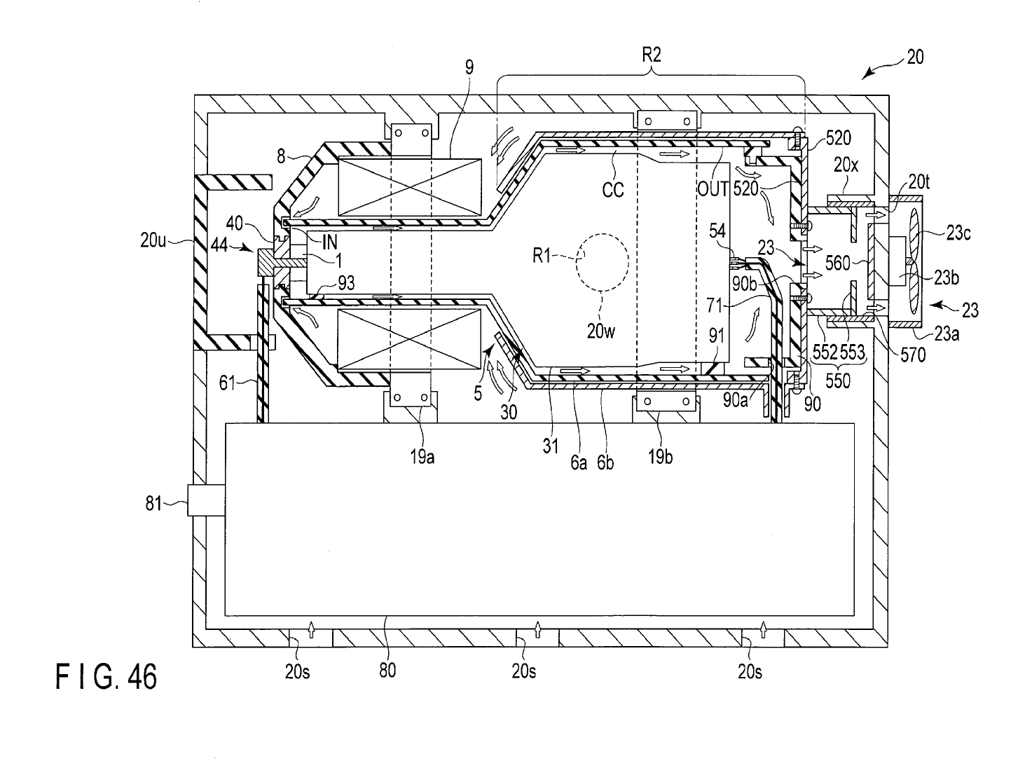

A rotation anode X-ray tube assembly according to the twentieth embodiment will be explained. In the twentieth embodiment, elements having the same functions as those in the nineteenth embodiment will be denoted by the same reference numerals as in the nineteenth embodiment, and their detailed explanations will be omitted. FIG. 46 is a cross-sectional view showing the X-ray tube assembly according to the twentieth embodiment.

As shown in FIG. 46, a housing 20 is formed without a duct 20v. In a tubular portion 552, a through hole is not formed. Thus, the tubular portion 552 also functions as a duct. In a plate portion 553, a through hole is formed.

An outlet 20t is a through hole formed in the housing 20. The outlet 20t is located opposite to the plate portion 553. In a region located opposite to the through hole of the plate portion 553, an X-ray shielding member (plate portion) 560 is bonded to an inner surface of the housing 20. The housing 20 includes a tubular portion 20x which surrounds the outlet 20t on an inner surface side of the housing 20. The tubular portion 20x is formed of metal material such as aluminum. To an inner peripheral surface of the tubular portion 20x, an X-ray shielding member (tubular portion) 570 is bonded. The X-ray shielding members 560 and 570 both contribute to shielding against scattered X-rays which may be radiated to the outside.

A circulation unit 23 is located outside the housing 20. In the twentieth embodiment, the circulation unit 23 is attached to an outer surface of the housing 20. The circulation unit 23 takes in air from a side in which the outlet 20t is located. Since forced convection can be made to occur in the housing 20, air can be circulated in the housing 20. Further, a flow passage CC can produce a flow of air. In the twentieth embodiment, air flows in the flow passage CC from a side where a high-voltage supply terminal 44 is located to a side in which a high-voltage supply terminal 54.

According to the twentieth embodiment, in an X-ray tube unit 5 and the X-ray tube assembly having the above structures, the X-ray tube unit 5 comprises an X-ray tube 30 and an insulating member 6a. Therefore, the X-ray tube unit 5 and the X-ray tube assembly according to the twentieth embodiment can obtain the same advantages as in the nineteenth embodiment. The circulation unit 23 may be attached to the outer surface of the housing 20.

For the above reason, it is possible to obtain an X-ray tube assembly and an X-ray tube unit 5 which can improve the heat dissipation of an anode target 35. Furthermore, the X-ray tube unit 5, which includes an X-ray shield 6b, can be alone subjected to an X-ray leakage test.

### Twenty-First Embodiment

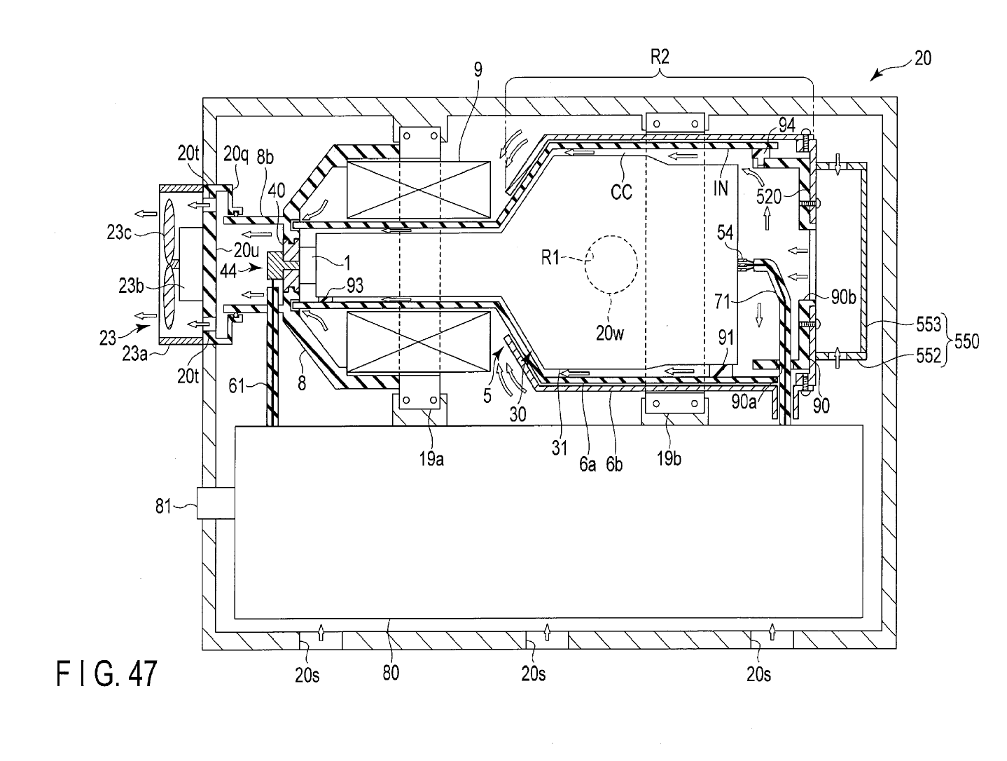

A rotation anode X-ray tube assembly according to the twenty-first embodiment will be explained. In the twenty-first embodiment, elements having the same functions as those in the twentieth embodiment will be denoted by the same reference numerals as in the twentieth embodiment, and their detailed explanations will be omitted. FIG. 47 is a cross-sectional view showing the X-ray tube assembly according to the twenty-first embodiment.

As shown in FIG. 47, in a tubular portion 552, a number of through holes are formed to function as air holes. It should be noted that in a plate portion 553, no through hole is formed. This is intended to shield scattered X-rays and regulate the flow of air.

The housing 20 does not include a tubular portion 20x. The X-ray tube assembly does not include X-ray shielding members 560 and 570.

A holder 8 includes a taking-out opening not shown. The taking-out opening has a function of taking out air flowing in a flow passage CC, etc. The holder 8 includes a tubular portion 8b. The tubular portion 8b surrounds the taking-out opening of the holder 8. The tubular portion 8b covers an electrical connection portion between a high-voltage supply terminal 44 and a high-voltage cable 61. Also, in the tubular portion 8b, a through hole is formed and used as a passage through which the high-voltage cable 61 is passed.

An insulating member 20u is formed in the shape of a plate, and separated from the tubular portion 8b. In the insulating member 20u, an outlet 20t is formed.

To the insulating member 20u, a guide 20q is attached to regulate the flow of air. The guide 20q is formed of resin material. In the twenty-first embodiment, the insulating member 20u is also formed of resin material. The guide 20q is tubularly formed, and surrounds the outlet 20t. The guide 20q is located opposite to the tubular portion 8b.

An annular groove portion is formed on an inner peripheral surface side of the guide 20q which is located opposite to the tubular portion 8b. The gap between the guide 20q and the tubular portion 8b is sealed by an annular O-ring provided in the groove portion. The O-ring has a function of preventing the leakage of air in the gap between the guide 20q and the tubular portion 8b.

A circulation unit 23 is provided outside the housing 20, and attached to the insulating member 20u (the outer surface of a housing 20). The circulation unit 23 takes in air from a side in which the outlet 20t is located. Since forced convection can be made to occur in the housing 20, air can be circulated in the housing 20. Furthermore, a flow passage CC can produce a flow of air. In the twenty-first embodiment, air flows in the flow passage CC from a side where a high-voltage supply terminal 54 is located to a side where the high-voltage supply terminal 44 is located.

According to the twenty-first embodiment, in an X-ray tube unit 5 and the X-ray tube assembly having the above structures, the X-ray tube unit 5 comprises an X-ray tube 30 and an insulating member 6a. Therefore, the X-ray tube unit 5 and the X-ray tube assembly according to the twenty-first embodiment can obtain the same advantages as in the twentieth embodiment.

For the above reason, it is possible to obtain an X-ray tube assembly and an X-ray tube unit 5 which can improve the heat dissipation of an anode target 35. Furthermore, the X-ray tube unit 5, which includes an X-ray shield 6b, can be alone subjected to an X-ray leakage test.

Techniques related to the above eighteenth to twenty-first embodiments can be applied as appropriate to the X-ray tube assemblies according to the first to seventeenth embodiments.

Next, matters related to the above eighteenth to twenty-first embodiments and modifications thereof will be referred to in the following (U1) and (U21).

(U1) A rotation anode X-ray tube unit including:

a rotation anode X-ray tube including a cathode which emits electrons, an anode target which is rotatably provided to emit X-rays, and a vacuum envelope which accommodates the cathode and the anode target; and

a flow-passage formation member including a shell which surrounds the vacuum envelope in a direction perpendicular to an axis of the anode target, the flow-passage formation member forming a flow passage in which a cooling fluid flows, and which is located between the flow-passage formation member and the vacuum envelope.

(U2) The rotation anode X-ray tube unit according to (U1), wherein the cooling fluid is air.

(U3) The rotation anode X-ray tube unit according to (U1), wherein the shell is an electrical insulating member.

(U4) The rotation anode X-ray tube unit according to (U3), wherein the electrical insulating member is formed of resin material containing at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(U5) The rotation anode X-ray tube unit according to (U3) or (U4), wherein the shell is formed of an electrical insulating material which contains as an admixture ingredient, metal fine particles of at least one of tungsten, tantalum, molybdenum, barium, bismuth, rare-earth metal and lead, and/or compound fine particles of at least one of tungsten, tantalum, molybdenum, barium, bismuth, rare-earth metal and lead, the shell including a through hole which permits X-rays to be transmitted therethrough.

(U6) The rotation anode X-ray tube unit according to (U1), wherein the shell surrounds at least part of the envelope, and includes a metal material including a through hole which permits X-rays to be transmitted therethrough.

(U7) The rotation anode X-ray tube unit according to (U5) or (U6), further including a partition plate which closes the through hole of the shell, and is formed of material having a good X-ray transmission characteristic.

(U8) The rotation anode X-ray tube unit according to one of (U1) to (U7), further including an X-ray shield which is located opposite to the rotation anode X-ray tube with respect to the shell, and includes a through hole which permits X-rays to be transmitted through.

(U9) The rotation anode X-ray tube unit according to (U8), wherein the X-ray shield is shaped to be in tight contact or close contact with the shell.

(U10) The rotation anode X-ray tube unit according to (U9), wherein the X-ray shield is fixed to the shell, and forms along with the shell a shield structure.

(U11) The rotation anode X-ray tube unit according to (U1), further including a rotary drive unit which is located opposite to the anode X-ray tube with respect to the flow-passage formation member, restricts the position of the flow-passage formation member in a direction perpendicular to the axis, and rotates the anode target.

(U12) The rotation anode X-ray tube unit according to (U11), wherein the rotary drive unit is fixed to an outer surface of the shell.

(U13) A rotation anode X-ray tube assembly including:

a rotation anode X-ray tube unit; and

a housing accompanying the rotation anode X-ray tube unit, and providing space in which a cooling fluid flows and which is located between the housing and the rotation anode X-ray tube unit,

wherein the rotation anode X-ray tube unit includes:

a rotation anode X-ray tube including a cathode which emits electrons, an anode target which is rotatably provided to emit X-rays, and a vacuum envelope which accommodates the cathode and the anode target; and

a flow-passage formation member including a shell which surrounds the vacuum envelope in a direction perpendicular to an axis of the anode target, the flow-passage formation member forming a flow passage in which the cooling fluid flows and which is located between the flow-passage formation member and the vacuum envelope.

(U14) The rotation anode X-ray tube assembly according to (U13), wherein the cooling fluid is air, and the housing includes an intake for taking in air and an outlet for letting out air.

(U15) The rotation anode X-ray tube assembly according to (U14), further including a circulation unit which produces a flow of air in the flow passage and the space.

(U16) The rotation anode X-ray tube assembly according to (U13), further including a high-voltage unit which is provided in the housing, and applies a high voltage to the rotation anode X-ray tube,

wherein the cooling fluid is insulating oil.

(U17) The rotation anode X-ray tube assembly according to one of (U13) to (U16), further including an X-ray shield which is located opposite to the rotation anode X-ray tube with respect to the shell, and includes a through hole which permits X-rays to be transmitted through.

(U18) The rotation anode X-ray tube assembly according to one of (U13) to (U17), wherein the housing is formed of resin material.

(U19) The rotation anode X-ray tube assembly according to (U18), wherein the resin material of which the housing is formed includes at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(U20) The rotation anode X-ray tube assembly according to (U18) or (U19), wherein the housing includes a shield layer which forms at least part of an inner surface and an outer surface of the housing, and prevents an electromagnetic noise from leaking from the housing to the outside thereof.

(U21) The rotation anode X-ray tube assembly according to (U20), wherein the shield layer is formed of metal.

### Twenty-Second Embodiment

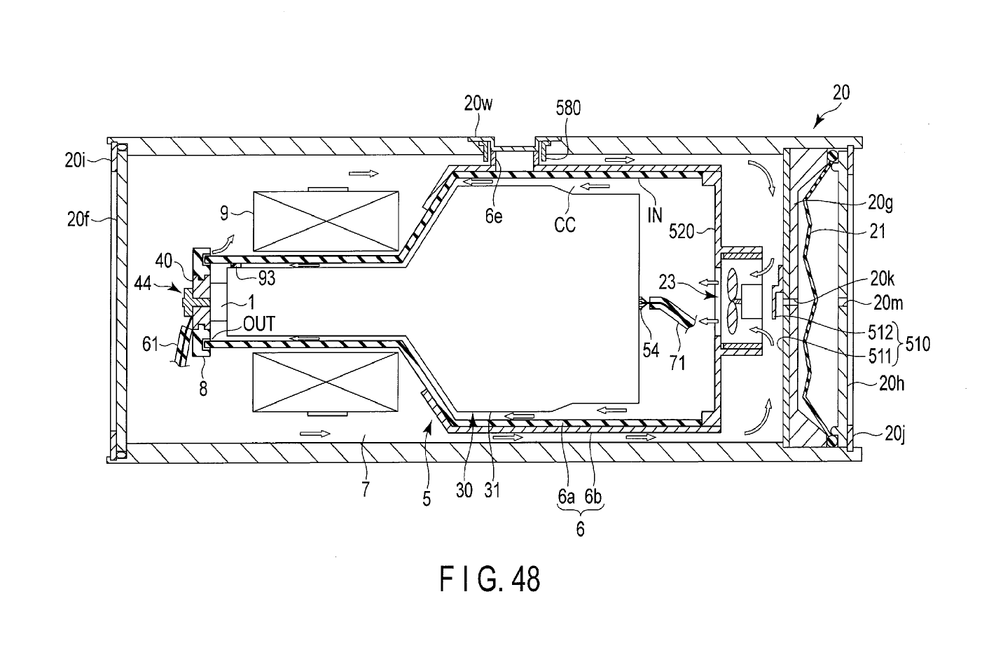

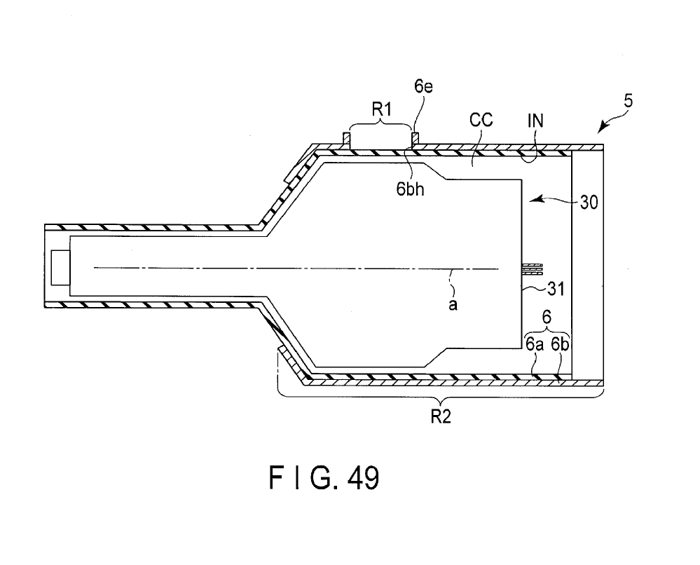

A rotation anode X-ray tube assembly according to the twenty-second embodiment will be explained. In the twenty-second embodiment, elements having the same functions as those in the eleventh embodiment will be denoted by the same reference numerals as in the eleventh embodiment, and their detailed explanations will be omitted. FIG. 48 is a cross-sectional view (vertical sectional view) showing the X-ray tube assembly according to the twenty-second embodiment. It should be noted that FIG. 28 can be regarded as a cross-sectional view of the X-ray tube assembly according to the twenty-second embodiment. FIG. 49 is a cross-sectional view of a rotation anode X-ray tube unit according to the twenty-second embodiment.

As shown in FIGS. 48 and 49, the X-ray tube assembly comprises an X-ray shielding member 6e as a first X-ray shielding member and an X-ray shielding member 580 as a second X-ray shielding member. In this regard, it suffices that the X-ray tube assembly comprises at least one of the X-ray shielding member 6e and the X-ray shielding member 580.

The X-ray shielding member 6e is formed in the shape of a frame (the shape of a tube). The X-ray shielding member 6e is attached to an X-ray shield 6b, and surrounds a through hole 6bh of the X-ray shield 6b. The X-ray shielding member 6e projects toward the housing 20.

The X-ray shielding member 580 is formed in the shape of a frame (the shape of a tube). The X-ray shielding member 580 is attached to a housing body 20e, and surrounds an opening (an X-ray output window 20w) of the housing body 20e. The X-ray shielding member 580 projects towards the X-ray shield 6b.

The X-ray shielding member 6e and the X-ray shielding member 580 can be formed of, for example, a hard lead, by a casting process. In this case, the X-ray shielding member 580 can be fixed to the housing body 20e by screw engagement. The X-ray shielding member 6e can be fixed to the X-ray shield 6b by soldering.

The outside diameter of the X-ray shielding member 6e is smaller than the inside diameter of the X-ray shielding member 580. The X-ray shielding member 580 is provided in such a manner as to surround the X-ray shielding member 6e. The X-ray shielding member 6e and the X-ray shielding member 580 are stacked together in a direction perpendicular to a direction which the X-ray output window 20w and the through hole 6bh are located opposite to each other.

In an X-ray tube unit 5 and the X-ray tube assembly having the above structures according to the twenty-second embodiment, the X-ray tube unit 5 comprises an X-ray tube 30 and a shield structure 6. Therefore, the X-ray tube unit 5 and the X-ray tube assembly according to the twenty-second embodiment can obtain the same advantages as in the eleventh embodiment.

The X-ray tube assembly comprises at least one of the X-ray shielding member 6e and the X-ray shielding member 580. It is therefore possible to prevent leakage of undesired X-rays (scattered X-rays) in the vicinity of the through hole 6bh of the X-ray shield 6b. In the twenty-second embodiment, the X-ray tube assembly comprises both the X-ray shielding member 6e and the X-ray shielding member 580, and can thus further reliably achieve the above effect.

For the above reason, it is possible to obtain an X-ray tube assembly and an X-ray tube unit 5 which can improve the heat dissipation of an anode target 35. Furthermore, the X-ray tube unit 5 can be alone subjected to an X-ray leakage test.

### Twenty-Third Embodiment

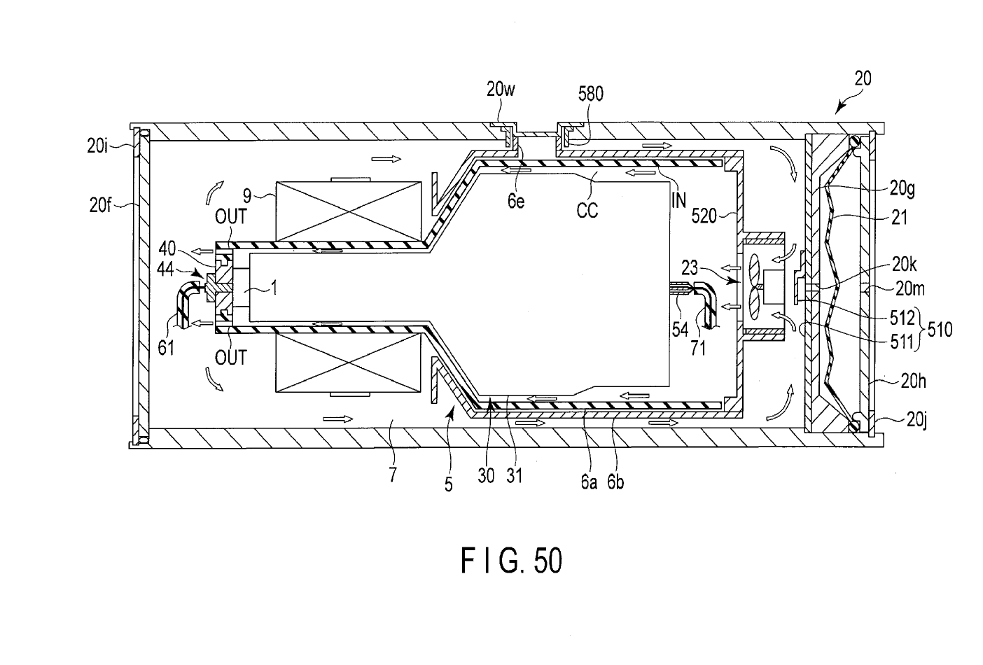

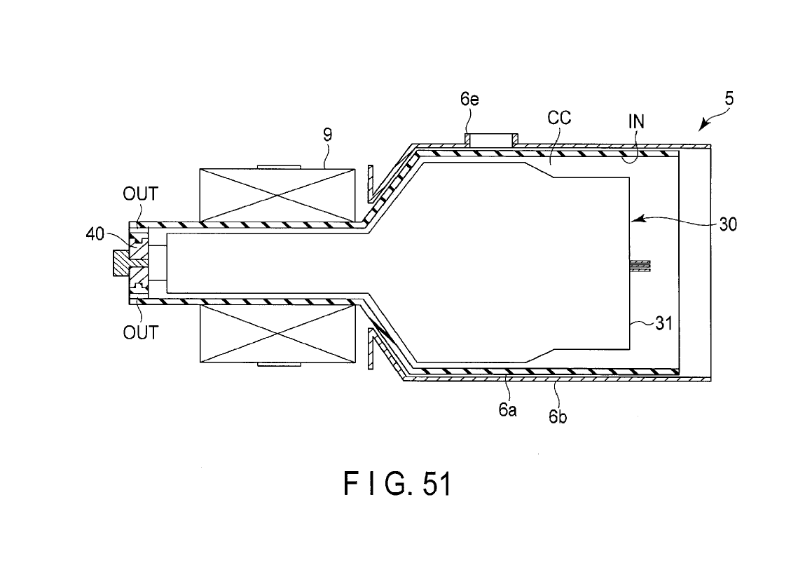

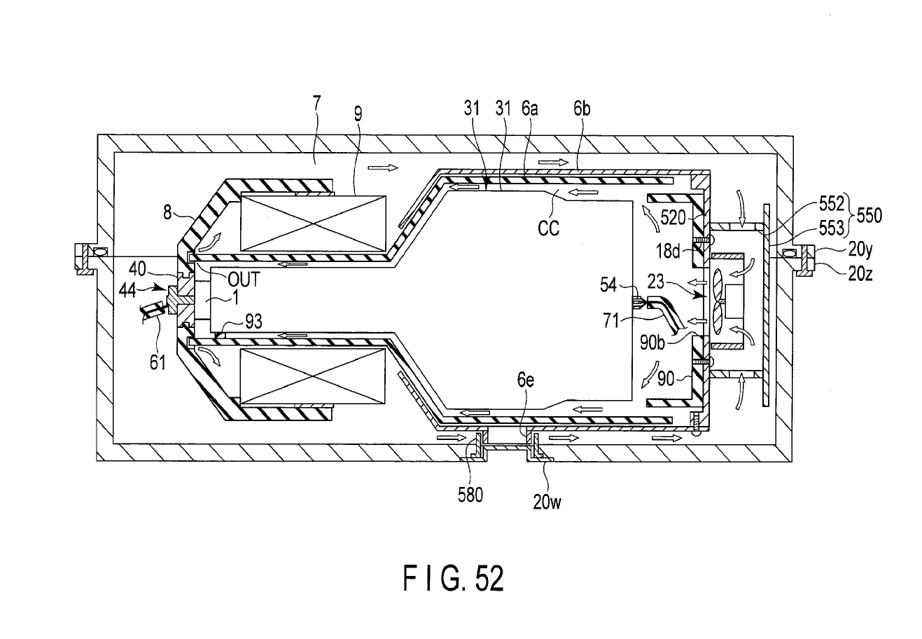

A rotation anode X-ray tube assembly according to the twenty-third embodiment will be explained. In the twenty-third embodiment, elements having the same functions as those in the twelfth embodiment will be denoted by the same reference numerals as in the twelfth embodiment, and their detailed explanations will be omitted. FIG. 50 is a cross-sectional view (vertical sectional view) showing the X-ray tube assembly according to the twenty-third embodiment. It should be noted that FIG. 34 can be regarded as a cross-sectional view of the X-ray tube assembly according to the twenty-third embodiment. FIG. 51 is a cross-sectional view showing a rotation anode X-ray tube unit according to the twenty-third embodiment.

As shown in FIGS. 50 and 51, the X-ray tube assembly comprises an X-ray shielding member 6e and an X-ray shielding member 580 as described above with respect to the twenty-second embodiment. In this regard, it suffices that the X-ray tube assembly comprises at least one of the X-ray shielding member 6e and the X-ray shielding member 580.

According to the twenty-third embodiment, in an X-ray tube unit 5 and the X-ray tube assembly having the above structures, the X-ray tube unit 5 comprises an X-ray tube 30, an insulating member 6a and an X-ray shield 6b. Therefore, the X-ray tube unit 5 and the X-ray tube assembly according to the twenty-third embodiment can obtain the same advantages as in the twelfth embodiment.

The X-ray tube assembly comprises at least one of the X-ray shielding member 6e and the X-ray shielding member 580. It is therefore possible to prevent leakage of undesired X-rays (scattered X-rays) in the vicinity of a through hole 6bh of the X-ray shield 6b. In the twenty-third embodiment, the X-ray tube assembly comprises both the X-ray shielding member 6e and the X-ray shielding member 580, and can thus further reliably achieve the above effect.

For the above reason, it is possible to obtain an X-ray tube assembly and an X-ray tube unit 5 which can improve the heat dissipation of an anode target 35. Furthermore, the X-ray tube unit 5 can be alone subjected to an X-ray leakage test.

### Twenty-Fourth Embodiment

A rotation anode X-ray tube assembly according to the twenty-fourth embodiment will be explained. In the twenty-fourth embodiment, elements having the same functions as those in the fifteenth embodiment will be denoted by the same reference numerals as in the fifteenth embodiment, and their detailed explanations will be omitted. FIG. 52 is a cross-sectional view (vertical sectional view) showing the X-ray tube assembly according to the twenty-fourth embodiment. It should be noted that FIG. 38 can be regarded as a cross-sectional view of the X-ray tube assembly according to the twenty-fourth embodiment.

As shown in FIG. 52, the X-ray tube assembly comprises an X-ray shielding member 6e and an X-ray shielding member 580 as described above with respect to the twenty-second embodiment. In this regard, it suffices that the X-ray tube assembly comprises at least one of the X-ray shielding member 6e and the X-ray shielding member 580.

Roughly speaking, the housing 20 is divided into a housing body and a lid portion. The housing body includes a frame portion (flange) 20y at an outer edge side of an opening end. The lid portion includes a frame portion (flange) 20z on an outer edge side of an opening end. In the frame portion 20y (the housing body), a frame-shaped groove portion is formed on a side located opposite to the frame portion 20z. The housing body and the lid portion are in contact with each other and fixed to each other by screw engagement, with the frame portion 20y and the frame portion 20z located to face each other. An O-ring is provided at the groove portion formed in the frame portion 20y, and prevents leakage of a coolant 7 from a housing 20 to the outside thereof.

According to the twenty-fourth embodiment, in an X-ray tube unit 5 and the X-ray tube assembly having the above structures, the X-ray tube unit 5 comprises an X-ray tube 30, an insulating member 6a and an X-ray shield 6b. Therefore, the X-ray tube unit 5 and the X-ray tube assembly according to the twenty-fourth embodiment can obtain same advantages as in the fifteenth embodiment.

The X-ray tube assembly comprises at least one of the X-ray shielding member 6e and the X-ray shielding member 580. It is therefore possible to prevent leakage of undesired X-rays (scattered X-rays) in the vicinity of a through hole 6bh of the X-ray shield 6b. In the twenty-fourth embodiment, the X-ray tube assembly comprises both the X-ray shielding member 6e and the X-ray shielding member 580, and can thus further reliably achieve the above effect.

For the above reason, it is possible to obtain an X-ray tube assembly and an X-ray tube unit 5 which can improve the heat dissipation of an anode target 35. Furthermore, the X-ray tube unit 5 including the X-ray shield 6b can be alone subjected to an X-ray leakage test.

Techniques related to the above twenty-second to twenty-fourth embodiments can be applied as appropriate to the X-ray tube assemblies according to the first to twenty-first embodiments.

Next, matters related to the twenty-second to twenty-fourth embodiments and the modifications thereof will be referred to in the following (V1) to (V24).

(V1) A rotation anode X-ray tube unit including:

a rotation anode X-ray tube including a cathode which emits electrons, an anode target which is rotatably provided to emit X-rays, and a vacuum envelope which accommodates the cathode and the anode target; and

a flow-passage formation member including a shell which surrounds the vacuum envelope in a direction perpendicular to an axis of the anode target, the flow-passage formation member forming a flow passage in which a cooling fluid flows, and which is located between the flow-passage formation member and the vacuum envelope.

(V2) The rotation anode X-ray tube unit according to (V1), further including:

an X-ray shield located opposite to the rotation anode X-ray tube with respect to the shell, and including a through hole which permits X-rays to be transmitted therethrough; and

a frame-shaped X-ray shielding member attached to the X-ray shield, surrounding the through hole of the X-ray shield, and projecting opposite to the shell with respect to the X-ray shield.

(V3) The rotation anode X-ray tube unit according to (V2), wherein the X-ray shield is shaped to be in tight contact or close contact with the shell.

(V4) The rotation anode X-ray tube unit according to (V3), wherein the X-ray shield is fixed to the shell, and forms along with the shell a shield structure.

(V5) The rotation anode X-ray tube unit according to one of (V1) to (V4), wherein the cooling fluid is a coolant.

(V6) The rotation anode X-ray tube unit according to one of (V1) to (V5), wherein the shell is an electrical insulating member.

(V7) The rotation anode X-ray tube unit according to (V6), wherein the electrical insulating member is formed of resin material containing at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(V8) The rotation anode X-ray tube unit according to (V6) or (V7), wherein the shell is formed of an electrical insulating material which contains as an admixture ingredient, metal fine particles of at least one of tungsten, tantalum, molybdenum, barium, bismuth, rare-earth metal and lead, and/or compound fine particles of at least one of tungsten, tantalum, molybdenum, barium, bismuth, rare-earth metal and lead, the shell including a through hole which permits X-rays to be transmitted therethrough.

(V9) The rotation anode X-ray tube unit according to (V1), wherein the shell surrounds at least part of the envelope, and includes a metal material including a through hole which permits X-rays to be transmitted therethrough.

(V10) The rotation anode X-ray tube unit according to (V8) or (V9), further including a partition plate which closes the through hole of the shell, and is formed of material having a good X-ray transmission characteristic.

(V11) The rotation anode X-ray tube unit according to one of (V1) to (V10), further including a rotary drive unit which is located opposite to the rotation anode X-ray tube with respect to the flow-passage formation member, and rotates the anode target.

(V12) The rotation anode X-ray tube unit according to (V11), wherein the rotary drive unit is fixed to an outer surface of the shell.

(V13) A rotation anode X-ray tube assembly including:

a rotation anode X-ray tube unit; and

a housing accompanying the rotation anode X-ray tube unit, and providing space in which a cooling fluid flows and which is located between the housing and the rotation anode X-ray tube unit,

wherein the rotation anode X-ray tube unit includes:

a rotation anode X-ray tube including a cathode which emits electrons, an anode target which is rotatably provided to emit X-rays, and a vacuum envelope which accommodates the cathode and the anode target; and

a flow-passage formation member including a shell which surrounds the vacuum envelope in a direction perpendicular to an axis of the anode target, the flow-passage formation member forming a flow passage in which the cooling fluid flows, and which is located between the flow-passage formation member and the vacuum envelope.

(V14) The rotation anode X-ray tube assembly according to (V13), further including:

an X-ray shield located opposite to the rotation anode X-ray tube with respect to the shell, and including a through hole which permits X-rays to be transmitted therethrough;

an X-ray output window which transmits X-rays, and which closes an opening of the housing which is located opposite to the through hole of the X-ray shield; and

a frame-shaped X-ray shielding member,

wherein the X-ray shielding member is attached to the X-ray shield, surrounds the through hole of the X-ray shield, and projects toward the housing, or is attached to the housing, surrounds the opening of the housing, and projects toward the X-ray shield.

(V15) The rotation anode X-ray tube assembly according to (V13), further including:

an X-ray shield located opposite to the rotation anode X-ray tube with respect to the shell, and including a through hole which permits X-rays to be transmitted therethrough;

an X-ray output window which transmits X-rays, and which closes an opening of the housing which is located opposite to the through hole of the X-ray shield;

a first X-ray shielding member which is frame-shaped, attached to the X-ray shield, surrounds the through hole of the X-ray shield, and projects toward the housing; and

a second X-ray shielding member which is frame-shaped, attached to the housing, surrounds the opening of the housing, and projects toward the X-ray shield.

(V16) The rotation anode X-ray tube assembly according to (V13), wherein the cooling fluid is a coolant.

(V17) The rotation anode X-ray tube assembly according to (V16), further including a circulation unit which produces a flow of the coolant in the flow passage and the space.

(V18) The rotation anode X-ray tube assembly according to (V13), wherein the coolant is insulating oil.

(V19) The rotation anode X-ray tube assembly according to (V18), further including a high-voltage unit which is provided in the housing, immersed in the coolant, and applies a high voltage to the rotation anode X-ray tube.

(V20) The rotation anode X-ray tube assembly according to one of (V16) to (V19), further including a heat exchanger which includes: an air-cooling radiator which is located in the housing and outside the housing, and liquid-tightly attached to the housing, and radiates heat of the coolant to the outside of the housing; and an air blower which is provided outside the housing and sends air to the air-cooling radiator.

(V21) The rotation anode X-ray tube assembly according to one of (V13) to (V20), wherein the housing is formed of resin material.

(V22) The rotation anode X-ray tube assembly according to (V21), wherein the resin material of which the housing is formed includes at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(V23) The rotation anode X-ray tube assembly according to (V21) or (V22), wherein the housing includes a shield layer which forms at least part of an inner surface and an outer surface of the housing, and prevents an electromagnetic noise from leaking from the housing to the outside thereof.

(V24) The rotation anode X-ray tube assembly according to (V23), wherein the shield layer is formed of metal.

### Twenty-Fifth Embodiment

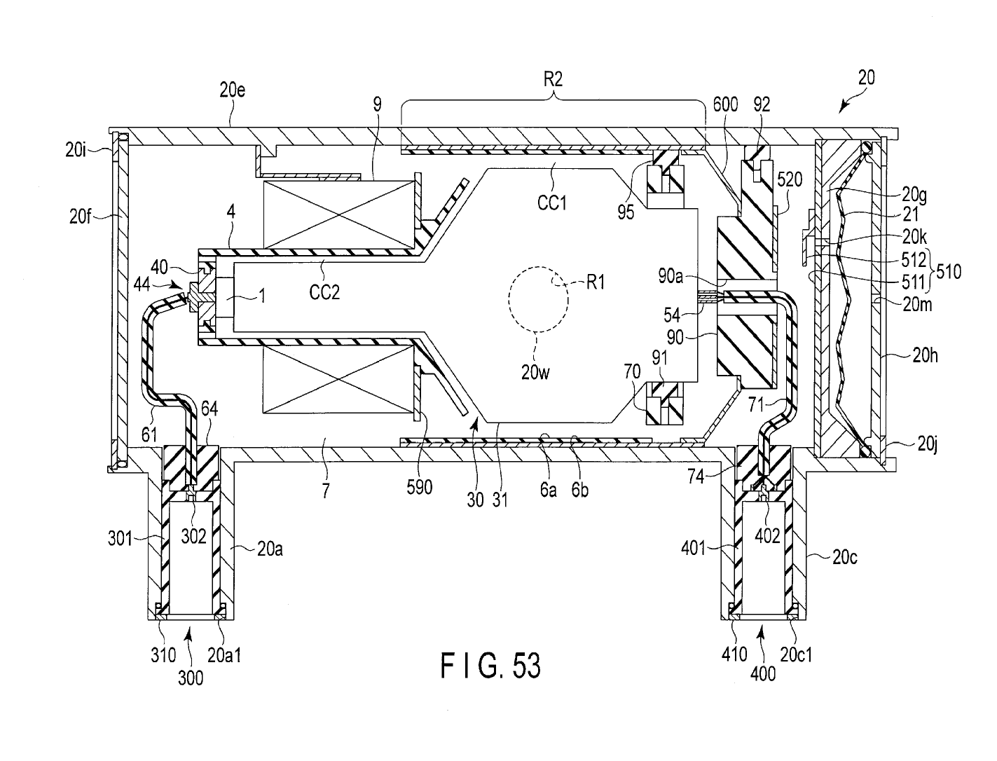

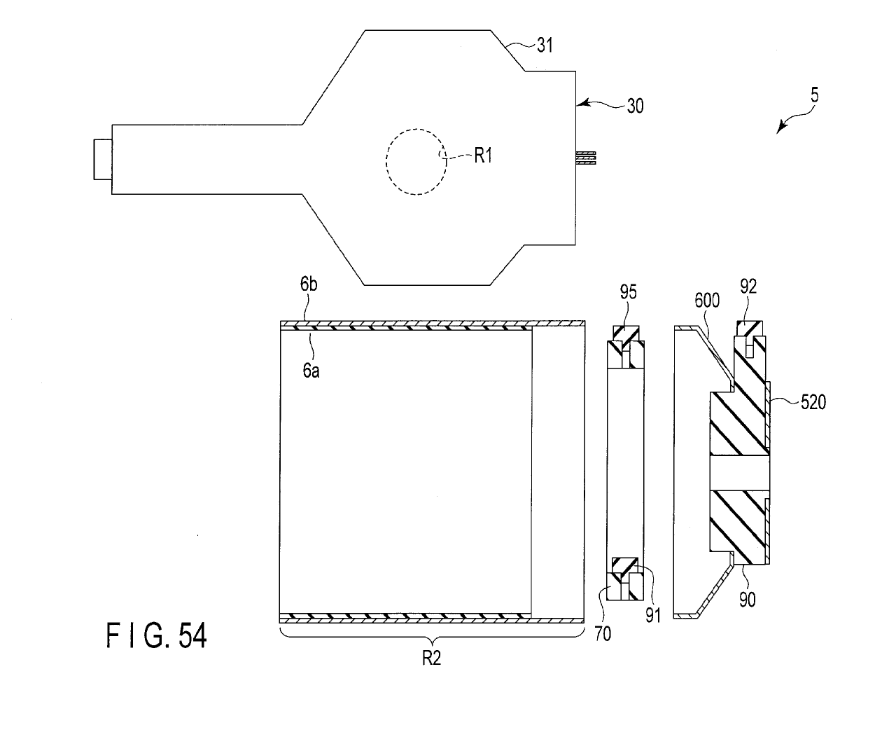

A rotation anode X-ray tube assembly according to the twenty-fifth embodiment will be explained. In the twenty-fifth embodiment, elements having the same functions as those in the first embodiment will be denoted by the same reference numerals as in the first embodiment, and their detailed explanations will be omitted. FIG. 53 is a cross-sectional view showing the X-ray tube assembly according to the twenty-fifth embodiment. FIG. 54 is an exploded cross-sectional view showing a rotation anode X-ray tube unit according to the twenty-fifth embodiment.

As shown in FIGS. 53 and 54, the housing body 20e is formed of metal material such as aluminum. In the housing body 20e formed of the metal material, heat of a coolant 7 is easily transmitted, and heat is easily radiated to the outside, as compared with a housing body formed of resin material.

A vacuum envelope 31 includes a large-diameter portion located opposite to an anode target 35 in the direction perpendicular to the axis a, a small-diameter portion located opposite to a rotor 10 in the direction perpendicular to the axis a, and an intermediary portion joining the large-diameter portion and the small-diameter portion.

The X-ray shield 6b is tubularly formed. It should be noted that the X-ray shield 6b is formed of lead. The outside diameter of the X-ray shield 6b is slightly smaller the inside diameter of the housing body 20e, and the X-ray shield 6b can be inserted into the housing body 20e. The X-ray shield 6b surrounds the large-diameter portion and intermediary portion of the vacuum envelope 31.

An insulating member 6a is tubularly formed. In the twenty-fifth embodiment, the insulating member 6a is formed of an electrical insulating material. The insulating member 6a is provided independent of the X-ray shield 6b. The outside diameter of the insulating member 6a is slightly smaller the inside diameter of the X-ray shield 6b, and the insulating member 6a can be inserted into the X-ray shield 6b. The insulating member 6a surrounds at least the large-diameter portion of the vacuum envelope 31. In the twenty-fifth embodiment, the insulating member 6a surrounds the large-diameter portion and the intermediary portion of the vacuum envelope 31.

It should be noted that the insulating member 6a and the X-ray shield 6b may be provided as a single body. Also, it is possible to replace the insulating member 6a with a metallic member.

The positions of the insulating member 6a and the X-ray shield 6b along the axis a are fixed by another means. The insulating member 6a functions as a flow-passage formation member which forms a flow passage between the insulating member 6a and the vacuum envelope 31 as a flow passage in which the coolant 7 flows. In the twenty-fifth embodiment, the X-ray tube assembly does not include a circulation unit, since natural convection occurs in the coolant 7 in the housing 20.

An annular portion 70 is annularly formed, and provided around a large-diameter portion of an X-ray tube 30 (the vacuum envelope 31) and apart from the large-diameter portion. The annular portion 70 is formed of an electrical insulating material such as resin. A number of rubber members (electrical insulating members) 91 are attached to an inner peripheral surface side of the annular portion 70, and are also in contact with the large-diameter portion of the X-ray tube 30 (the vacuum envelope 31). Furthermore, a number of rubber members (electrical insulating members) 95 are attached to an outer peripheral surface side of the annular portion 70, and are also in contact with the X-ray shield 6b. Thus, the annular portion 70 and the rubber members 91 and 95 fix the X-ray tube 30 to the housing 20 due to friction fits.

The rubber members 95 presses the X-ray shield 6b against the housing body 20e. Thereby, the X-ray shield 6b is deformed to contact the housing body 20e and to be electrically connected to the housing body 20e. It is therefore possible to stabilize the potential of the X-ray shield 6b. It is possible to restrict induction of discharge of the X-ray tube 30 in the case where the X-ray shield 6b is electrically in a floating state. Between the X-ray shield 6b and an inner wall of the housing body 20e, a sufficient gap (approximately 0.2 mm or more) for causing the coolant 7 to flow due to natural convection of the coolant 7 is provided, except for the vicinity of part of the X-ray shield 6b which is pressed by the rubber members 95. In order to do so, as occasion demands, the outside-diameter of the X-ray shield 6b may be changed on both sides along the axis a with respect to the rubber members 95.

An X-ray shielding member 590 is annularly formed. The X-ray shielding member 590 is attached to a stator coil 9, and is set to have the same potential as the housing 20. In the direction perpendicular to the axis a, the X-ray shielding member 590 is surrounded by the X-ray shield 6b. The X-ray shielding member 590 contributes to shielding against scattered X rays.

The X-ray tube assembly includes a high-voltage insulating member 4. The high-voltage insulating member 4 is fixed to the X-ray tube 30 by a connection member 40. The high-voltage insulating member 4 and the connection member 40 are mechanically firmly connected to each other. One of ends of the high-voltage insulating member 4 is conically formed and the other is closely tubularly formed. The high-voltage insulating member 4 surrounds the small-diameter portion and intermediary portion of the vacuum envelope 31 in the direction perpendicular to the axis a. The high-voltage insulating member 4 electrically insulates a fixed shaft 1, a housing 20 and the stator coil 9 from each other.

The high-voltage insulating member 4 includes an opening for entry or exit of the coolant 7, which is located close to the connection member 40. The high-voltage insulating member 4 functions as a flow-passage formation member forming a flow passage in which the coolant 7 flows and which is located between the high-voltage insulating member 4 and the vacuum envelope 31. This is provided in consideration of natural convection which occurs in the coolant 7 in the housing 20.

Furthermore, in the twenty-fifth embodiment, the insulating member 6a and the high-voltage insulating member 4 are formed of independent of each other, and spaced from each other. A flow passage CC1 between the insulating member 6a and the vacuum envelope 31 is separated from a flow passage CC2 between the high-voltage insulating member 4 and the vacuum envelope 31, thus enabling natural convection to easily occur in the coolant 7.

The stator coil 9 is adhered to the high-voltage insulating member 4.

A fixing member 90 is provided in the housing 20. Also, on a side located opposite to an anode target 35 with respect to a cathode 36, the fixing member 90 is located outward of the X-ray tube 30. The fixing member 90 is an electrical insulating member, and also formed of an electrical insulating material such as resin.

To the fixing member 90, an X-ray shield 600 is attached. An X-ray shield 600 is formed of a hard lead. The X-ray shield 600 is formed in the shape of a frame. The X-ray shield 600 includes an end portion which is laid over the X-ray shield 6b in the direction perpendicular to the axis a. The outside-diameter of the end portion of the X-ray shield 600 is slightly smaller than the inside-diameter of the X-ray shield 6b. The X-ray shield 600 contributes to shielding against undesired X-rays (e.g., scattered X-rays).

The fixing member 90 is fixed to the housing body 20e with a number of rubber members (electrical insulating members) 92. For example, in three or four positions, the fixing member 90 is fixed with the rubber members 92. The rubber members 92 are in contact with the housing body 20e. Thus, the fixing member 90 and the rubber members 92 are fixed to the housing body 20e due to friction fits.

A through hole 90a formed in the fixing member 90 is used as space for connection between a high-voltage supplying terminal 54 and a high-voltage cable 71, a passage for the high-voltage cable 71 and a flow passage for the coolant 7. The fixing member 90 is located and shaped to maintain a connection portion between the high-voltage supplying terminal 54 and the high-voltage cable 71 and the insulation for the high-voltage cable 71.

Also, the X-ray shield 600 and the X-ray shielding member 520 are attached to the fixing member 90. As described above, on a side where the cathode 36 is located, lead and insulating material are used in a multiple manner. This can reduce the quantity of lead to be applied. Also, it can be ensured that the high-voltage cable 71, the X-ray shield 600 and the X-ray shielding member 520 are insulated from each other.

At least the X-ray tube 30, the insulating member 6a and the X-ray shield 6b form a rotation anode X-ray tube unit 5. In the twenty-fifth embodiment, the X-ray tube unit 5 is made of the X-ray tube 30, the insulating member 6a, the X-ray shield 6b, the annular portion 70, the fixing member 90, the X-ray shield 600, the X-ray shielding member 520 and the rubber members 91, 92 and 95.

According to the twenty-fifth embodiment, in the X-ray tube unit 5 and the X-ray tube assembly having the above structures, the X-ray tube unit 5 comprises the X-ray tube 30, the insulating member 6a and the X-ray shield 6b. Therefore, the X-ray tube unit 5 and the X-ray tube assembly according to the twenty-fifth embodiment can obtain the same advantages as in the first embodiment.

The X-ray tube unit 5 is formed such that natural convection easily occurs in the coolant 7. Therefore, without a circulation unit, an X-ray tube assembly can be formed in which local overheating does not easily occur in an X-ray tube 30.

The X-ray shield 6b is electrically connected to the housing 20. In the twenty-fifth embodiment, the X-ray shield 6b is pressed by the rubber members 95, brought into contact with the housing 20, and electrically connected to the housing 20. It is therefore possible to stabilize the potential of the X-ray shield 6b.

For the above reason, it is possible to obtain an X-ray tube assembly and an X-ray tube unit 5 which can improve the heat dissipation of an anode target 35. Furthermore, the X-ray tube unit 5 including the X-ray shield 6b can be alone subjected to an X-ray leakage test.

### Twenty-Sixth Embodiment

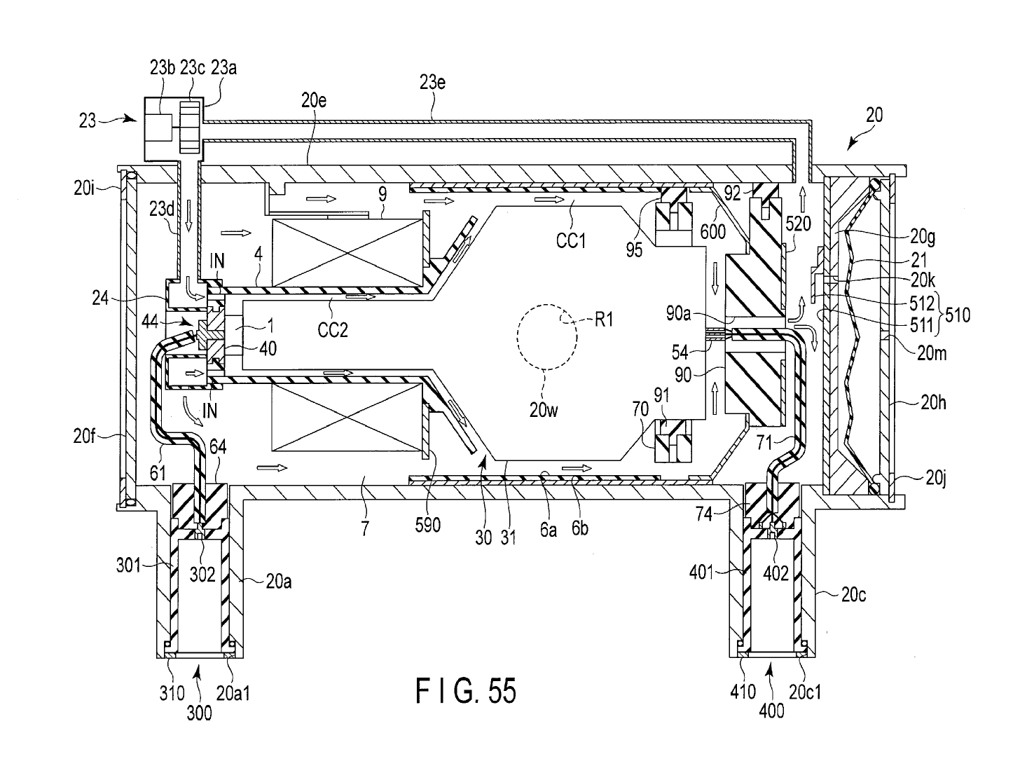

A rotation anode X-ray tube assembly according to the twenty-sixth embodiment will be explained. In the twenty-sixth embodiment, elements having the same functions as those in the twenty-fifth embodiment will be denoted by the same reference numerals as in the twenty-fifth embodiment, and their detailed explanations will be omitted. FIG. 55 is a cross-sectional view showing the X-ray tube assembly according to the twenty-sixth embodiment.

As shown in FIG. 55, the X-ray tube assembly may comprise a circulation unit 23. The circulation unit 23 is attached to an outer surface of a housing body 20e (housing 20). The X-ray tube assembly further comprises a cavity portion 24 and pipes 23d and 23e. It suffices that the pipes 23d and 23e can feed a coolant 7, and are formed of, for example, hoses.

The cavity portion 24 includes a tubular inner peripheral wall, a tubular outer peripheral wall and annular end walls. One of the annular end walls liquid-tightly closes an end of each of the inner and outer peripheral walls, and the other liquid-tightly closes the other end of each of the inner and outer peripheral walls. In the twenty-sixth embodiment, the above other end wall is formed of a connection member 40 and a high-voltage insulating member 4, and includes a number of intakes IN. An opening formed at part of the outer peripheral wall liquid-tightly communicates with an outlet of a chamber 23a through the pipe 23d.

The pipe 23d is liquid-tightly attached to an opening formed in the housing body 20e. The cavity portion 24 serves as a flow passage which connects the outlet of the chamber 23a and the intakes IN. Thus, the coolant 7 flows in a flow passage CC2 from a side where a small-diameter portion of a vacuum envelope 31 to a side where an intermediary portion of the vacuum envelope 31 is located. An intake of the chamber 23a is liquid-tightly attached to the opening formed in the housing body 20e by the pipe 23e.

The circulation unit 23 takes in the coolant 7, which has passed through the through hole 90a. Thus, the coolant 7 flows in a flow passage CC1 from the side where the intermediary of the vacuum envelope 31 to the side where the small-diameter portion of the vacuum envelope 31 is located.

According to the twenty-sixth embodiment, in an X-ray tube unit 5 and the X-ray tube assembly having the above structures, the X-ray tube unit 5 comprises an X-ray tube 30, an insulating member 6a and an X-ray shield 6b. Therefore, the X-ray tube unit 5 and the X-ray tube assembly according to the twenty-sixth embodiment can obtain the same advantages as in the twenty-fifth embodiment.

Since the X-ray tube assembly includes the circulation unit 23, it is possible to cause forced convection to occur in the housing 20. It is also possible to circulate the coolant 7 in the housing 20. This can uniformize the temperature distribution of the coolant 7 in the housing 20.

For the above reason, it is possible to obtain an X-ray tube assembly and an X-ray tube unit 5 which can improve the heat dissipation of an anode target 35. Furthermore, the X-ray tube unit 5 including the X-ray shield 6b can be alone subjected to an X-ray leakage test.

### Twenty-Seventh Embodiment

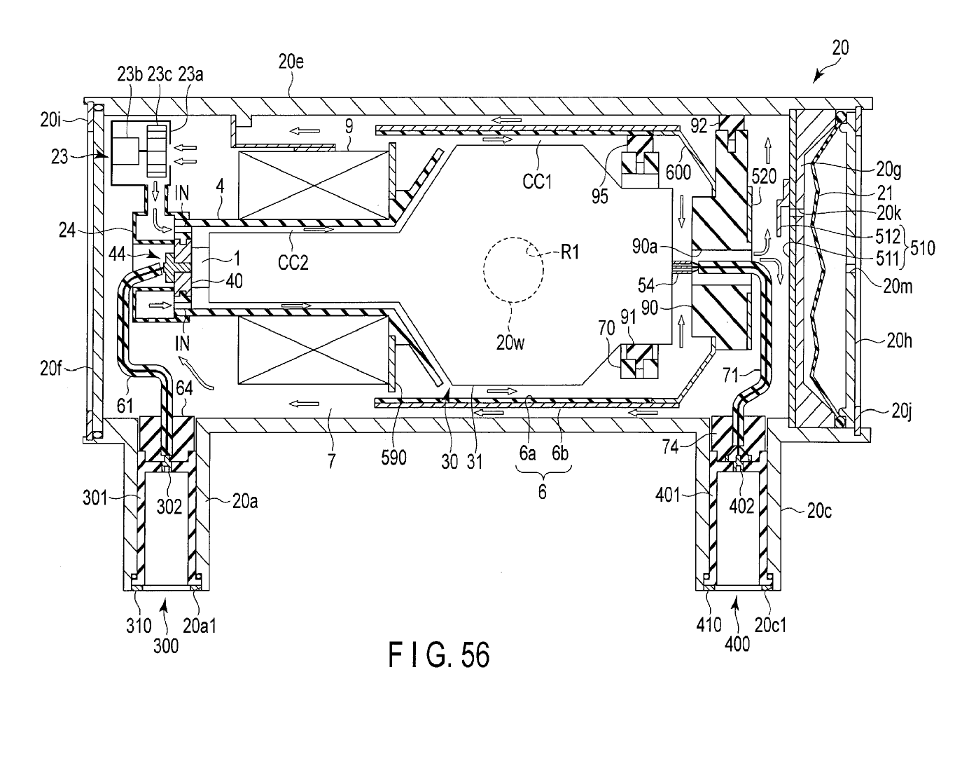

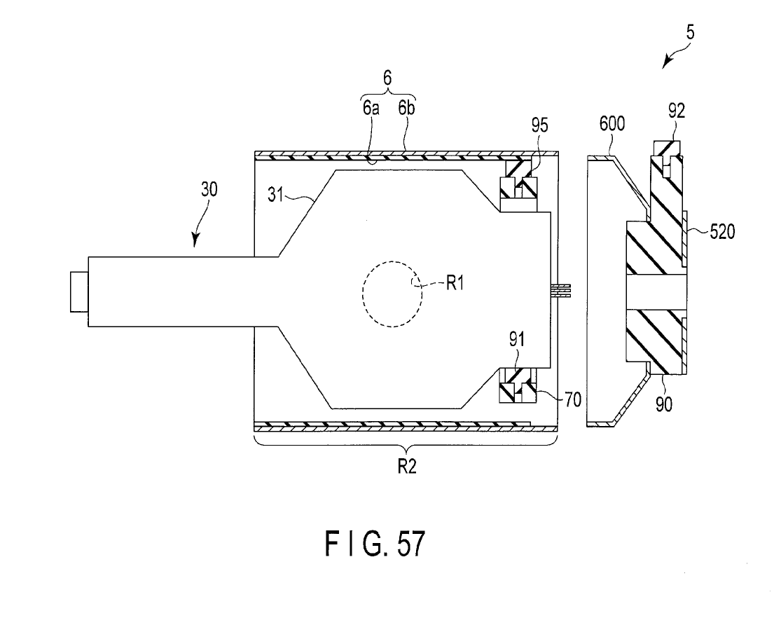

A rotation anode X-ray tube assembly according to the twenty-seventh embodiment will be explained. In the twenty-seventh embodiment, elements having the same functions as those in the twenty-sixth embodiment will be denoted by the same reference numerals as in the twenty-sixth embodiment, and their detailed explanations will be omitted. FIG. 56 is a cross-sectional view showing the X-ray tube assembly according to the twenty-seventh embodiment. FIG. 57 is a cross-sectional view showing a rotation anode X-ray tube unit according to the twenty-seventh embodiment.

As shown in FIGS. 56 and 57, a circulation unit 23 is provided in the housing 20. An X-ray shield 6b is formed of a hard lead. The X-ray shield 6b is spaced from the housing body 20e.

The X-ray shield 6b is fixed to an insulating member 6a, and forms along with the insulating member 6a a shield structure 6.

At least an X-ray tube 30 and the shield structure 6 form a rotation anode X-ray tube unit 5. In the twenty-seventh embodiment, the X-ray tube unit 5 is made of the X-ray tube 30, the shield structure 6, an annular portion 70, a fixing member 90, an X-ray shield 600, an X-ray shielding member 520 and rubber members 91, 92 and 95.

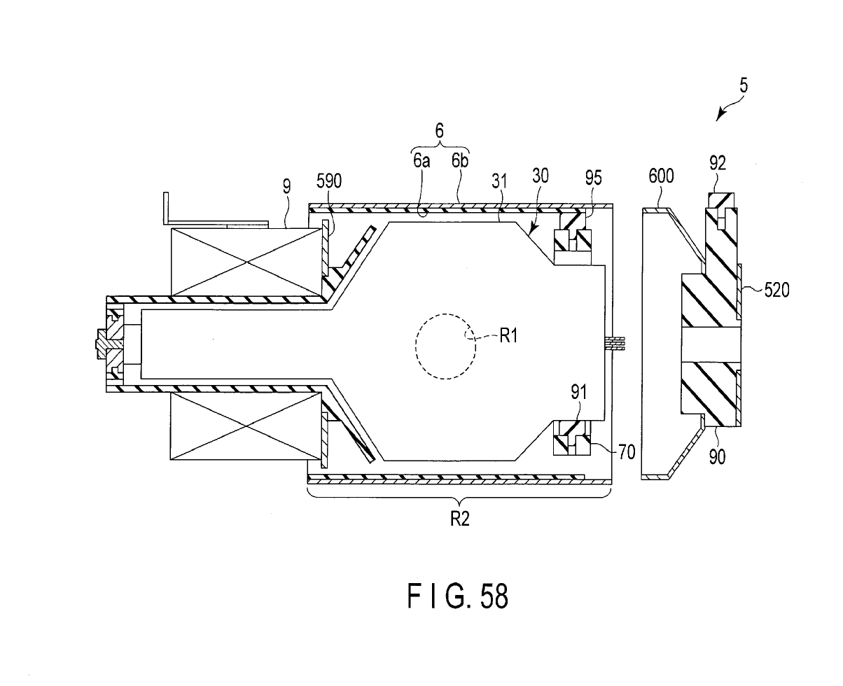

It should be noted that as shown in FIG. 58, the X-ray tube unit 5 may be formed to further include a connection member 40, a high-voltage insulating member 4, a stator coil 9 and an X-ray shielding member 590, in addition to the X-ray tube 30, the shield structure 6, the annular portion 70, the fixing member 90, the X-ray shield 600, the X-ray shielding member 520 and the rubber members 91, 92 and 95.

According to the twenty-seventh embodiment, in the X-ray tube unit 5 and the X-ray tube assembly having the above structures, the X-ray tube unit 5 comprises the X-ray tube 30, the insulating member 6a and the X-ray shield 6b. Therefore, the X-ray tube unit 5 and the X-ray tube assembly according to the twenty-seventh embodiment can obtain the same advantages as in the twenty-sixth embodiment.

In the twenty-seventh embodiment, it is hard to effect electrical conduction between the X-ray shield 6b and a housing 20, which is ground potential. Thus, electrical conduction between the X-ray shield 6b and the housing 20 can be effected by applying such a conductive line 17 as described above, etc.

For the above reason, it is possible to obtain an X-ray tube assembly and an X-ray tube unit 5 which can improve the heat dissipation of an anode target 35. Furthermore, the X-ray tube unit 5 including the X-ray shield 6b can be alone subjected to an X-ray leakage test.

Techniques related to the above twenty-fifth to twenty-seventh embodiments and modifications thereof can be applied as appropriate to the X-ray tube assemblies according to the first to twenty-fourth embodiments.

Next, matters related to the twenty-fifth to twenty-seventh embodiments and the modifications thereof will be referred to in the following (W1) to (W31).

(W1) A rotation anode X-ray tube unit including:

a rotation anode X-ray tube including a cathode which emits electrons, an anode target which is rotatably provided to emit X-rays, and a vacuum envelope which accommodates the cathode and the anode target; and

a flow-passage formation member including a shell which surrounds the vacuum envelope in a direction perpendicular to an axis of the anode target, the flow-passage formation member forming a flow passage in which a cooling fluid flows and which is located between the flow-passage formation member and the vacuum envelope.

(W2) The rotation anode X-ray tube unit according to (W1), further including an X-ray shield which is located opposite to the rotation anode X-ray tube with respect to the shell, and includes a through hole which permits X-rays to be transmitted through.

(W3) The rotation anode X-ray tube unit according to (W2), wherein the X-ray shield is shaped to be in tight contact or close contact with the shell.

(W4) The rotation anode X-ray tube unit according to (W3), wherein the X-ray shield is fixed to the shell, and forms along with the shell a shield structure.

(W5) The rotation anode X-ray tube unit according to one of (W2) to (W4), further including:

an electrical insulating member located outward of the rotation anode X-ray tube on a side located opposite to the anode target with respect to the cathode; and

another X-ray shield attached to the electrical insulating member, and including an end portion laid over the X-ray shield.

(W6) The rotation anode X-ray tube unit according to (W1), further including an electrical insulating member located outward of the rotation anode X-ray tube on a side located opposite to the anode target with respect to the cathode.

(W7) The rotation anode X-ray tube unit according to one of (W1) to (W6), wherein the cooling fluid is a coolant.

(W8) The rotation anode X-ray tube unit according to one of (W1) to (W7), wherein the shell is an electrical insulating member.

(W9) The rotation anode X-ray tube unit according to (W8), wherein the electrical insulating member is formed of resin material containing at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(W10) The rotation anode X-ray tube unit according to one of (W8) or (W9), wherein the shell is formed of an electrical insulating material which contains as an admixture ingredient, metal fine particles of at least one of tungsten, tantalum, molybdenum, barium, bismuth, rare-earth metal and lead, and/or compound fine particles of at least one of tungsten, tantalum, molybdenum, barium, bismuth, rare-earth metal and lead, the shell including a through hole which permits X-rays to be transmitted therethrough.

(W11) The rotation anode X-ray tube unit according to (W1), wherein the shell surrounds at least part of the envelope, and includes a metal material including a through hole which permits X-rays to be transmitted therethrough.

(W12) The rotation anode X-ray tube unit according to (W10) or (W11), further including a partition plate which closes the through hole of the shell, and is formed of material having an X-ray transmission characteristic.

(W13) The rotation anode X-ray tube unit according to (W1), wherein:

the vacuum envelope includes a large-diameter portion located opposite to the anode target in a direction perpendicular to the axis, a small-diameter portion, and an intermediary portion joining the large-diameter portion and the small-diameter portion; and

the shell surrounds at least the large-diameter portion of the vacuum envelope.

(W14) The rotation anode X-ray tube unit according to (W13), further including another flow-passage formation member including an electrical insulating member which surrounds the small-diameter portion and the intermediary portion of the vacuum envelope in the direction perpendicular to the axis of the anode target, the another flow-passage formation member forming another flow passage in which the cooling fluid flows and which is located between the small-diameter portion and the intermediary portion of the vacuum envelope, the another flow passage being separated from the flow passage.

(W15) The rotation anode X-ray tube unit according to (W14), further including a rotary drive unit which is located opposite to the rotation anode X-ray tube with respect to the another flow-passage formation member, and rotates the anode target.

(W16) The rotation anode X-ray tube unit according to (W15), wherein the rotary drive unit is fixed to an outer surface of the electrical insulating member.

(W17) A rotation anode X-ray tube assembly including:

a rotation anode X-ray tube unit; and

a housing accompanying the rotation anode X-ray tube unit, and providing space in which a cooling fluid flows and which is located between the housing and the rotation anode X-ray tube unit,

wherein the rotation anode X-ray tube unit includes:

a rotation anode X-ray tube including a cathode which emits electrons, an anode target which is rotatably provided to emit X-rays, and a vacuum envelope which accommodates the cathode and the anode target; and

a flow-passage formation member including a shell which surrounds the vacuum envelope in a direction perpendicular to an axis of the anode target, the flow-passage formation member forming a flow passage in which the cooling fluid flows and which is located between the flow-passage formation member and the vacuum envelope.

(W18) The rotation anode X-ray tube assembly according to (W17), further including an X-ray shield which is located opposite to the rotation anode X-ray tube with respect to the shell, and includes a through hole which permits X-rays to be transmitted through.

(W19) The rotation anode X-ray tube assembly according to (W18), further including:

an electrical insulating member located outward of the rotation anode X-ray tube on a side located opposite to the anode target with respect to the cathode; and

another X-ray shield attached to the electrical insulating member, and including an end portion laid over the X-ray shield.

(W20) The rotations anode X-ray tube assembly according to (W17), wherein the cooling fluid is a coolant.

(W21) The rotation anode X-ray tube assembly according to (W20), further including a circulation unit which produces a flow of the coolant in the flow passage and the space.

(W22) The rotation anode X-ray tube assembly according to (W20), wherein the coolant is an aquatic coolant.

(W23) The rotation anode X-ray tube assembly according to (W20), wherein the coolant is insulating oil.

(W24) The rotation anode X-ray tube assembly according to (W23), further including a high-voltage unit which is provided in the housing, immersed in the coolant, and applies a high voltage to the rotation anode X-ray tube.

(W25) The rotation anode X-ray tube assembly according to one of (W20) to (W24), further including a heat exchanger which includes: an air-cooling radiator which is located in the housing and outside the housing, and liquid-tightly attached to the housing, and radiates heat of the coolant to the outside of the housing; and an air blower which is provided outside the housing and sends air to the air-cooling radiator.

(W26) The rotation anode X-ray tube assembly according to one of (W17) to (W25), wherein the housing is formed of resin material.

(W27) The rotation anode X-ray tube assembly according to (W26), wherein the resin material of which the housing is formed includes at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

(W28) The rotation anode X-ray tube assembly according to (W26) or (W27), wherein the housing includes a shield layer which forms at least part of an inner surface and an outer surface of the housing, and prevents an electromagnetic noise from leaking from the housing to the outside thereof.

(W29) The rotation anode X-ray tube assembly according to (W28), wherein the shield layer is formed of metal.

(W30) The rotation anode X-ray tube assembly according to (W17), wherein:

the vacuum envelope includes a large-diameter portion located opposite to the anode target in a direction perpendicular to the axis, a small-diameter portion, and an intermediary portion joining the large-diameter portion and the small-diameter portion; and

the shell surrounds at least the large-diameter portion of the vacuum envelope.

(W31) The rotation anode X-ray tube unit according to (W30), further including another flow-passage formation member including an electrical insulating member which surrounds the small-diameter portion and the intermediary portion of the vacuum envelope in the direction perpendicular to the axis of the anode target, the another flow-passage formation member forming another flow passage in which the cooling fluid flows and which is located between the small-diameter portion and the intermediary portion of the vacuum envelope, the another flow passage being separated from the flow passage.

It should be noted that the embodiments are not limited to the above-mentioned ones; and when they are put to practical use, they can be embodied by deforming a structural element or elements without departing from their subject matter. Furthermore, it is possible to make various embodiments by combining as appropriate a number of structural elements disclosed with respect to the above embodiments. For example, some structural elements may be deleted from all the structural elements disclosed with respect to the embodiments. In addition, structural elements disclosed with respect to different embodiments may be combined as appropriates.

The housing 20 may be formed of material other than resin. For example, metal material such as aluminum, an aluminum alloy, a magnesium alloy, stainless or brass can be selected.

With respect to the insulating member 6a of the shield structure 6, resin may contain a substance impermeable to X-rays, as an admixture ingredient. For example, the insulating member 6a may be formed of an electrical insulating material which contains as an admixture ingredient, metal fine particles of at least one of tungsten, tantalum, molybdenum, barium, bismuth, rare-earth metal and lead, and/or compound fine particles of at least one of tungsten, tantalum, molybdenum, barium, bismuth, rare-earth metal and lead. In this case, since the insulating member 6a is impermeable to X-rays, it includes a through hole located in an X-ray transmission region R1.

The electrical insulating material of the insulating member 6a and the housing 20 may be made to further contain reinforcing fibers such as glass fibers, carbon fibers, boron fibers, alumina fibers or aramid fibers, in order to increase their mechanical strength.

The housing 20 may include a shield layer which forms at least part of an inner surface and outer surface of the housing 20, and prevents an electromagnetic noise from leaking from the housing 20 to the outside thereof. The shield layer can be formed of metal which prevents leakage of an electromagnetic noise. The shield layer is grounded.

In the case where the vacuum vessel 32, which is located opposite to the rotor 10 in the direction perpendicular to the axis of the X-ray tube assembly, is formed of metal, materials forming the shield structure 6 may be all applied as metal.

Although the air cooling radiator as shown in FIG. 23 uses a number of heat pipes, it is possible to use a number of metallic bars formed of metal having a high thermal conductivity or a single metallic block, in place of the heat pipes.

In the case of using the coolant 7 as a cooling fluid, the X-ray tube assembly may be formed without a circulation unit. This is because natural convection occurs in the space in the housing 20 or the flow passage formed of the flow-passage formation member such as the insulating member 6a. This causes local overheating to hardly occur in the X-ray tube 30, as compared with the case where the above flow passage is not formed.

It is preferable that the X-ray tube assembly use the fan 120 or the fan 150 since the efficiency of cooling the coolant 7 is increased. However, the X-ray tube assembly may be formed without the fan 120 or the fan 150.

As described above, the X-ray tube unit 5 includes X-ray shielding means, and can thus be alone subjected to an X-ray leakage test. Furthermore, there can be a case where most of the X-ray shielding means can be provided at the X-ray tube unit 5, not the housing 20.

The X-ray tube assembly is not limited to a neutral-point grounded type of X-ray tube assembly in which a high voltage is applied to each of an anode target 35 and a cathode 36. For example, as the X-ray tube assembly, an anode grounded type of X-ray tube assembly or a cathode grounded type of X-ray tube assembly may be applied.

The embodiments described herein are not limited to an X-ray tube unit and an X-ray tube assembly for use in X-ray photography performed in the above-mentioned medical field, etc.; that is, they can be applied to various kinds of X-ray tube units and X-ray tube assemblies.

1. A rotation anode X-ray tube unit comprising:
a rotation anode X-ray tube including a cathode which emits electrons, an anode target which is rotatably provided to emit X-rays, and a vacuum envelope which accommodates the cathode and the anode target;
a flow-passage formation member including a shell which surrounds the vacuum envelope in a direction perpendicular to an axis of the anode target, the flow-passage formation member forming a flow passage in which a cooling fluid flows and which is located between the flow-passage formation member and the vacuum envelope; and
X-ray shielding means for preventing leakage of the X-rays,
wherein
the X-ray shielding means includes:
an X-ray shield located opposite to the rotation anode X-ray tube with respect to the shell, and including a through hole which permits X-rays to be transmitted therethrough; and
a frame-shaped X-ray shielding member attached to the X-ray shield, surrounding the through hole of the X-ray shield, and projecting opposite to the shell with respect to the X-ray shield.

2. The rotation anode X-ray tube unit of claim 1, wherein the X-ray shield is shaped to be in tight contact with or close contact with the shell.

3. The rotation anode X-ray tube unit of claim 2, wherein the X-ray shield is fixed to the shell, and forms a shield structure with the shell.

4. The rotation anode X-ray tube unit of claim 1, further comprising:
an electrical insulating member located outward of the rotation anode X-ray tube on a side located opposite to the anode target with respect to the cathode; and
another X-ray shield attached to the electrical insulating member, and including an end portion laid over the X-ray shield.

5. The rotation anode X-ray tube unit of claim 1, wherein the shell is an electrical insulating member.

6. The rotation anode X-ray tube unit of claim 5, wherein the electrical insulating member is formed of resin material containing at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

7. The rotation anode X-ray tube unit of claim 5, wherein the shell is formed of an electrical insulating material which contains as an admixture ingredient, metal fine particles of at least one of tungsten, tantalum, molybdenum, barium, bismuth, rare-earth metal and lead, and/or compound fine particles of at least one of tungsten, tantalum, molybdenum, barium, bismuth, rare-earth metal and lead, the shell including a through hole which permits X-rays to be transmitted therethrough.

8. The rotation anode X-ray tube unit of claim 1, wherein the shell surrounds at least part of the envelope, and includes a metal member including a through hole which permits X-rays to be transmitted therethrough.

9. The rotation anode X-ray tube unit of claim 7, further comprising:
a partition plate which closes the through hole of the shell, and is formed of material having a good X-ray transmission characteristic.

10. The rotation anode X-ray tube unit of claim 1, wherein
the vacuum envelope includes a large-diameter portion located opposite to the anode target in a direction perpendicular to the axis, a small-diameter portion, and an intermediary portion joining the large-diameter portion and the small-diameter portion; and
the shell surrounds at least the large-diameter portion of the vacuum envelope.

11. The rotation anode X-ray tube unit of claim 10, further comprising:
another flow-passage formation member including an electrical insulating member which surrounds the small-diameter portion and the intermediary portion of the vacuum envelope in the direction perpendicular to the axis of the anode target, the another flow-passage formation member forming another flow passage in which the cooling fluid flows and which is located between the small-diameter portion and the intermediary portion of the vacuum envelope, the another flow passage being separated from the flow passage.

12. The rotation anode X-ray tube unit of claim 11, further comprising:
a rotary drive unit which is located opposite to the rotation anode X-ray tube with respect to the another flow-passage formation member, and rotates the anode target.

13. The rotation anode X-ray tube unit of claim 12, wherein the rotary drive unit is fixed to an outer surface of the electrical insulating member.

14. The rotation anode X-ray tube unit of claim 1, further comprising:
a rotary drive unit which is located opposite to the rotation anode X-ray tube with respect to the flow-passage formation member, and rotates the anode target.

15. A rotation anode X-ray tube assembly comprising:
a rotation anode X-ray tube unit;
a housing accompanying the rotation anode X-ray tube unit, and providing space in which a cooling fluid flows and which is located between the housing and the rotation anode X-ray tube unit;
an X-ray output window; and
a frame-shaped X-ray shielding member,
wherein
the rotation anode X-ray tube unit comprises:
a rotation anode X-ray tube including a cathode which emits electrons, an anode target which is rotatably provided to emit X-rays, and a vacuum envelope which accommodates the cathode and the anode target;
a flow-passage formation member including a shell which surrounds the vacuum envelope in a direction perpendicular to an axis of the anode target, the flow-passage formation member forming a flow passage in which the cooling fluid flows and which is located between the flow-passage formation member and the vacuum envelope; and
X-ray shielding means for preventing leakage of the X-rays, the X-ray shielding means being located opposite to the rotation anode X-ray tube with respect to the shell, and including a through hole which permits X-rays to be transmitted therethrough,
the X-ray output window transmits X-rays, and closes an opening of the housing which is located opposite to the through hole of the X-ray shield, and
the X-ray shielding member is attached to the X-ray shield, forms the X-ray shielding means, surrounds the through hole of the X-ray shield, and projects toward the housing, or is attached to the housing, surrounds the opening of the housing, and projects toward the X-ray shield.

16. The rotation anode X-ray tube assembly of claim 15, further comprising:
an electrical insulating member located outward of the rotation anode X-ray tube on a side located opposite to the anode target with respect to the cathode; and
another X-ray shield attached to the electrical insulating member, forming the X-ray shielding means, and including an end portion laid over the X-ray shield.

17. The rotation anode X-ray tube assembly of claim 15, wherein the X-ray shield is electrically connected to the housing.

18. The rotation anode X-ray tube assembly of claim 15, wherein the cooling fluid is a coolant.

19. The rotation anode X-ray tube assembly of claim 18, further comprising:
a circulation unit which produces a flow of the coolant in the flow passage and the space.

20. The rotation anode X-ray tube assembly of claim 18, wherein the coolant is an aquatic coolant.

21. The rotation anode X-ray tube assembly of claim 18, wherein the coolant is insulating oil.

22. The rotation anode X-ray tube assembly of claim 21, further comprising:
a high-voltage unit which is provided in the housing, immersed in the coolant, and applies a high voltage to the rotation anode X-ray tube.

23. The rotation anode X-ray tube assembly of claim 18, further comprising:
a heat exchanger which is located in the housing and outside the housing, is liquid-tightly attached to the housing, and includes: an air-cooling radiator that radiates heat of the coolant to outside of the housing; and an air blower that is provided outside the housing and sends air to the air-cooling radiator.

24. The rotation anode X-ray tube assembly of claim 15, wherein
the cooling fluid is air; and
the housing includes an intake for taking in air and an outlet for letting out air.

25. The rotation anode X-ray tube assembly of claim 24, further comprising:
a circulation unit which produces a flow of air in the flow passage and the space.

26. The rotation anode X-ray tube assembly of claim 15, wherein the housing is formed of resin material.

27. The rotation anode X-ray tube assembly of claim 26, wherein the resin material of which the housing is formed includes at least one of thermosetting epoxy resin, unsaturated polyester resin, phenol resin, diallyl phthalate resin, thermoplastic epoxy resin, nylon resin, aromatic nylon resin, polybutylene terephthalate resin, polyethylene terephthalate resin, polycarbonate resin, polyphenylene sulfide resin, polyphenylene ether resin, liquid crystal polymer and methylpentene polymer.

28. The rotation anode X-ray tube assembly of claim 26, wherein the housing includes a shield layer which forms at least part of an inner surface and an outer surface of the housing, and prevents an electromagnetic noise from leaking from the housing to outside thereof.

29. The rotation anode X-ray tube assembly of claim 28, wherein the shielding layer is formed of metal.

30. The rotation anode X-ray tube assembly of claim 15, wherein
the vacuum envelope includes a large-diameter portion located opposite to the anode target in a direction perpendicular to the axis, a small-diameter portion, and an intermediary portion joining the large-diameter portion and the small-diameter portion; and
the shell surrounds at least the large-diameter portion of the vacuum envelope.

31. The rotation anode X-ray tube assembly of claim 30, further including:
another flow-passage formation member including an electrical insulating member which surrounds the small-diameter portion and the intermediary portion of the vacuum envelope in the direction perpendicular to the axis of the anode target, the another flow-passage formation member forming another flow passage in which the cooling fluid flows and which is located between the small-diameter portion and the intermediary portion of the vacuum envelope, the another flow passage being separated from the flow passage.

32. The rotation anode X-ray tube unit of claim 6, wherein the shell is formed of an electrical insulating material which contains as an admixture ingredient, metal fine particles of at least one of tungsten, tantalum, molybdenum, barium, bismuth, rare-earth metal and lead, and/or compound fine particles of at least one of tungsten, tantalum, molybdenum, barium, bismuth, rare-earth metal and lead, the shell including a through hole which permits X-rays to be transmitted therethrough.
